(19) United States
(12) Patent Application Publication
(10) Pub. No.: US 2026/0231154 A1
(43) Pub. Date: Aug. 6, 2026

(54) AUTOMATIC REPEAT REQUEST TRANSMISSION FOR UPLINK CONTROL MESSAGES

(71) Applicant: QUALCOMM Incorporated, San Diego, CA (US)

(72) Inventors: Mostafa KHOSHNEVISAN, San Diego, CA (US); Jing SUN, San Diego, CA (US); Linhai HE, San Diego, CA (US)

(21) Appl. No.: 19/045,315

(22) Filed: Feb. 4, 2025

(51) Int. Cl. H04W 72/21; H04L 1/1812; H04W 24/10

(52) U.S. Cl. CPC H04W 72/21; H04L 1/1812; H04W 24/10

(57) ABSTRACT

Various aspects of the present disclosure generally relate to wireless communication. In some aspects, a user equipment (UE) may receive, from a network node, an indication of an unsuccessful hybrid automatic repeat request (HARQ) termination associated with a previous uplink transport block (TB), wherein the previous uplink TB includes an uplink control message. The UE may transmit, to the network node, one or more uplink communications, wherein the one or more uplink communications include a retransmission of the uplink control message. Numerous other aspects are described.

### FIELD OF THE DISCLOSURE

Aspects of the present disclosure generally relate to wireless communication and specifically relate to techniques, apparatuses, and methods associated with feedback messaging for configured grant communication, indication of unsuccessful hybrid automatic repeat request termination for uplink communication, automatic repeat request transmission for uplink control messages, or signaling of uplink automatic repeat request, among other examples.

### BACKGROUND

Wireless communication systems are widely deployed to provide various services, which may involve carrying or supporting voice, text, other messaging, video, data, and/or other traffic. Typical wireless communication systems may employ multiple-access radio access technologies (RATs) capable of supporting communication among multiple wireless communication devices including user devices or other devices by sharing the available system resources (for example, time domain resources, frequency domain resources, spatial domain resources, and/or device transmit power, among other examples). Such multiple-access RATs are supported by technological advancements that have been adopted in various telecommunication standards, which define common protocols that enable different wireless communication devices to communicate on a local, municipal, national, regional, or global level.

An example telecommunication standard is New Radio (NR). NR, which may also be referred to as 5G, is part of a continuous mobile broadband evolution promulgated by the Third Generation Partnership Project (3GPP). NR (and other RATs beyond NR) may be designed to better support enhanced mobile broadband (eMBB) access, Internet of things (IoT) networks or reduced capability device deployments, and ultra-reliable low latency communication (URLLC) applications. To support these verticals, NR systems may be designed to implement a modularized functional infrastructure, a disaggregated and service-based network architecture, network function virtualization, network slicing, multi-access edge computing, millimeter wave (mmWave) technologies including massive multiple-input multiple-output (MIMO), licensed and unlicensed spectrum access, non-terrestrial network (NTN) deployments, sidelink and other device-to-device direct communication technologies (for example, cellular vehicle-to-everything (CV2X) communication), multiple-subscriber implementations, high-precision positioning, and/or radio frequency (RF) sensing, among other examples. As the demand for connectivity continues to increase, further improvements in NR may be implemented, and other RATs, such as 6G and beyond, may be introduced to enable new applications and facilitate new use cases.

A medium access control layer of a protocol stack may implement a hybrid automatic repeat request (HARQ) protocol or an automatic repeat request protocol to provide a retransmission mechanism. In some examples, the HARQ protocol may include a transmitting device using a retransmission protocol in combination with a receiving device, such as a send-and-wait protocol that enables the receiving device to recover and/or correct data errors in a first HARQ process without hindering data transmissions in a second HARQ process. Accordingly, multiple HARQ processes may operate in parallel, and data errors identified in the first HARQ process may not hinder transmissions in the second HARQ process. A HARQ process may be used for downlink communications, uplink communications, and/or sidelink communications. In some examples, and as part of a HARQ process, a network node may transmit information in downlink control information that indicates to a receiving device (e.g., a UE) which downlink transmission(s) and/or which uplink transmissions to process using a HARQ protocol.

In some examples, a HARQ process and/or HARQ protocol may enable a receiving device to correct errors in a received data packet, such as by correcting errors within a transport block (TB) based at least in part on soft combining packets in a physical layer. In some examples, a TB may be partitioned into one or more code block groups (CBGs), and each CBG may partitioned into one or more code blocks. To correct for errors, the receiving device may buffer one or more data packets that have been identified as including an error, combine the data packets, and process the combined data packets to reduce errors.

### SUMMARY

Some aspects described herein relate to a method of wireless communication performed by a user equipment (UE). The method may include receiving a first message identifying a resource allocation for a configured grant (CG) physical uplink shared channel (PUSCH) (CG-PUSCH) communication. The method may include transmitting, using the resource allocation, the CG-PUSCH communication. The method may include receiving downlink control information (DCI) scheduling a re-transmission of the CG-PUSCH communication (TB), wherein the DCI includes a feedback message associated with one or more prior TBs.

Some aspects described herein relate to a method of wireless communication performed by a network node. The method may include transmitting a first message identifying a resource allocation for a CG-PUSCH communication. The method may include transmitting DCI scheduling a re-transmission of the CG-PUSCH communication, wherein the DCI includes a feedback message associated with one or more prior TBs.

Some aspects described herein relate to a UE for wireless communication. The UE may include one or more memories and one or more processors coupled to the one or more memories. The one or more processors may be configured to receive a first message identifying a resource allocation for a CG-PUSCH communication. The one or more processors may be configured to transmit, using the resource allocation, the CG-PUSCH communication. The one or more processors may be configured to receive DCI scheduling a re-transmission of the CG-PUSCH communication, wherein the DCI includes a feedback message associated with one or more prior TBs.

Some aspects described herein relate to a network node for wireless communication. The network node may include one or more memories and one or more processors coupled to the one or more memories. The one or more processors may be configured to transmit a first message identifying a resource allocation for a CG-PUSCH communication. The one or more processors may be configured to transmit DCI scheduling a re-transmission of the CG-PUSCH communication, wherein the DCI includes a feedback message associated with one or more prior TBs.

Some aspects described herein relate to a non-transitory computer-readable medium that stores a set of instructions for wireless communication by a UE. The set of instructions, when executed by one or more processors of the UE, may cause the UE to receive a first message identifying a resource allocation for a CG-PUSCH communication. The set of instructions, when executed by one or more processors of the UE, may cause the UE to transmit, using the resource allocation, the CG-PUSCH communication. The set of instructions, when executed by one or more processors of the UE, may cause the UE to receive DCI scheduling a re-transmission of the CG-PUSCH communication, wherein the DCI includes a feedback message associated with one or more prior TBs.

Some aspects described herein relate to a non-transitory computer-readable medium that stores a set of instructions for wireless communication by a network node. The set of instructions, when executed by one or more processors of the network node, may cause the network node to transmit a first message identifying a resource allocation for a CG-PUSCH communication. The set of instructions, when executed by one or more processors of the network node, may cause the network node to transmit DCI scheduling a re-transmission of the CG-PUSCH communication, wherein the DCI includes a feedback message associated with one or more prior TBs.

Some aspects described herein relate to an apparatus for wireless communication. The apparatus may include means for receiving a first message identifying a resource allocation for a CG-PUSCH communication. The apparatus may include means for transmitting, using the resource allocation, the CG-PUSCH communication. The apparatus may include means for

receiving DCI scheduling a re-transmission of the CG-PUSCH communication, wherein the DCI includes a feedback message associated with one or more prior TBs.

Some aspects described herein relate to an apparatus for wireless communication. The apparatus may include means for transmitting a first message identifying a resource allocation for a CG-PUSCH communication. The apparatus may include means for transmitting DCI scheduling a re-transmission of the CG-PUSCH communication, wherein the DCI includes a feedback message associated with one or more prior TBs.

Some aspects described herein relate to a method of wireless communication performed by a UE. The method may include receiving a DCI message associated with scheduling a new TB on a physical uplink shared channel, wherein the DCI message includes a feedback indication of a previous TB. The method may include transmitting one or more uplink communications, wherein whether the one or more uplink communications includes a retransmission of information associated with the previous TB is based on the feedback indication.

Some aspects described herein relate to a method of wireless communication performed by a UE. The method may include receiving a non-scheduling DCI message, wherein the DCI message includes an automatic repeat request (ARQ) indication of a TB scheduled in a PUSCH and scheduled by a previous DCI, wherein the non-scheduling DCI includes a configuration associated with validation of the non-scheduling DCI. The method may include transmitting one or more uplink communications to re-transmit information associated with the previous TB based on the feedback indication.

Some aspects described herein relate to a method of wireless communication performed by a network node. The method may include transmitting a DCI message associated with scheduling a new TB on a physical uplink shared channel, wherein the DCI message includes a feedback indication of a previous TB. The method may include receiving one or more uplink communications, wherein whether the one or more uplink communications includes a retransmission of information associated with the previous TB is based on the feedback indication.

Some aspects described herein relate to a method of wireless communication performed by a network node. The method may include transmitting a non-scheduling DCI message, wherein the DCI message includes an ARQ feedback indication of a previous TB scheduled in a PUSCH and scheduled by a previous DCI, wherein the non-scheduling DCI includes a configuration associated with validation of the non-scheduling DCI. The method may include receiving one or more uplink communications to re-transmit information associated with the previous TB based on the feedback indication.

Some aspects described herein relate to a UE. The UE may include one or more memories and one or more processors coupled to the one or more memories. The one or more processors may be configured to receive a DCI message associated with scheduling a new TB on a physical uplink shared channel, wherein the DCI message includes a feedback indication of a previous TB. The one or more processors may be configured to transmit one or more uplink communications, wherein whether the one or more uplink communications includes a retransmission of information associated with the previous TB is based on the feedback indication.

Some aspects described herein relate to a UE. The UE may include one or more memories and one or more processors coupled to the one or more memories. The one or more processors may be configured to receive a non-scheduling DCI message, wherein the DCI message includes an ARQ feedback indication of a previous TB scheduled in a PUSCH and scheduled by a previous DCI, wherein the non-scheduling DCI includes a configuration associated with validation of the non-scheduling DCI. The one or more processors may be configured to transmit one or more uplink communications to re-transmit information associated with the previous TB based on the feedback indication.

Some aspects described herein relate to a network node. The network node may include one or more memories and one or more processors coupled to the one or more memories. The one or more processors may be configured to transmit a DCI message associated with scheduling a new TB on a physical uplink shared channel, wherein the DCI message includes a feedback indication of a previous TB. The one or more processors may be configured to receive one or more uplink communications, wherein whether the one or more uplink communications includes a retransmission of information associated with the previous TB is based on the feedback indication.

Some aspects described herein relate to a network node. The network node may include one or more memories and one or more processors coupled to the one or more memories. The one or more processors may be configured to transmit a non-scheduling DCI message, wherein the DCI message includes an ARQ feedback indication of a previous TB scheduled in a PUSCH and scheduled by a previous DCI, wherein the non-scheduling DCI includes a configuration associated with validation of the non-scheduling DCI. The one or more processors may be configured to receive one or more uplink communications to re-transmit information associated with the previous TB based on the feedback indication.

Some aspects described herein relate to a non-transitory computer-readable medium that stores a set of instructions for wireless communication by a UE. The set of instructions, when executed by one or more processors of the UE, may cause the UE to receive a DCI message associated with scheduling a new TB on a physical uplink shared channel, wherein the DCI message includes a feedback indication of a previous TB. The set of instructions, when executed by one or more processors of the UE, may cause the UE to transmit one or more uplink communications, wherein whether the one or more uplink communications includes a retransmission of information associated with the previous TB is based on the feedback indication.

Some aspects described herein relate to a non-transitory computer-readable medium that stores a set of instructions for wireless communication by a UE. The set of instructions, when executed by one or more processors of the UE, may cause the UE to receive a non-scheduling DCI message, wherein the DCI message includes an ARQ feedback indication of a previous TB scheduled in a PUSCH and scheduled by a previous DCI, wherein the non-scheduling DCI includes a configuration associated with validation of the non-scheduling DCI. The set of instructions, when executed by one or more processors of the UE, may cause the UE to transmit one or more uplink communications to re-transmit information associated with the previous TB based on the feedback indication.

Some aspects described herein relate to a non-transitory computer-readable medium that stores a set of instructions for wireless communication by a network node. The set of instructions, when executed by one or more processors of the network node, may cause the network node to transmit a DCI message associated with scheduling a new TB on a physical uplink shared channel, wherein the DCI message includes a feedback indication of a previous TB. The set of instructions, when executed by one or more processors of the network node, may cause the network node to receive one or more uplink communications, wherein whether the one or more uplink communications includes a retransmission of information associated with the previous TB is based on the feedback indication.

Some aspects described herein relate to a non-transitory computer-readable medium that stores a set of instructions for wireless communication by a network node. The set of instructions, when executed by one or more processors of the network node, may cause the network node to transmit a non-scheduling DCI message, wherein the DCI message includes an ARQ feedback indication of a previous TB scheduled in a PUSCH and scheduled by a previous DCI, wherein the non-scheduling DCI includes a configuration associated with validation of the non-scheduling DCI. The set of instructions, when executed by one or more processors of the network node, may cause the network node to receive one or more uplink communications to re-transmit information associated with the previous TB based on the feedback indication.

Some aspects described herein relate to an apparatus for wireless communication. The apparatus may include means for receiving a DCI message associated with scheduling a new TB on a physical uplink shared channel, wherein the DCI message includes a feedback indication of a previous TB. The apparatus may include means for transmitting one or more uplink communications, wherein whether the one or more uplink communications includes a retransmission of information associated with the previous TB is based on the feedback indication.

Some aspects described herein relate to an apparatus for wireless communication. The apparatus may include means for receiving a non-scheduling DCI message, wherein the DCI message includes an ARQ feedback indication of a previous TB scheduled in a PUSCH and scheduled by a previous DCI, wherein the non-scheduling DCI includes a configuration associated with validation of the non-scheduling DCI. The apparatus may include means for transmitting one or more uplink communications to re-transmit information associated with the previous TB based on the feedback indication.

Some aspects described herein relate to an apparatus for wireless communication. The apparatus may include means for transmitting a DCI message associated with scheduling a new TB on a physical uplink shared channel, wherein the DCI message includes a feedback indication of a previous TB. The apparatus may include means for receiving one or more uplink communications, wherein whether the one or more uplink communications includes a retransmission of information associated with the previous TB is based on the feedback indication.

Some aspects described herein relate to an apparatus for wireless communication. The apparatus may include means for transmitting a non-scheduling DCI message, wherein the DCI message includes an ARQ feedback indication of a previous TB scheduled in a PUSCH and scheduled by a previous DCI, wherein the non-scheduling DCI includes a configuration associated with validation of the non-scheduling DCI. The apparatus may include means for receiving one or more uplink communications to re-transmit information associated with the previous TB based on the feedback indication.

Some aspects described herein relate to a UE for wireless communication. The UE may include a transceiver and may include one or more memories and one or more processors coupled to the one or more memories. The one or more processors may be configured to receive, via the transceiver from a network node, an indication of an unsuccessful HARQ termination associated with a previous uplink TB, wherein the previous uplink TB includes an uplink control message. The one or more processors may be configured to transmit, via the transceiver to the network node, one or more uplink communications, wherein the one or more uplink communications include a retransmission of the uplink control message.

Some aspects described herein relate to a network node for wireless communication. The network node may include a transceiver and may include one or more memories and one or more processors coupled to the one or more memories. The one or more processors may be configured to transmit, via the transceiver to a UE, an indication of an unsuccessful HARQ termination associated with a previous uplink TB, wherein the previous uplink TB includes an uplink control message. The one or more processors may be configured to receive, via the transceiver from the UE, one or more uplink communications, wherein the one or more uplink communications include a retransmission of the uplink control message.

Some aspects described herein relate to a method of wireless communication performed by a UE. The method may include receiving, from a network node, an indication of an unsuccessful HARQ termination associated with a previous uplink TB, wherein the previous uplink TB includes an uplink control message. The method may include transmitting, to the network node, one or more uplink communications, wherein the one or more uplink communications include a retransmission of the uplink control message.

Some aspects described herein relate to a method of wireless communication performed by a network node. The method may include transmitting, to a UE, an indication of an unsuccessful HARQ termination associated with a previous uplink TB, wherein the previous uplink TB includes an uplink control message. The method may include receiving, from the UE, one or more uplink communications, wherein the one or more uplink communications include a retransmission of the uplink control message.

Some aspects described herein relate to a non-transitory computer-readable medium that stores a set of instructions for wireless communication by a UE. The set of instructions, when executed by one or more processors of the UE, may cause the UE to receive, from a network node, an indication of an unsuccessful HARQ termination associated with a previous uplink TB, wherein the previous uplink TB includes an uplink control message. The set of instructions, when executed by one or more processors of the UE, may cause the UE to transmit, to the network node, one or more uplink communications, wherein the one or more uplink communications include a retransmission of the uplink control message.

Some aspects described herein relate to a non-transitory computer-readable medium that stores a set of instructions for wireless communication by a network node. The set of instructions, when executed by one or more processors of the network node, may cause the network node to transmit, to a UE, an indication of an unsuccessful HARQ termination associated with a previous uplink TB, wherein the previous uplink TB includes an uplink control message. The set of instructions, when executed by one or more processors of the network node, may cause the network node to receive, from the UE, one or more uplink communications, wherein the one or more uplink communications include a retransmission of the uplink control message.

Some aspects described herein relate to an apparatus for wireless communication. The apparatus may include means for receiving, from a network node, an indication of an unsuccessful HARQ termination associated with a previous uplink TB, wherein the previous uplink TB includes an uplink control message. The apparatus may include means for transmitting, to the network node, one or more uplink communications, wherein the one or more uplink communications include a retransmission of the uplink control message.

Some aspects described herein relate to an apparatus for wireless communication. The apparatus may include means for transmitting, to a UE, an indication of an unsuccessful HARQ termination associated with a previous uplink TB, wherein the previous uplink TB includes an uplink control message. The apparatus may include means for receiving, from the UE, one or more uplink communications, wherein the one or more uplink communications include a retransmission of the uplink control message.

Some aspects described herein relate to a UE for wireless communication. The UE may include a transceiver and may include one or more memories and one or more processors coupled to the one or more memories. The one or more processors may be configured to receive, via the transceiver from a network node, information that indicates one or more unsuccessful HARQ termination events associated with one or more respective uplink TBs associated with one or more HARQ identifiers (IDs). The one or more processors may be configured to transmit, via the transceiver to the network node, one or more uplink transmissions, wherein the one or more uplink transmissions include a retransmission of at least one of one or more radio link control (RLC) service data units (SDUs) or one or more RLC SDU segments associated with a respective uplink TB, of the one or more respective uplink TBs, associated with a valid unsuccessful HARQ termination event of the one or more unsuccessful HARQ termination events.

Some aspects described herein relate to a network node for wireless communication. The network node may include a transceiver and may include one or more memories and one or more processors coupled to the one or more memories. The one or more processors may be configured to transmit, via the transceiver to a UE, information that indicates one or more unsuccessful HARQ termination events associated with one or more respective uplink TBs associated with one or more HARQ IDs. The one or more processors may be configured to receive, via the transceiver from the UE, one or more uplink transmissions, wherein the one or more uplink transmissions include a retransmission of at least one of one or more RLC SDUs or one or more RLC SDU segments associated with a respective uplink TB, of the one or more respective uplink TBs, associated with a valid unsuccessful HARQ termination event of the one or more unsuccessful HARQ termination events.

Some aspects described herein relate to a method of wireless communication performed by a UE. The method may include receiving, from a network node, information that indicates one or more unsuccessful HARQ termination events associated with one or more respective uplink TBs associated with one or more HARQ IDs. The method may include transmitting, to the network node, one or more uplink transmissions, wherein the one or more uplink transmissions include a retransmission of at least one of one or more RLC SDUs or one or more RLC SDU segments associated with a respective uplink TB, of the one or more respective uplink TBs, associated with a valid unsuccessful HARQ termination event of the one or more unsuccessful HARQ termination events.

Some aspects described herein relate to a method of wireless communication performed by a network node. The method may include transmitting, to a UE, information that indicates one or more unsuccessful HARQ termination events associated with one or more respective uplink TBs associated with one or more HARQ IDs. The method may include receiving, from the UE, one or more uplink transmissions, wherein the one or more uplink transmissions include a retransmission of at least one of one or more RLC SDUs or one or more RLC SDU segments associated with a respective uplink TB, of the one or more respective uplink TBs, associated with a valid unsuccessful HARQ termination event of the one or more unsuccessful HARQ termination events.

Some aspects described herein relate to a non-transitory computer-readable medium that stores a set of instructions for wireless communication by a UE. The set of instructions, when executed by one or more processors of the UE, may cause the UE to receive, from a network node, information that indicates one or more unsuccessful HARQ termination events associated with one or more respective uplink TBs associated with one or more HARQ IDs. The set of instructions, when executed by one or more processors of the UE, may cause the UE to transmit, to the network node, one or more uplink transmissions, wherein the one or more uplink transmissions include a retransmission of at least one of one or more RLC SDUs or one or more RLC SDU segments associated with a respective uplink TB, of the one or more respective uplink TBs, associated with a valid unsuccessful HARQ termination event of the one or more unsuccessful HARQ termination events.

Some aspects described herein relate to a non-transitory computer-readable medium that stores a set of instructions for wireless communication by a network node. The set of instructions, when executed by one or more processors of the network node, may cause the network node to transmit, to a UE, information that indicates one or more unsuccessful HARQ termination events associated with one or more respective uplink TBs associated with one or more HARQ IDs. The set of instructions, when executed by one or more processors of the network node, may cause the network node to receive, from the UE, one or more uplink transmissions, wherein the one or more uplink transmissions include a retransmission of at least one of one or more RLC SDUs or one or more RLC SDU segments associated with a respective uplink TB, of the one or more respective uplink TBs, associated with a valid unsuccessful HARQ termination event of the one or more unsuccessful HARQ termination events.

Some aspects described herein relate to an apparatus for wireless communication. The apparatus may include means for receiving, via a transceiver from a network node, information that indicates one or more unsuccessful HARQ termination events associated with one or more respective uplink TBs associated with one or more HARQ IDs. The apparatus may include means for transmitting, via the transceiver to the network node, one or more uplink transmissions, wherein the one or more uplink transmissions include a retransmission of at least one of one or more RLC SDUs or one or more RLC SDU segments associated with a respective uplink TB, of the one or more respective uplink TBs, associated with a valid unsuccessful HARQ termination event of the one or more unsuccessful HARQ termination events.

Some aspects described herein relate to an apparatus for wireless communication. The apparatus may include means for transmitting, via a transceiver to a UE, information that indicates one or more unsuccessful HARQ termination events associated with one or more respective uplink TBs associated with one or more HARQ IDs. The apparatus may include means for receiving, via the transceiver from the UE, one or more uplink transmissions, wherein the one or more uplink transmissions include a retransmission of at least one of one or more RLC SDUs or one or more RLC SDU segments associated with a respective uplink TB, of the one or more respective uplink TBs, associated with a valid unsuccessful HARQ termination event of the one or more unsuccessful HARQ termination events.

Aspects of the present disclosure may generally be implemented by or as a method, apparatus, system, computer program product, non-transitory computer-readable medium, user equipment, base station, network node, network entity, wireless communication device, and/or processing system as substantially described with reference to, and as illustrated by, this specification and accompanying drawings.

The foregoing paragraphs of this section have broadly summarized some aspects of the present disclosure. These and additional aspects and associated advantages will be described hereinafter. The disclosed aspects may be used as a basis for modifying or designing other aspects for carrying out the same or similar purposes of the present disclosure. Such equivalent aspects do not depart from the scope of the appended claims. Characteristics of the aspects disclosed herein, both their organization and method of operation, together with associated advantages, will be better understood from the following description when considered in connection with the accompanying drawings.

### BRIEF DESCRIPTION OF THE DRAWINGS

The appended drawings illustrate some aspects of the present disclosure but are not limiting of the scope of the present disclosure because the description may enable other aspects. Each of the drawings is provided for purposes of illustration and description, and not as a definition of the limits of the claims. The same or similar reference numbers in different drawings may identify the same or similar elements.

FIG. 1 is a diagram illustrating an example of a wireless communication network, in accordance with the present disclosure.

FIG. 2 is a diagram illustrating an example disaggregated network node architecture, in accordance with the present disclosure.

FIG. 3 is a diagram illustrating an example of a hybrid automatic repeat request (HARQ) process, in accordance with the present disclosure.

FIG. 4 is a diagram illustrating an example of a user plane protocol stack and a control plane protocol stack for a network node and a core network in communication with a user equipment (UE), in accordance with the present disclosure.

FIG. 5 is a diagram illustrating an example of HARQ identifier sharing, in accordance with the present disclosure.

FIG. 6 is a diagram illustrating an example of an uplink (medium access control protocol data unit, in accordance with the present disclosure.

FIGS. 7A-7J are diagrams illustrating an example associated with indication of unsuccessful HARQ termination for uplink communication, in accordance with the present disclosure.

FIGS. 8A-8F are diagrams illustrating an example associated with feedback messaging for configured grant communication, in accordance with the present disclosure.

FIGS. 9A-9C are diagrams illustrating examples associated with signaling of uplink automatic repeat request (ARQ), in accordance with the present disclosure.

FIGS. 10A-10E are diagrams illustrating examples associated with ARQ transmission for uplink control messages, in accordance with the present disclosure.

FIG. 11 is a diagram illustrating an example process performed, for example, at a UE or an apparatus of a UE, in accordance with the present disclosure.

FIG. 12 is a diagram illustrating an example process performed, for example, at a network node or an apparatus of a network node, in accordance with the present disclosure.

FIG. 13 is a diagram illustrating an example process performed, for example, at a UE or an apparatus of a UE, in accordance with the present disclosure.

FIG. 14 is a diagram illustrating an example process performed, for example, at a network node or an apparatus of a network node, in accordance with the present disclosure.

FIG. 15 is a diagram illustrating an example process performed, for example, at a UE or an apparatus of a UE, in accordance with the present disclosure.

FIG. 16 is a diagram illustrating an example process performed, for example, at a network node or an apparatus of a network node, in accordance with the present disclosure.

FIG. 17 is a diagram illustrating an example process performed, for example, at a UE or an apparatus of a UE, in accordance with the present disclosure.

FIG. 18 is a diagram illustrating an example process performed, for example, at a network node or an apparatus of a network node, in accordance with the present disclosure.

FIGS. 19-20 are diagrams of example apparatuses for wireless communication, in accordance with the present disclosure.

FIG. 21 is a diagram illustrating an example process performed, for example, at a UE or an apparatus of a UE, in accordance with the present disclosure.

FIG. 22 is a diagram illustrating an example process performed, for example, at a network node or an apparatus of a network node, in accordance with the present disclosure.

### DETAILED DESCRIPTION

Various aspects of the present disclosure are described hereinafter with reference to the accompanying drawings. However, aspects of the present disclosure may be embodied in many different forms. The present disclosure is not to be construed as limited to any specific aspect illustrated by or described with reference to an accompanying drawing or otherwise presented in this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or in combination with any other aspect of the disclosure. For example, an apparatus may be implemented or a method may be practiced using various combinations or quantities of the aspects set forth herein. In addition, the scope of the disclosure is intended to cover an apparatus having, or a method that is practiced using, other structures and/or functionalities in addition to or other than the structures and/or functionalities with which various aspects of the disclosure set forth herein may be practiced. Any aspect of the disclosure disclosed herein may be embodied by one or more elements of a claim.

Several aspects of telecommunication systems will now be presented with reference to various methods, operations, apparatuses, and techniques. These methods, operations, apparatuses, and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

In a scheduling uplink DCI (e.g., a DCI that schedules uplink communication), a UE may interpret toggling of an NDI bit to indicate when a new TB for a particular HARQ ID is scheduled. Accordingly, the UE can determine that the particular HARQ ID is terminated for a prior TB, but may not have information indicating whether the particular HARQ ID is successfully terminated or unsuccessfully terminated. On a network node side, the network node may, based on satisfaction of a condition, cease scheduling HARQ retransmissions for a TB even when the TB has not been successfully received. The condition may include a maximum quantity of HARQ retransmissions being attempted. Alternatively, the condition may include uplink skipping being configured for a UE and the UE having data to transmit, but the UE missing the DCI scheduling the HARQ retransmission or the UE sending a PUSCH that the network node does not receive. In the scenario of this condition, the network node may determine that the UE skipped the PUSCH as a result of not having data to transmit and may not send DCI for a HARQ retransmission.

The network node may resolve an issue with ceasing scheduling HARQ retransmission by configuring radio link control (RLC) acknowledge mode (AM). When RLC AM is configured, the network node transmits status reports to the UE indicating an RLC layer feedback indication for one or more RLC service data units (SDUs) or SDU segments. Based on receiving the RLC layer feedback indication, the UE can flush an upper-layer (e.g., layer 2 (L2)) buffer for ACKed RLC SDUs or SDU segments. In contrast, the UE may queue NACKed RLC SDUs or SDU segments for automatic repeat request (ARQ) retransmission. However, ARQ retransmission may be associated with a relatively high latency and a relatively large L2 buffer. Accordingly, the UE may receive an indication of unsuccessful HARQ termination via L1 (e.g., DCI) signaling, which may reduce an ARQ latency and a maximum L2 buffer size. However, to signal indication of unsuccessful HARQ termination via L1 signaling, the network node may include an extra bit in the L1 signaling and the UE may maintain a mapping between TBs and RLC SDUs or SDU segments.

Various aspects relate generally to indication of unsuccessful HARQ termination for uplink transmission. Some aspects more specifically relate to an uplink DCI scheduling a new TB on a PUSCH, with a toggled NDI for a particular HARQ ID, indicating whether a previous TB associated with the same HARQ ID was successfully received. In some aspects, a network node may transmit a non-scheduling DCI to indicate whether previous TBs have been successfully decoded or not. In some aspects, a DCI scheduling a TB on a PUSCH may indicate whether code blocks (CBs) or code block groups (CBGs) of a previous TB associated with the same HARQ ID have been successfully received or not.

Particular aspects of the subject matter described in this disclosure can be implemented to realize one or more of the following potential advantages. In some examples, the described techniques can be used to provide feedback signaling. In some examples, the described techniques can be used to reduce a likelihood of dropped communications or a latency associated with retransmitting missed communications.

A network node may identify resources that a user equipment (UE) is to use for communication. For example, the network node may transmit a message to configure a grant for an uplink communication, such as a configured grant (CG) physical uplink shared channel (PUSCH) (CG-PUSCH) communication. CG-PUSCH communications include periodic transmissions of PUSCHs, where the periodicity is configured by the network node using radio resource control (RRC) signaling. For CG-PUSCH communications, the UE may be triggered to transmit the CG-PUSCH communications based on receiving the RRC signaling or based on receiving an activation downlink control information (DCI) signal. For CG-PUSCH communications, a hybrid automatic repeat request (HARQ) identifier (ID) may be configured using the RRC signaling on a per-CG configuration basis. Within a CG-PUSCH communication set, a HARQ ID may be incremented, for each CG occasion or periodicity, based on a slot number of a PUSCH.

Similarly, the network node may transmit DCI to dynamically schedule an uplink transmission, such as a dynamic grant (DG) PUSCH (DG-PUSCH). For a DG-PUSCH, a HARQ ID may be indicated in the scheduling DCI that the network node transmits. The network node may transmit the DCI for a cell radio network temporary identifier (C-RNTI) scrambled DG-PUSCH transmission, which may be an initial transmission or a re-transmission in accordance with whether a new data indicator (NDI) is toggled. Additionally, or alternatively, the network node may transmit the DCI for a configured-scheduling radio network temporary identifier (CS-RNTI), which may be a retransmission of a CG-PUSCH and may be referred to as a “CG ReTx” communication.

When a UE is transmitting a set of transport blocks (TBs) and is configured for CG-PUSCH communication, an initial transmission of a CG-PUSCH communication may not be scheduled by a DCI. For example, the initial transmission of a CG-PUSCH may be scheduled by RRC signaling. Accordingly, the UE may lack information indicating whether previous TBs (e.g., TBs before a TB being scheduled for an initial transmission of a CG-PUSCH) have been acknowledged (ACKed) or negative acknowledged (NACKed). Various aspects relate generally to layer 1 (L1) (e.g., DCI) based feedback for uplink communication. Some aspects more specifically relate to DCI scheduling a HARQ retransmission of a CG-PUSCH communication, for a particular HARQ ID, indicating whether one or more previous TBs associated with the same HARQ ID were successfully received. Accordingly, when the UE receives a DCI scheduling a HARQ retransmission of a CG-PUSCH with a cyclic redundancy check (CRC) scrambled with a CS-RNTI and an NDI set to a configured value, the UE may determine whether to retransmit one or more prior TBs associated with a CS-RNTI in an earlier CG occasion.

Particular aspects of the subject matter described in this disclosure can be implemented to realize one or more of the following potential advantages. In some examples, the described techniques can be used to provide feedback signaling in communication scenarios in which HARQ feedback is used for CG-PUSCH communication and in which HARQ IDs are shared between C-RNTI scrambled and CS-RNTI scrambled communications.

In a wireless network, uplink HARQ may be utilized to ensure reliable data transmission from the UE to the network node. For example, when the UE transmits data over the PUSCH, the network node checks the data for errors. A HARQ process may terminate (e.g., conclude) either successfully or unsuccessfully. For example, where the network node detects an error in a received transmission, the network node may request retransmission by toggling the NDI in subsequent scheduling grants sent to the UE. By limiting the number of retransmissions, the HARQ process prevents increased latency and improves efficient resource allocation.

However, uplink HARQ may be asynchronous, meaning that retransmissions do not follow a fixed (e.g., periodic) timing pattern relative to the initial transmission. Rather, each retransmission is scheduled by the network. As a result, where the network node schedules uplink DCI, the UE may be informed of the scheduling of a new TB for a HARQ ID via NDI toggling (e.g., where an NDI value is toggled compared to its previous state for the same HARQ ID, the NDI indicates that a new transmission is scheduled). Accordingly, the UE may be aware of when an uplink HARQ ID is terminated, but the UE may be unaware of whether the HARQ ID was successfully terminated or unsuccessfully terminated. As a result, the network node may cease scheduling HARQ retransmission for a TB despite the TB not being successfully received. For example, the network may cease scheduling a HARQ retransmission based on a quantity of HARQ retransmissions satisfying (e.g., meeting or exceeding) a threshold. Similarly, where the UE missed an uplink DCI or the UE transmits a PUSCH message, but the network did not detect it, the network may determine that the UE skipped the PUSCH transmission because the UE did not have data to transmit. As a result, the network node may not send DCI for a HARQ retransmission.

In some examples, the network node may transmit a status report to the UE that indicates an RLC-layer ACK or NACK for an RLC SDU or an RLC SDU segment. By receiving this status report, the UE may be able to remove an upper-layer (e.g., the L2) buffer for ACKed (e.g., received) RLC SDUs or RLC SDU segments, and the UE may queue the NACKed (e.g., unreceived) RLC SDUs or RLC SDU segments for ARQ retransmission. However, this mechanism may cause increased latency for ARQ transmission and an increased buffer size at the UE. Additionally, network latency may be increased where the UE may wait for the network node to transmit the status report before the UE may act.

Various aspects relate generally to a UE receiving information indicating an unsuccessful HARQ termination event associated with an uplink TB associated with a HARQ ID rather than inferring the unsuccessful HARQ termination event or being unaware of it altogether, as discussed above. The UE may then (after receiving the information indicating the unsuccessful HARQ termination event) transmit an uplink transmission that includes an RLC SDU or RLC SDU segment associated with a respective uplink TB of the unsuccessful HARQ termination event. Some aspects more specifically relate to the information being received via an RLC status report indicating a NACK associated with the uplink TB. Additionally, the information may indicate a CC index, a HARQ ID, an NDI, and a time stamp associated with the unsuccessful HARQ termination event. In some aspects, the information may be a bitmap including a bit representing a HARQ ID associated with the uplink TB, where the value of the bit indicates the HARQ ID is associated with an unsuccessful HARQ termination event. Additionally the information may indicate an NDI and time stamp associated with the unsuccessful HARQ termination event. In some aspects, the bitmap may be associated with a CC index or the bitmap may be associated with one or more CCs. In some aspects, the information may indicate a time stamp for each unsuccessful HARQ termination event, where the time stamp indicates one or more time periods associated with scheduled PUSCHs associated with each respective uplink TB. Additionally, the information may include a time stamp indicating a time period associated with a PUSCH message that was successfully decoded before transmission of a respective uplink TB having a HARQ ID matching the HARQ ID of the PUSCH message.

In some aspects, despite receiving the indication of an unsuccessful HARQ termination event, the UE may skip transmission of the uplink transmission (e.g., skip retransmitting the RLC SDUs or the RLC SDU segments in the UL TB associated with the unsuccessful HARQ termination event) based on a determination that the UE did not receive an uplink grant associated with an NDI and HARQ ID matching the NDI and HARQ ID of the uplink TB, and/or based on a determination that the UE previously skipped an uplink transmission associated with the NDI and HARQ ID matching the NDI and HARQ ID of the uplink TB. Similarly, the UE may skip transmission of the uplink transmission based on the information received from the network node indicating that the respective uplink TB is not associated with an RLC SDU or RLC SDU segment. In some aspects, the UE may discard all RLC SDUs and RLC SDU segments associated with the uplink TB where the UE has not received, during a time period, an indication of an unsuccessful HARQ termination event associated with the uplink TB.

Particular aspects of the subject matter described in this disclosure can be implemented to realize one or more of the following potential advantages. In some examples, the described techniques can be used to reduce latency and to provide feedback signaling regarding unsuccessful HARQ termination events. For example, the described techniques can be used to reduce the probability of dropped communications or a latency associated with retransmitting missed communications. In some examples, where the information is indicated per uplink TB or HARQ ID and includes a NACK-only indication, the downlink overhead may be reduced for reporting unsuccessful HARQ termination events. Similarly, where the information indicating the unsuccessful HARQ termination events is transmitted only when an unsuccessful HARQ termination event occurs, the DCI overhead may be reduced. In some examples, where an unsuccessful HARQ termination event is indicated via a time stamp or according to an indication associated with a CC index or one or more CCs, the signaling overhead may be reduced, relative to explicitly reporting a relatively larger dataset identifying each unsuccessful HARQ termination event. Additionally, by discarding RLC SDUs and RLC SDU segments based on conditions configured by the network node, the UE may efficiently manage a transmission buffer by removing potentially outdated and/or irrelevant data, thereby optimizing resource allocation by freeing memory and transmission capacity for the UE to prioritize new or relevant data.

In a wireless network, uplink control messages may facilitate efficient communication between a UE and a network node. In some examples, uplink control messages may enable dynamic adjustments to resource allocation, power control, and link adaptation, which may reduce latency and increase reliability in network communication. For example, the UE may transmit a HARQ message to the network node in order to provide feedback on whether certain downlink transmissions were successfully received. Additionally, or alternatively, the UE may transmit a scheduling request (SR) to the network node, in which the UE may request uplink transmission resources.

In some examples, the HARQ process may end when the transmitted data is received correctly, and the network transmits an ACK message to the UE. Alternatively, the HARQ process may also terminate when a defined quantity of transmissions are made without a successful decoding at the network node. In such an example, the unsuccessful HARQ termination may end without an ACK and with the transmitted data being discarded.

Additionally, an ARQ retransmission mechanism may be utilized to enable error detection in communications between the UE and the network node. In some examples, the ARQ retransmission mechanism enables the network node to detect errors in transmitted data and request the UE to retransmit lost or corrupted data from a previous transmission (e.g., after an unsuccessful HARQ termination). Accordingly, the ARQ retransmission mechanism may enable reliable data reception and error correction in relatively poor network conditions.

However, uplink control messages are unable to utilize an ARQ retransmission mechanism. For example, uplink control messages are generally transmitted at a medium access control (MAC) layer and/or at a physical (PHY) layer, which do not utilize ARQ retransmissions. As a result, where the ARQ retransmission mechanism is unavailable, the UE and the network may experience decreased performance (e.g., in poor network conditions), resource allocation issues, and/or increased power consumption (e.g., where the UE may retransmit uplink control messages at increased transmit power levels).

Various aspects relate generally to a network node transmitting, and a UE receiving, an indication of an unsuccessful HARQ termination associated with a previous uplink TB including an uplink control message, and the UE transmitting, and the network node receiving, one or more uplink communications that includes a retransmission of the uplink control message. Some aspects more specifically relate to the uplink communications being associated with a different component carrier (CC) and HARQ ID than the CC or HARQ ID of the previous uplink TB. In some aspects, the retransmission of the uplink control message may include a retransmission of a payload associated with the uplink control message or may include a regeneration of the uplink control message included in the previous TB. Additionally, the uplink control message may be associated with an indication of unsuccessful HARQ termination events for previous downlink TBs. Additionally, the uplink communications may include a new indication of downlink HARQ termination events that occurred since transmission of the previous uplink TB, where the new indication may have a lower transmission priority than the transmission priority of the uplink control message retransmission. In some aspects, the new indication may be included in a regenerated uplink control message that is included in the retransmitted uplink control message. Additionally, the UE may transmit a capability indicator that indicates the UE's ability to store unsuccessful downlink HARQ termination events associated with the previous downlink TBs.

In some aspects, the UE may ignore a timer associated with transmission of a RLC status report, where the uplink control message in the previous uplink TB is associated with the RLC status report. Additionally, the UE may transmit new RLC status reports according to the timer, where the new RLC status reports are generated after transmission of the previous uplink TB. In some aspects, the UE may stop and reset a timer associated with transmission of an RLC status report where the uplink control message in the previous uplink TB is associated with the RLC status report, and the regenerated uplink control message may include an ACK or a NACK for sequence numbers (SNs) associated with an RLC or an RLC SDU segment received since transmission of the previous uplink TB.

In some aspects, the UE may perform a beam failure recovery (BFR) procedure (such as resetting beams or uplink power control values based on an identified new beam) based on receiving an indication of successful HARQ termination for an uplink control message in the previous uplink TB, where the uplink control message is associated with a BFR MAC control element (MAC-CE). Additionally, or alternatively, the UE may retransmit the BFR MAC-CE based on receiving an indication of unsuccessful HARQ termination for the uplink control message in the previous uplink TB. Additionally, the uplink communications may include new indications associated with beam failure events that occurred since transmission of the previous uplink TB. In some additional aspects, the retransmitted uplink control message includes a regeneration of a previous uplink control message, including updated fields associated with a BFR MAC-CE based on beam conditions received since transmission of the previous uplink TB. Additionally, the UE may receive, from the network node, an RRC message indicating conditions for retransmitting the uplink control message, where the conditions may be applied based on an uplink control message type associated with the uplink control message.

Particular aspects of the subject matter described in this disclosure can be implemented to realize one or more of the following potential advantages. In some examples, the described techniques can be used to decrease latency, improve network communication reliability, and ensure efficient resource allocation. For example, where the UE is able to retransmit uplink control messages upon receipt of an indication of an unsuccessful HARQ termination, the UE may increase the probability of consistent, reliable data delivery, thereby increasing spectral efficiency and decreasing latency due to a reduced quantity of repeated transmissions (e.g., as a result of missed or failed transmissions). Additionally, where the retransmission of the uplink control message includes a new indication of downlink HARQ termination events and the new indications are given a relatively lower transmission priority, the UE may prioritize retransmission of the original uplink control message prior to providing the network node with a new indication, while conserving transmit and power resources. Additionally, or alternatively, where the retransmission of the uplink control message is included in a regenerated payload (e.g., with the original uplink control message), the new indication and the original uplink control message may be provided concurrently to the network node.

Additionally, by ignoring the timer associated with transmission of an RLC status report associated with the previous uplink TB, the UE may ensure that the RLC status report is transmitted to the network node regardless of timing, thereby removing the effects of the missed transmission. Similarly, by following the timer for any new RLC status reports, the UE may reduce unnecessary signaling and/or retransmissions while ensuring transmission of the RLC status report associated with the previous uplink TB. Additionally, by stopping and resetting a timer associated with transmission of the RLC status report associated with the previous uplink TB, the UE may increase the probability of the uplink communications including an ACK or NACK for the SNs associated with an RLC SDU or RLC SDU segment received since transmission of the previous uplink TB.

In some examples, by including new indications associated with beam failure events in the uplink communications, the UE may provide updated beam failure information to the network. For example, where the retransmitted uplink control message includes updated fields associated with BFR MAC-CE based on beam conditions received since transmission of the previous uplink TB, the network may make decisions based on accurate, updated beam information, thereby increasing data transmission efficiency and reducing communication interruptions. Additionally, where the UE transmits a capability indicator that indicates the UE's ability to store unsuccessful downlink HARQ termination events associated with the previous downlink TBs, the network node may configure the retransmission of uplink control messages based on the type of uplink control message and/or according to a threshold quantity of retransmissions and/or a threshold time duration. As a result, the network may improve spectral efficiency by preventing unnecessary and/or relatively lower priority transmissions, depending on network traffic, available resources, or the like.

As described above, wireless communication systems may be deployed to provide various services, which may involve carrying or supporting voice, text, other messaging, video, data, and/or other traffic. Some wireless communications systems may employ multiple-access radio access technologies (RATs). The multiple-access RATs may be capable of supporting communication with multiple wireless communication devices by sharing the available system resources (for example, time domain resources, frequency domain resources, spatial domain resources, and/or device transmit power, among other examples). Examples of such multiple-access RATs include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

Multiple-access RATs are supported by technological advancements that have been adopted in various telecommunication standards, which define common protocols that enable wireless communication devices to communicate on a local, municipal, enterprise, national, regional, or global level. For example, 5G New Radio (NR) is part of a continuous mobile broadband evolution promulgated by the Third Generation Partnership Project (3GPP). 5G NR may support enhanced mobile broadband (eMBB) access, Internet of Things (IoT) networks or reduced capability (RedCap) device deployments, ultra-reliable low-latency communication (URLLC) applications, and/or massive machine-type communication (mMTC), among other examples.

To support these and other target verticals, a wireless communication system may be designed to implement a modularized functional infrastructure, a disaggregated and service-based network architecture, network function virtualization, network slicing, multi-access edge computing, millimeter wave (mmWave) technologies including massive multiple-input multiple-output (MIMO), beamforming, IoT device or RedCap device connectivity and management, industrial connectivity, licensed and unlicensed spectrum access, sidelink and other device-to-device direct communication (for example, cellular vehicle-to-everything (CV2X) communication), frequency spectrum expansion, overlapping spectrum use, small cell deployments, non-terrestrial network (NTN) deployments, device aggregation, advanced duplex communication (for example, sub-band full-duplex (SBFD)), multiple-subscriber implementations, high-precision positioning, radio frequency (RF) sensing, network energy savings (NES), low-power signaling and radios, and/or artificial intelligence or machine learning (AI/ML), among other examples.

The foregoing and other technological improvements may support use cases, such as wireless fronthauls, wireless midhauls, wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial and/or aerial platforms, among other examples.

As the demand for connectivity continues to increase, further improvements in NR may be implemented, and other RATs, such as 6G and beyond, may be introduced to enable new applications and facilitate new use cases. The methods, operations, apparatuses, and techniques described herein may enable one or more of the foregoing technologies or new technologies and/or support one or more of the foregoing use cases or new use cases.

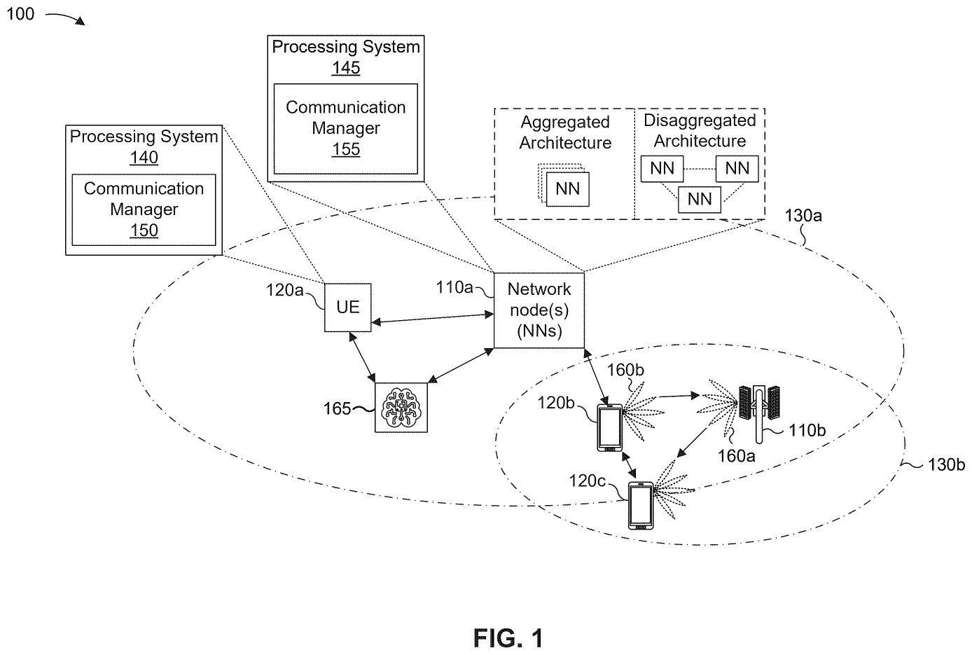

FIG. 1 is a diagram illustrating an example of a wireless communication network 100, in accordance with the present disclosure. The wireless communication network 100 may be or may include elements of a 5G (or NR) network or a 6G network, among other examples. The wireless communication network 100 may include multiple network nodes 110. For example, in FIG. 1, the wireless communication network 100 includes a network node (NN) 110a and a network node 110b. The network nodes 110 may support communications with multiple UEs 120. For example, in FIG. 1, the network nodes 110 support communication with a UE 120a, a UE 120b, and a UE 120c. In some examples, a UE 120 may also communicate with other UEs 120 and a network node 110 may communicate with a core network and with other network nodes 110.

The network nodes 110 and the UEs 120 of the wireless communication network 100 may communicate using the electromagnetic spectrum, which may be subdivided by frequency or wavelength into various classes, bands, carriers, and/or channels. For example, devices of the wireless communication network 100 may communicate using one or more operating bands. In some aspects, multiple wireless communication networks 100 may be deployed in a given geographic area. Each wireless communication network 100 may support a particular RAT (which may also be referred to as an air interface) and may operate on one or more carrier frequencies in one or more frequency bands or ranges. In some examples, when multiple RATs are deployed in a given geographic area, each RAT in the geographic area may operate on different frequencies to avoid interference with other RATs. Additionally or alternatively, in some examples, the wireless communication network 100 may implement dynamic spectrum sharing (DSS), in which multiple RATs are implemented with dynamic bandwidth allocation (for example, based on user demand) in a single frequency band. In some examples, the wireless communication network 100 may support communication over unlicensed spectrum, where access to an unlicensed channel is subject to a channel access mechanism. For example, in a shared or unlicensed frequency band, a transmitting device may perform a channel access procedure, such as a listen-before-talk (LBT) procedure, to contend against other devices for channel access before transmitting on a shared or unlicensed channel.

Various operating bands have been defined as frequency range designations FR1 (410 MHz through 7.125 GHz), FR2 (24.25 GHz through 52.6 GHz), FR3 (7.125 GHz through 24.25 GHz), FR4a or FR4-1 (52.6 GHz through 71 GHz), FR4 (52.6 GHz through 114.25 GHz), and FR5 (114.25 GHz through 300 GHz). Although a portion of FR1 is greater than 6 GHz, FR1 is often referred to (interchangeably) as a “sub-6 GHz” band in some documents and articles. Similarly, FR2 is often referred to (interchangeably) as a “millimeter wave” band in some documents and articles, despite being different than the extremely high frequency (EHF) band (30 GHz through 300 GHz), which is identified by the International Telecommunications Union (ITU) as a “millimeter wave” band. The frequencies between FR1 and FR2 are often referred to as mid-band frequencies, which include FR3. Frequency bands falling within FR3 may inherit FR1 characteristics or FR2 characteristics, and thus may effectively extend features of FR1 or FR2 into the mid-band frequencies. Thus, “sub-6 GHz,” if used herein, may broadly refer to frequencies that are less than 6 GHz, that are within FR1, and/or that are included in mid-band frequencies. Similarly, the term “millimeter wave,” if used herein, may broadly refer to mid-band frequencies or to frequencies that are within FR2, FR4, FR4-a or FR4-1, FR5, and/or the EHF band. Higher frequency bands may extend 5G NR operation, 6G operation, and/or other RATs beyond 52.6 GHz.

A network node 110 and/or a UE 120 may include one or more devices, components, or systems that enable communication with other devices, components, or systems of the wireless communication network 100. For example, a UE 120 and a network node 110 may each include one or more chips, system-on-chips (SoCs), chipsets, packages, or devices that individually or collectively constitute or comprise a processing system, such as a processing system 140 of the UE 120 or a processing system 145 of the network node 110. A processing system (for example, the processing system 140 and/or the processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), and/or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

The processing system 140 and the processing system 145 may each include memory circuitry in the form of one or multiple memory devices, memory blocks, memory elements, or other discrete gate or transistor logic or circuitry, each of which may include or implement tangible storage media such as random-access memory (RAM) or read-only memory (ROM), or combinations thereof (any one or more of which may be generally referred to herein individually as a “memory” or collectively as “the memory” or “the memory circuitry”). One or more of the memories may be coupled (for example, operatively coupled, communicatively coupled, electronically coupled, or electrically coupled) with one or more of the processors and may individually or collectively store processor-executable code or instructions (such as software) that, when executed by one or more of the processors, may configure one or more of the processors to perform various functions or operations described herein. Additionally or alternatively, in some examples, one or more of the processors may be configured to perform various functions or operations described herein without requiring configuration by software. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

The processing system 140 and the processing system 145 may each include or be coupled with one or more modems (such as a cellular (for example, a 5G or 6G compliant) modem). In some examples, one or more processors of the processing system 140 and/or the processing system 145 include or implement one or more of the modems. The processing system 140 and the processing system 145 may also include or be coupled with multiple radios (collectively “the radio”), multiple RF chains, or multiple transceivers, each of which may in turn be coupled with one or more of multiple antennas. In some examples, one or more processors of the processing system 140 and/or the processing system 145 include or implement one or more of the radios, RF chains, or transceivers. An RF chain may include one or more filters, mixers, oscillators, amplifiers, analog-to-digital converters (ADCs), and/or other devices that convert between an analog signal (such as for transmission or reception via an air interface) and a digital signal (such as for processing by the processing system 140 of the UE 120 or by the processing system 145 of the network node 110).

A network node 110 and a UE 120 may each include one or multiple antennas or antenna arrays. Typical network nodes 110 and UEs 120 may include multiple antennas, which may be organized or structured into one or more antenna panels, one or more antenna groups, one or more sets of antenna elements, or one or more antenna arrays, among other examples. As used herein, the term “antenna” can refer to one or more antennas, one or more antenna panels, one or more antenna groups, one or more sets of antenna elements, or one or more antenna arrays. The term “antenna panel” can refer to a group of antennas (such as antenna elements) arranged in an array or panel, which may facilitate beamforming by manipulating parameters associated with the group of antennas. The term “antenna module” may refer to circuitry including one or more antennas as well as one or more other components (such as filters, amplifiers, or processors) associated with integrating the antenna module into a wireless communication device such as the network node 110 and the UE 120.

A network node 110 may be, may include, or may also be referred to as an NR network node, a 5G network node, a 6G network node, a Node B, a gNB, an access point (AP), a transmission reception point (TRP), a network entity, a network element, a network equipment, and/or another type of device, component, or system included in a radio access network (RAN). In various deployments, a network node 110 may be implemented as a single physical node (for example, a single physical structure) or may be implemented as two or more physical nodes (for example, two or more distinct physical structures). For example, a network node 110 may be a device or system that implements a part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node having an aggregated architecture, meaning that the network node 110 may implement a full radio protocol stack that is physically and logically integrated within a single physical structure in the wireless communication network 100. For example, an aggregated network node 110 may consist of a single standalone base station or a single TRP that operates with a full radio protocol stack to enable or facilitate communication between a UE 120 and a core network of the wireless communication network 100.

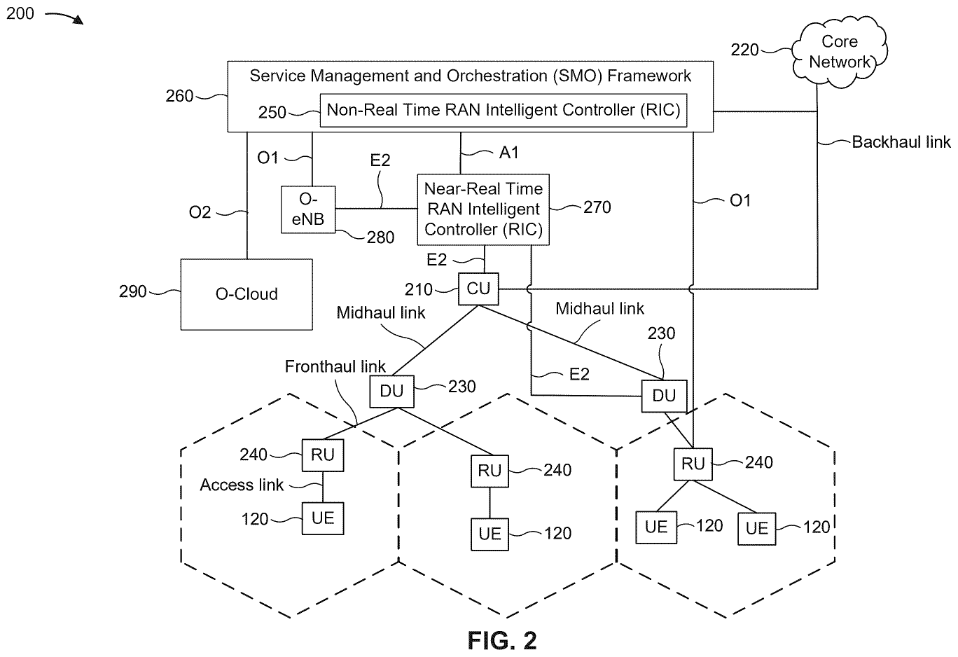

Alternatively, and as also shown, a network node 110 may be a disaggregated network node (sometimes referred to as a disaggregated base station), having a disaggregated architecture, meaning that the network node 110 may operate with a radio protocol stack that is physically distributed and/or logically distributed among two or more nodes in the same geographic location or in different geographic locations. An example disaggregated network node architecture is described in more detail below with reference to FIG. 2. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating network functionality into multiple units or modules that can be individually deployed.

The network nodes 110 of the wireless communication network 100 may include one or more central units (CUs), one or more distributed units (DUs), and one or more radio units (RUs). A CU may host one or more higher layers, such as an RRC layer, a packet data convergence protocol (PDCP) layer, and a service data adaptation protocol (SDAP) layer, among other examples. A DU may host one or more of a RLC layer, a MAC layer, and/or one or more higher PHY layers depending, at least in part, on a functional split, such as a functional split defined by the 3GPP. In some examples, a DU also may host a lower PHY layer that is configured to perform functions, such as a fast Fourier transform (FFT), an inverse FFT (IFFT), beamforming, and/or physical random access channel (PRACH) extraction and filtering, among other examples. An RU may perform RF processing functions or lower PHY layer functions, such as an FFT, an IFFT, beamforming, or PRACH extraction and filtering, among other examples, according to a functional split, such as a lower layer split (LLS). In such an architecture, each RU can be operated to handle over the air (OTA) communication with one or more UEs 120. In some examples, a single network node 110 may include a combination of one or more CUs, one or more DUs, and/or one or more RUs. In some examples, a CU, a DU, and/or an RU may be implemented as a virtual unit, such as a virtual central unit (VCU), a virtual distributed unit (VDU), or a virtual radio unit (VRU), among other examples, which may be implemented as a virtual network function, such as in a cloud deployment.

Some network nodes 110 (for example, a base station, an RU, or a TRP) may provide communication coverage for a particular geographic area. The term “cell” can refer to a coverage area of a network node 110 or to a network node 110 itself, depending on the context in which the term is used. A network node 110 may support one or more cells (for example, each cell may support communication within an angular (for example, 60 degree) range around the network node). In some examples, a network node 110 may provide communication coverage for a macro cell, a pico cell, a femto cell, or another type of cell. A macro cell may cover a relatively large geographic area (for example, several kilometers in radius) and may allow unrestricted access by UEs 120 with associated service subscriptions. A pico cell may cover a relatively small geographic area and may also allow unrestricted access by UEs 120 with associated service subscriptions. A femto cell may cover a relatively small geographic area (for example, a home) and may allow restricted access by UEs 120 having association with the femto cell (for example, UEs 120 in a closed subscriber group (CSG)). In some examples, a cell may not necessarily be stationary. For example, the geographic area of the cell may move according to the location of an associated mobile network node 110 (for example, a train, a satellite, an unmanned aerial vehicle, or an NTN network node).

The wireless communication network 100 may be a heterogeneous network that includes network nodes 110 of different types, such as macro network nodes, pico network nodes, femto network nodes, relay network nodes, aggregated network nodes, and/or disaggregated network nodes, among other examples. Various different types of network nodes 110 may generally transmit at different power levels, serve different coverage areas (for example, a cell 130a and a cell 130b), and/or have different impacts on interference in the wireless communication network 100 than other types of network nodes 110.

The UEs 120 may be physically dispersed throughout the coverage area of the wireless communication network 100, and each UE 120 may be stationary or mobile. A UE 120 may be, may include, or may also be referred to as an access terminal, a mobile station, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a netbook, a smartbook, an ultrabook, a medical device, a biometric device, a wearable device (for example, a smart watch, smart clothing, smart glasses, a smart wristband, or smart jewelry), a gaming device, an entertainment device (for example, a music device, a video device, or a satellite radio), an XR device, a vehicular component or sensor, a smart meter or sensor, industrial manufacturing equipment, a Global Navigation Satellite System (GNSS) device (such as a Global Positioning System device or another type of positioning device), a UE function of a network node, and/or any other suitable device or function that may communicate via a wireless medium.

Some UEs 120 may be classified according to different categories in association with different complexities and/or different capabilities. UEs 120 in a first category may facilitate massive IoT in the wireless communication network 100, and may offer low complexity and/or cost relative to UEs 120 in a second category. UEs 120 in a second category may include mission-critical IoT devices, legacy UEs, baseline UEs, high-tier UEs, advanced UEs, full-capability UEs, and/or premium UEs that are capable of URLLC, eMBB, and/or precise positioning in the wireless communication network 100, among other examples. A third category of UEs 120 may have mid-tier complexity and/or capability (for example, a capability between that of the UEs 120 of the first category and that of the UEs 120 of the second capability). A UE 120 of the third category may be referred to as a reduced capability UE (“RedCap UE”), a mid-tier UE, an NR-Light UE, and/or an NR-Lite UE, among other examples. RedCap UEs may bridge a gap between the capability and complexity of NB-IoT devices and/or eMTC UEs, and mission-critical IoT devices and/or premium UEs. RedCap UEs may include, for example, wearable devices, IoT devices, industrial sensors, or cameras that are associated with a limited bandwidth, power capacity, and/or transmission range, among other examples. RedCap UEs may support healthcare environments, building automation, electrical distribution, process automation, transport and logistics, or smart city deployments, among other examples.

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink and uplink resources may include time domain resources (for example, frames, subframes, slots, and symbols), frequency domain resources (for example, frequency bands, CCs, subcarriers, resource blocks, and resource elements), and spatial domain resources (for example, particular transmit directions or beams).

Frequency domain resources may be subdivided into bandwidth parts (BWPs). A BWP may be a block of frequency domain resources (for example, a continuous set of resource blocks (RBs) within a full component carrier bandwidth) that may be configured at a UE-specific level. A UE 120 may be configured with both an uplink BWP and a downlink BWP (which may be the same or different). Each BWP may be associated with its own numerology (indicating a sub-carrier spacing (SCS) and cyclic prefix (CP)). A BWP may be dynamically configured or activated (for example, by a network node 110 transmitting a DCI configuration to the one or more UEs 120) and/or reconfigured (for example, in real-time or near-real-time) according to changing network conditions in the wireless communication network 100 and/or specific requirements of one or more UEs 120. An active BWP defines the operating bandwidth of the UE 120 within the operating bandwidth of the serving cell. The use of BWPs enables more efficient use of the available frequency domain resources in the wireless communication network 100 because fewer frequency domain resources may be allocated to a BWP for a UE 120 (which may reduce the quantity of frequency domain resources that a UE 120 is required to monitor and reduce UE power consumption by enabling the UE to monitor fewer frequency domain resources), leaving more frequency domain resources to be spread across multiple UEs 120. Thus, BWPs may also assist in the implementation of lower-capability (for example, RedCap) UEs 120 by facilitating the configuration of smaller bandwidths for communication by such UEs 120 and/or by facilitating reduced UE power consumption.

As used herein, a downlink signal may be or include a reference signal, control information, or data. For example, downlink reference signals include a primary synchronization signal (PSS), a secondary SS (SSS), an SS block (SSB) (for example, that includes a PSS, an SSS, and a physical broadcast channel (PBCH)), a demodulation reference signal (DMRS), a phase tracking reference signal (PTRS), a tracking reference signal (TRS), and a channel state information (CSI) reference signal (CSI-RS), among other examples. A downlink signal carrying control information or data may be transmitted via a downlink channel. Downlink channels may include one or more control channels for transmitting control information and one or more data channels for transmitting data. Downlink reference signals may be transmitted in addition to, or multiplexed with, downlink control channel communications and/or downlink data channel communications. A downlink control channel may be specifically used to transmit DCI from a network node 110 to a UE 120. DCI generally contains the information the UE 120 needs to identify RBs in a subsequent subframe and how to decode them, including a modulation and coding scheme (MCS) or redundancy version parameters. Different DCI formats carry different information, such as scheduling information in the form of downlink or uplink grants, slot format indicators (SFIs), preemption indicators (PIs), transmit power control (TPC) commands, HARQ information, NDIs, among other examples. A downlink data channel may be used to transmit downlink data (for example, user data associated with a UE 120) from a network node 110 to a UE 120. Downlink control channels may include physical downlink control channels (PDCCHs), and downlink data channels may include physical downlink shared channels (PDSCHs). Control information or data communications may be transmitted on a PDCCH and PDSCH, respectively. For example, a PDCCH can carry DCI, while a PDSCH can carry a MAC-CE, an RRC message, or user data, among other examples. Each PDSCH may carry one or more transport blocks (TBs) of data.

As used herein, an uplink signal may include a reference signal, control information, or data. For example, uplink reference signals include a sounding reference signal (SRS), a PTRS, and a DMRS, among other examples. An uplink signal carrying control information or data may be transmitted via an uplink channel. An uplink channel may include one or more control channels for transmitting control information and one or more data channels for transmitting data. Uplink reference signals may be transmitted in addition to, or multiplexed with, uplink control channel communications and/or uplink data channel communications. An uplink control channel may be specifically used to transmit uplink control information (UCI) from a UE 120 to a network node 110. An uplink data channel may be used to transmit uplink data (for example, user data associated with a UE 120) from a UE 120 to a network node 110. Uplink control channels may include physical uplink control channels (PUCCHs), and uplink data channels may include PUSCHs. Control information or data communications may be transmitted on a PUCCH and PUSCH, respectively. For example, a PUCCH can carry UCI, while a PUSCH can carry a MAC-CE, an RRC message, or user data, among other examples. UCI can include a scheduling request (SR), HARQ feedback information (for example, a HARQ ACK indication or a HARQ NACK indication), uplink power control information (for example, an uplink TPC parameter), and/or CSI, among other examples. CSI can include a channel quality indicator (CQI) (indicative of downlink channel conditions to facilitate selection of transmission parameters, such as an MCS, by a network node 110), a precoding matrix indicator (PMI), a CSI-RS resource indicator (CRI) (for example, indicative of a beam used to transmit a CSI-RS), an SS/PBCH resource block indicator (SSBRI) (for example, indicative of a beam used to transmit an SSB), a layer indicator (LI), a rank indicator (RI), and/or measurement information (for example, an L1-reference signal received power (RSRP) parameter, a received signal strength indicator (RSSI) parameter, a reference signal received quality (RSRQ) parameter, among other examples) which can be used for beam management, among other examples. Each PUSCH may carry one or more TBs of data.

The information (for example, data, control information, or reference signal information) transmitted by a network node 110 to a UE 120, or vice versa, may be represented as a sequence of binary bits that are mapped (for example, modulated) to an analog signal waveform (for example, a discrete Fourier transform (DFT)-spread-orthogonal frequency division multiplexing (OFDM) (DFT-s-OFDM) waveform or a CP-OFDM waveform) that is transmitted by the network node 110 or UE 120 over a wireless communication channel. In some examples, the network node 110 or the UE 120 (for example, using the processing system 145 or the processing system 140, respectively) may select an MCS (for example, an order of quadrature amplitude modulation (QAM), such as 64-QAM, 128-QAM, or 256-QAM, among other examples) for a downlink signal or an uplink signal. For example, the network node 110 may select an MCS for a downlink signal in accordance with UCI received from the UE 120. The network node 110 may transmit, to the UE 120, an indication of the selected MCS for the downlink signal, such as via DCI that schedules the downlink signal. As another example, the network node 110 may transmit, and the UE 120 may receive, an indication of an MCS to be applied for the one or more uplink signals, such as via DCI scheduling transmission of the one or more uplink signals.

The network node 110 or the UE 120 (such as by using the processing system 145 or the processing system 140, respectively, and/or one or more coupled modems) may perform signal processing on the information (such as filtering, amplification, modulation, digital-to-analog conversion, an IFFT operation, multiplexing, interleaving, mapping, and/or encoding, among other examples) to generate a processed signal in accordance with the selected MCS. In some examples, the network node 110 or the UE 120 (for example, using the processing system 145 or the processing system 140, respectively, and/or one or more coupled encoders or modems) may perform a channel coding operation or a forward error correction (FEC) operation to control errors in transmitted information. For example, the network node 110 or the UE 120 may perform an encoding operation to generate encoded information (such as by selectively introducing redundancy into the information, typically using an error correction code (ECC), such as a polar code or a low-density parity-check (LDPC) code). The network node 110 or the UE 120 (for example, using the processing system 145 and/or one or more modems) may further perform spatial processing (for example, precoding) on the encoded information to generate one or more processed or precoded signals for downlink or uplink transmission, respectively. In some examples, the network node 110 or the UE 120 may perform codebook-based precoding or non-codebook-based precoding. Codebook-based precoding may involve selecting a precoder (for example, a precoding matrix) using a codebook. For example, the network node 110 may provide precoding information indicating which precoder, defined by the codebook, is to be used by the UE 120. Non-codebook-based precoding may involve selecting or deriving a precoder based on, or otherwise associated with, one or more downlink or uplink signal measurements. The network node 110 or the UE 120 may transmit the processed downlink or uplink signals, respectively, via one or more antennas.

The network node 110 or the UE 120 may receive uplink signals or downlink signals, respectively, via one or more antennas. The network node 110 or the UE 120 (for example, using the processing system 145 or the processing system 140, respectively, and/or one or more coupled modems) may perform signal processing (for example, in accordance with the MCS) on the received uplink or downlink signals, respectively (such as filtering, amplification, demodulation, analog-to-digital conversion, an FFT operation, demultiplexing, deinterleaving, de-mapping, equalization, interference cancellation, and/or decoding, among other examples), to map the received signal(s) to a sequence of binary bits (for example, received information) that estimates the information transmitted by the network node 110 or the UE 120 via the downlink or uplink signals. The network node 110 or the UE 120 (for example, using the processing system 145 or the processing system 140, respectively, and/or a coupled decoder or one or more modems) may decode the received information (such as by using an ECC, a decoding operation, and/or an FEC operation) to detect errors and/or correct bit errors in the received information to generate decoded information. The decoded information may estimate the information transmitted via the downlink or uplink signals.

In some examples, a UE 120 and a network node 110 may perform MIMO communication. “MIMO” generally refers to transmitting or receiving multiple signals (such as multiple layers or multiple data streams) simultaneously over the same time and frequency resources. MIMO techniques generally exploit multipath propagation. A network node 110 and/or UE 120 may communicate using massive MIMO, multi-user MIMO, or single-user MIMO, which may involve rapid switching between beams or cells. For example, the amplitudes and/or phases of signals transmitted via antenna elements and/or sub-elements may be modulated and shifted relative to each other (such as by manipulating a phase shift, a phase offset, and/or an amplitude) to generate one or more beams, which is referred to as beamforming. For example, the network node 110b may generate one or more beams 160a, and the UE 120b may generate one or more beams 160b. The term “beam” may refer to a directional transmission of a wireless signal toward a receiving device or otherwise in a desired direction, a directional reception of a wireless signal from a transmitting device or otherwise in a desired direction, a direction associated with a directional transmission or directional reception, a set of directional resources associated with a signal transmission or signal reception (for example, an angle of arrival, a horizontal direction, and/or a vertical direction), a set of parameters that indicate one or more aspects of a directional signal, a direction associated with the signal, and/or a set of directional resources associated with the signal, among other examples.

MIMO may be implemented using various spatial processing or spatial multiplexing operations. In some examples, MIMO may include a massive MIMO technique which may be associated with an increased (for example, “massive”) quantity of antennas at the network node 110 and/or at the UE 120, such as in a network implementing mmWave technology. Massive MIMO may improve communication reliability by enabling a network node 110 and/or a UE 120 to communicate the same data across different propagation (or spatial) paths. In some examples, MIMO may support simultaneous transmission to multiple receivers, referred to as multi-user MIMO (MU-MIMO). Some RATs may employ MIMO techniques, such as multi-TRP (mTRP) operation (including redundant transmission or reception on multiple TRPs), reciprocity in the time domain or the frequency domain, single-frequency-network (SFN) transmission, or non-coherent joint transmission (NC-JT).

To support MIMO techniques, the network node 110 and the UE 120 may perform one or more beam management operations, such as an initial beam acquisition operation, one or more beam refinement operations, and/or a beam recovery operation. For example, an initial beam acquisition operation may involve the network node 110 transmitting signals (for example, SSBs, CSI-RSs, or other signals) via respective beams (for example, of the beams 160a of the network node 110) and the UE 120 receiving and measuring the signal(s) via respective beams of multiple beams (for example, from the beams 160b of the UE 120) to identify a best beam (or beam pair) for communication between the UE 120 and the network node 110. For example, the UE 120 may transmit an indication (for example, in a message associated with a random access channel (RACH) operation) of a (best) identified beam of the network node 110 (for example, by indicating an SSBRI or other identifier associated with the beam). A beam refinement operation may involve a first device (for example, the UE 120 or the network node 110) transmitting signal(s) via a subset of beams (for example, identified based on, or otherwise associated with, measurements reported as part of one or more other beam management operations). A second device (for example, the network node 110 or the UE 120) may receive the signal(s) via a single beam (for example, to identify the best beam for communication from the subset of beams). The beam(s) may be identified via one or more spatial parameters, such as a transmission configuration indicator (TCI) state and/or a quasi co-location (QCL) parameter, among other examples. The network node 110 and the UE 120 may increase reliability and/or achieve efficiencies in throughput, signal strength, and/or other signal properties for massive MIMO operations by performing the beam management operations.

Some aspects and techniques as described herein may be implemented, at least in part, using an artificial intelligence (AI) program (for example, referred to herein as an “AI/ML model”), such as a program that includes a machine learning (ML) model and/or an artificial neural network (ANN) model. The AI/ML model may be deployed at one or more devices 165 (for example, one or more network nodes 110, one or more UEs 120, and/or one or more servers, and/or one or more components of a cloud computing network, among other examples). For example, in an deployment where AI/ML functionality is performed independently at a device 165, sometimes referred to as “overlay AI/ML”, the AI/ML model (or an instance or portion of the AI/ML model) may be deployed at a UE 120 (for example, at the processing system 140), a network node 110 (for example, at the processing system 145), one or more servers, and/or one or more components of a cloud computing network, among other examples. Additionally or alternatively, in a deployment where AI/ML functionality is coordinated between different devices 165, sometimes referred to as “coordinated AI/ML”, or performed at all device and network layers, sometimes referred to as “native AI/ML”, the AI/ML model (or an instance of the AI/ML model) may be deployed at multiple devices 165 (for example, a first portion of the AI/ML model may be deployed at a UE 120 and a second portion of the AI/ML model may be deployed at a network node 110). In other examples of coordinated AI/ML and/or native AI/ML, a first AI/ML model may be deployed at a UE 120 and a second AI/ML model may be deployed at a network node 110. The AI/ML model(s) may be configured to enhance various aspects of the wireless communication network 100 (for example, to increase privacy, reliability, and/or efficient use of network bandwidth, and/or to reduce latency, among other examples). For example, the AI/ML model(s) may be trained to identify patterns or relationships in data corresponding to the wireless communication network 100, a device, and/or an air interface, among other examples. The AI/ML model(s) may support operational decisions relating to one or more aspects associated with wireless communications devices, networks, or services.

Accordingly, in some examples, the AI/ML model(s) may enable AI-as-a-Service (for example, an end-to-end AI/ML service via a user plane) for use cases such as a self-organizing network (SON), minimization of drive test (MDT), quality of experience (QoE), positioning, sensing, predictive mobility, and/or traffic prediction, among other examples. In some examples, AI-as-a-Service use cases may include measurement collection reporting by a UE 120, device selection criteria (for example, according to a geographical area where measurements are to be collected and/or UE capabilities to be used to collected measurements), and/or reporting configurations (for example, reporting parameters such as location, time, and/or sensor information, among other examples). Additionally or alternatively, the AI/ML model(s) may enable AI/ML procedures (for example, RAN-triggered service establishment, configuration, inferencing using UE-side and/or network-side models, performance monitoring and/or management, and/or capability signaling, among other examples). Additionally or alternatively, the AI/ML model(s) may enable RAN-based AI/ML services via one or more application program interfaces (APIs) and/or management interfaces for use cases such as beam management, radio resource monitoring (RRM) relaxation, mobility prediction, load prediction, network energy savings, and/or coverage and capacity improvements, among other examples).

In some aspects, the UE 120 may include a communication manager 150. As described in more detail elsewhere herein, the communication manager 150 may receive a first message identifying a resource allocation for a CG-PUSCH communication; transmit, using the resource allocation, the CG-PUSCH communication; and receive DCI scheduling a re-transmission of the CG-PUSCH communication, wherein the DCI includes a feedback message associated with one or more prior transport blocks (TBs). Additionally, or alternatively, the communication manager 150 may receive a DCI message associated with scheduling a new TB on a physical uplink shared channel, wherein the DCI message includes a feedback indication of a previous TB; and transmit one or more uplink communications, wherein whether the one or more uplink communications includes a retransmission of information associated with the previous TB is based on the feedback indication. Additionally, or alternatively, the communication manager 150 may receive a non-scheduling DCI message, wherein the DCI message includes an ARQ feedback indication of a previous TB scheduled in a PUSCH and scheduled by a previous DCI, wherein the non-scheduling DCI includes a configuration associated with validation of the non-scheduling DCI; and transmit one or more uplink communications to re-transmit information associated with the previous TB based on the feedback indication. Additionally, or alternatively, the communication manager 150 may receive, via a transceiver from a network node 110, an indication of an unsuccessful HARQ termination associated with a previous uplink TB, wherein the previous uplink TB includes an uplink control message; and transmit, via the transceiver to the network node 110, one or more uplink communications, wherein the one or more uplink communications include a retransmission of the uplink control message. Additionally, or alternatively, the communication manager 150 may receive, via the transceiver from a network node 110, information that indicates one or more unsuccessful HARQ termination events associated with one or more respective uplink TBs associated with one or more HARQ IDs; and transmit, via the transceiver to the network node 110, one or more uplink transmissions, wherein the one or more uplink transmissions include a retransmission of at least one of one or more RLC SDUs or one or more RLC SDU segments associated with a respective uplink TB, of the one or more respective uplink TBs, associated with a valid unsuccessful HARQ termination event of the one or more unsuccessful HARQ termination events. Additionally, or alternatively, the communication manager 150 may perform one or more other operations described herein.

In some aspects, the network node 110 may include a communication manager 155. As described in more detail elsewhere herein, the communication manager 155 may transmit a first message identifying a resource allocation for a CG-PUSCH communication; and transmit DCI scheduling a re-transmission of the CG-PUSCH communication, wherein the DCI includes a feedback message associated with one or more prior TBs. Additionally, or alternatively, the communication manager 155 may transmit a DCI message associated with scheduling a new TB on a physical uplink shared channel, wherein the DCI message includes a feedback indication of a previous TB; and receive one or more uplink communications, wherein whether the one or more uplink communications includes a retransmission of information associated with the previous TB is based on the feedback indication. Additionally, or alternatively, the communication manager 155 may transmit a non-scheduling DCI message, wherein the DCI message includes a ARQ indication of a TB scheduled in a PUSCH and scheduled by a previous DCI, wherein the non-scheduling DCI includes a configuration associated with validation of the non-scheduling DCI; and receive one or more uplink communications to re-transmit information associated with the previous TB based on the feedback indication. Additionally, or alternatively, the communication manager 155 may transmit, to a UE 120, an indication of an unsuccessful HARQ termination associated with a previous uplink TB, wherein the previous uplink TB includes an uplink control message; and receive, from the UE 120, one or more uplink communications, wherein the one or more uplink communications include a retransmission of the uplink control message. Additionally, or alternatively, the communication manager 155 may perform one or more other operations described herein. Additionally, or alternatively, the communication manager 155 may transmit, via a transceiver to a UE 120, information that indicates one or more unsuccessful HARQ termination events associated with one or more respective uplink TBs associated with one or more HARQ IDs; and receive, via the transceiver from the UE 120, one or more uplink transmissions, wherein the one or more uplink transmissions include a retransmission of at least one of one or more RLC SDUs or one or more RLC SDU segments associated with a respective uplink TB, of the one or more respective uplink TBs, associated with a valid unsuccessful HARQ termination event of the one or more unsuccessful HARQ termination events. Additionally, or alternatively, the communication manager 155 may perform one or more other operations described herein.

FIG. 2 is a diagram illustrating an example disaggregated network node architecture 200, in accordance with the present disclosure. One or more components of the example disaggregated network node architecture 200 may be, may include, or may be included in one or more network nodes (such one or more network nodes 110). The disaggregated network node architecture 200 may include a CU 210 that can communicate directly with a core network 220 via a backhaul link, or that can communicate indirectly with the core network 220 via one or more disaggregated control units, such as a non-real-time (Non-RT) RAN intelligent controller (RIC) 250 associated with a Service Management and Orchestration (SMO) Framework 260 and/or a near-real-time (Near-RT) RIC 270 (for example, via an E2 link). The CU 210 may communicate with one or more DUs 230 via respective midhaul links, such as via F1 interfaces. Each of the DUs 230 may communicate with one or more RUs 240 via respective fronthaul links. Each of the RUs 240 may communicate with one or more UEs 120 via respective RF access links. In some deployments, a UE 120 may be simultaneously served by multiple RUs 240.

Each of the components of the disaggregated network node architecture 200, including the CUs 210, the DUs 230, the RUs 240, the Near-RT RICs 270, the Non-RT RICs 250, and the SMO Framework 260, may include one or more interfaces or may be coupled with one or more interfaces for receiving or transmitting signals, such as data or information, via a wired or wireless transmission medium.

In some aspects, the CU 210 may be logically split into one or more CU user plane (CU-UP) units and one or more CU control plane (CU-CP) units. A CU-UP unit may communicate bidirectionally with a CU-CP unit via an interface, such as the E1 interface when implemented in an O-RAN configuration. The CU 210 may be deployed to communicate with one or more DUs 230, as necessary, for network control and signaling. Each DU 230 may correspond to a logical unit that includes one or more base station functions to control the operation of one or more RUs 240. For example, a DU 230 may host various layers, such as an RLC layer, a MAC layer, or one or more PHY layers, such as one or more high PHY layers or one or more low PHY layers. Each layer (which also may be referred to as a module) may be implemented with an interface for communicating signals with other layers (and modules) hosted by the DU 230, or for communicating signals with the control functions hosted by the CU 210. Each RU 240 may implement lower layer functionality. In some aspects, real-time and non-real-time aspects of control and user plane communication with the RU(s) 240 may be controlled by the corresponding DU 230.

The SMO Framework 260 may support RAN deployment and provisioning of non-virtualized and virtualized network elements. For non-virtualized network elements, the SMO Framework 260 may support the deployment of dedicated physical resources for RAN coverage requirements, which may be managed via an operations and maintenance interface, such as an O1 interface. For virtualized network elements, the SMO Framework 260 may interact with a cloud computing platform (such as an open cloud (O-Cloud) platform 290) to perform network element life cycle management (such as to instantiate virtualized network elements) via a cloud computing platform interface, such as an O2 interface. A virtualized network element may include, but is not limited to, a CU 210, a DU 230, an RU 240, a non-RT RIC 250, and/or a Near-RT RIC 270. In some aspects, the SMO Framework 260 may communicate with a hardware aspect of a 4G RAN, a 5G NR RAN, and/or a 6G RAN, such as an open eNB (O-eNB) 280, via an O1 interface. Additionally or alternatively, the SMO Framework 260 may communicate directly with each of one or more RUs 240 via a respective O1 interface. In some deployments, this configuration can enable each DU 230 and the CU 210 to be implemented in a cloud-based RAN architecture, such as a vRAN architecture.

The Non-RT RIC 250 may include or may implement a logical function that enables non-real-time control and optimization of RAN elements and resources, AI/ML workflows including model training and updates, and/or policy-based guidance of applications and/or features in the Near-RT RIC 270. The Non-RT RIC 250 may be coupled to or may communicate with (such as via an A1 interface) the Near-RT RIC 270. The Near-RT RIC 270 may include or may implement a logical function that enables near-real-time control and optimization of RAN elements and resources via data collection and actions via an interface (such as via an E2 interface) connecting one or more CUs 210, one or more DUs 230, and/or an O-eNB 280 with the Near-RT RIC 270.

In some aspects, to generate AI/ML models to be deployed in the Near-RT RIC 270, the Non-RT RIC 250 may receive parameters or external enrichment information from external servers. Such information may be utilized by the Near-RT RIC 270 and may be received at the SMO Framework 260 or the Non-RT RIC 250 from non-network data sources or from network functions. In some examples, the Non-RT RIC 250 or the Near-RT RIC 270 may tune RAN behavior or performance. For example, the Non-RT RIC 250 may monitor long-term trends and patterns for performance and may employ AI/ML models to perform corrective actions via the SMO Framework 260 (such as reconfiguration via an O1 interface) or via creation of RAN management policies (such as A1 interface policies).

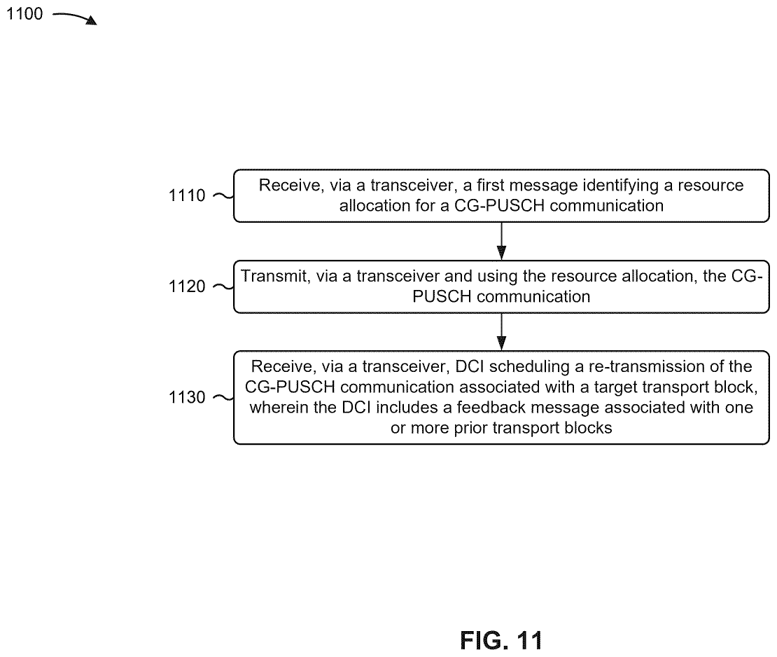

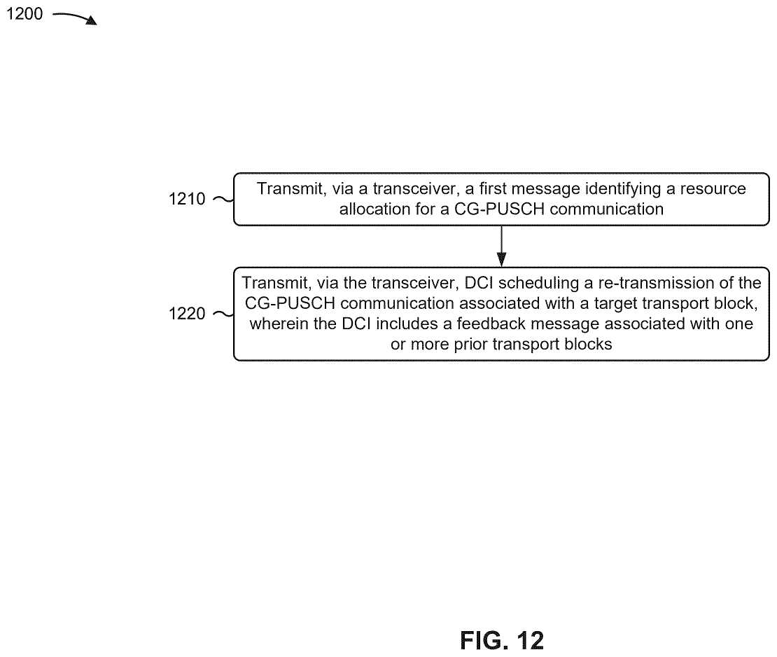

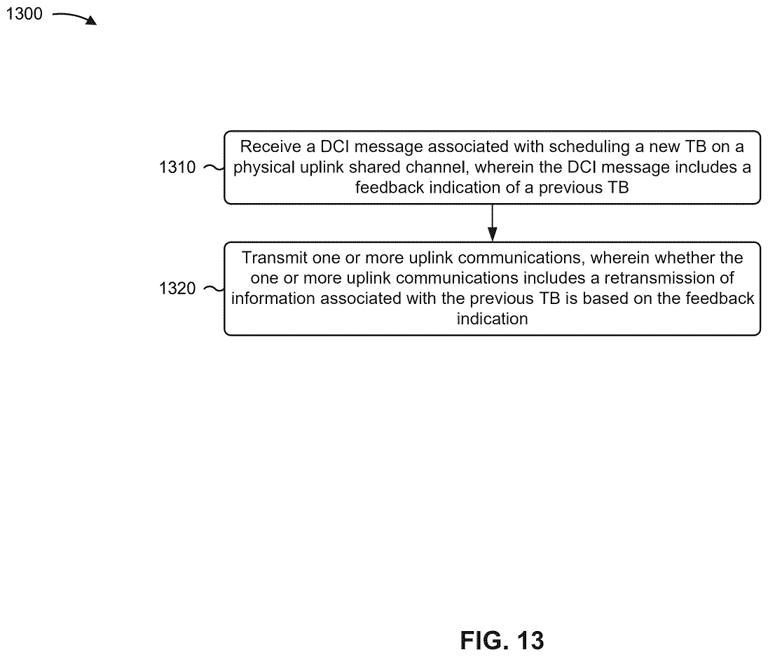

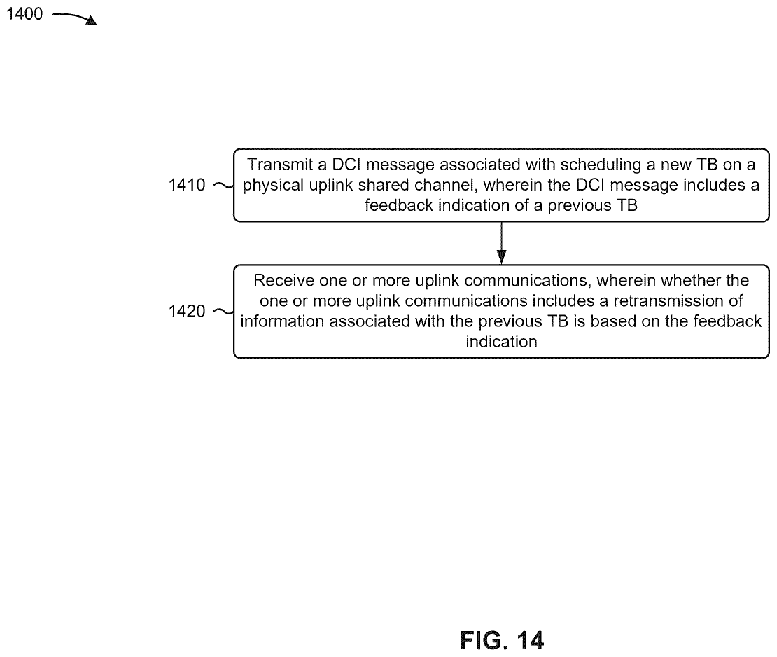

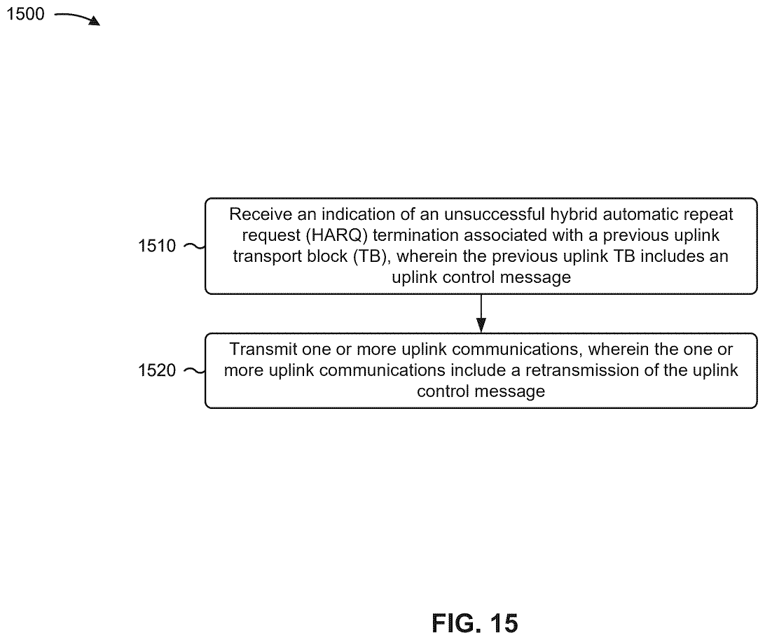

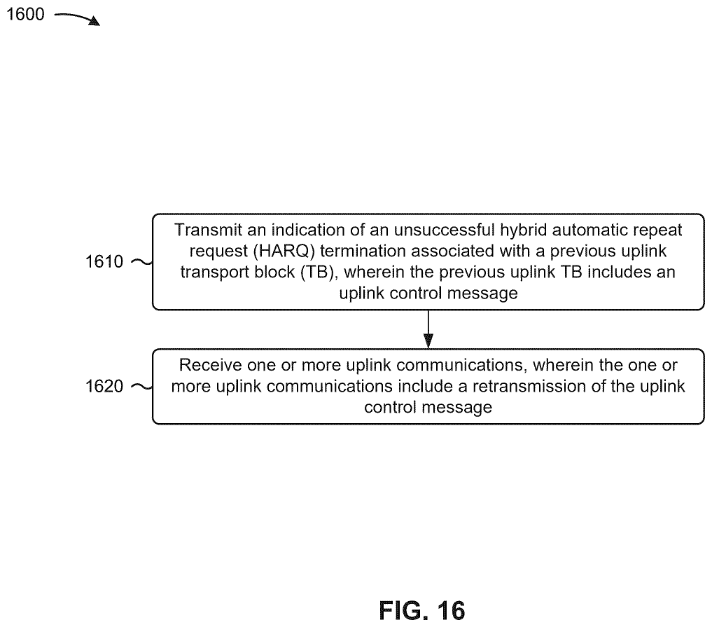

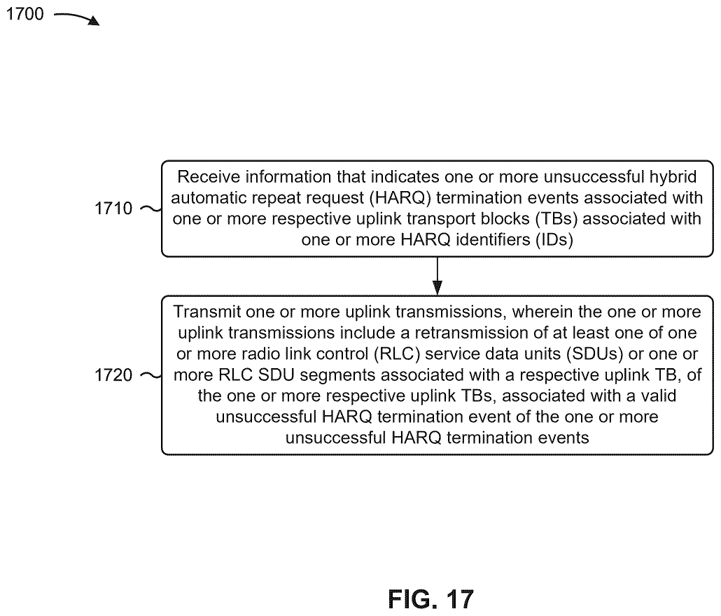

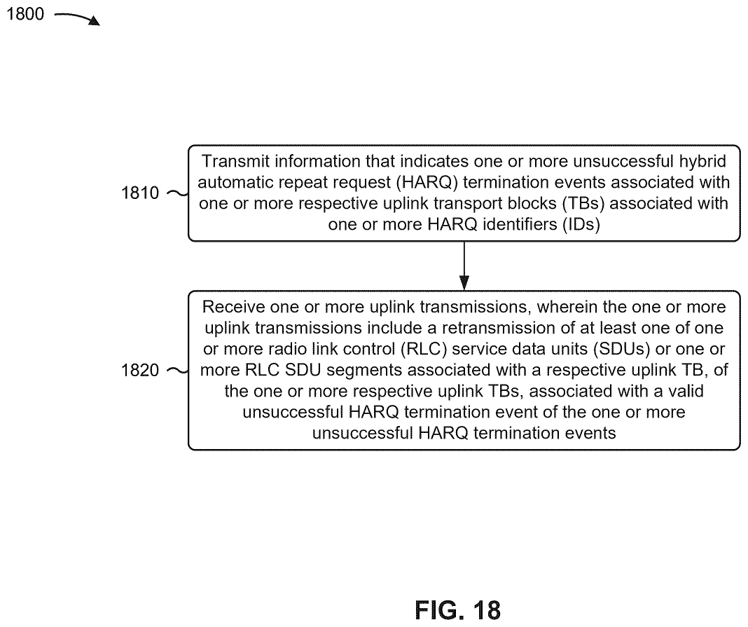

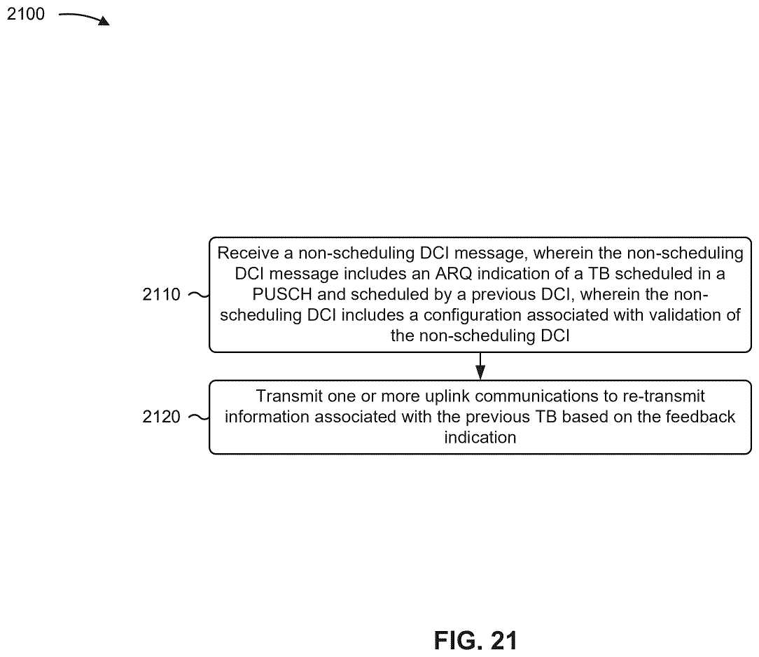

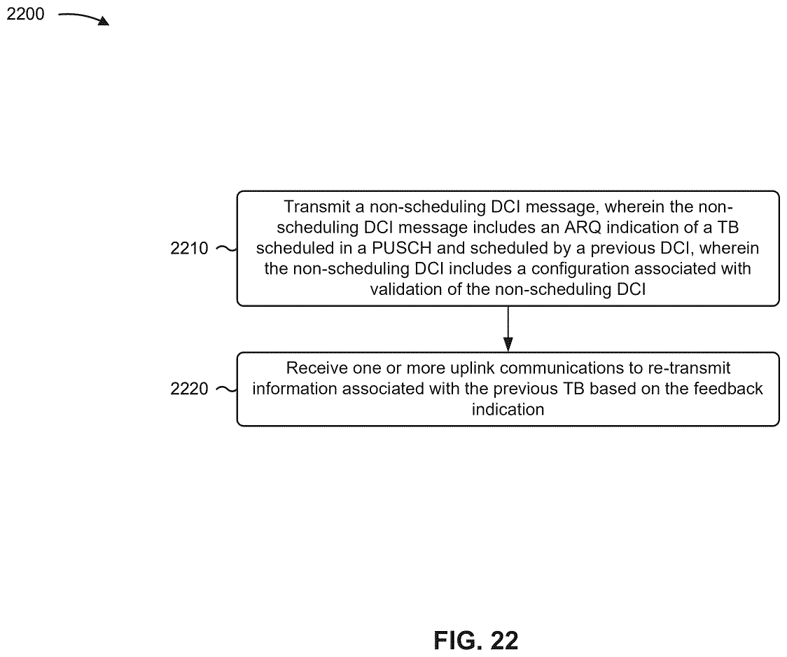

The network node 110, the processing system 145 of the network node 110, the UE 120, the processing system 140 of the UE 120, the CU 210, the DU 230, the RU 240, or any other component(s) of FIG. 1 and/or FIG. 2 may implement one or more techniques or perform one or more operations associated with feedback messaging for configured grant communication, indication of unsuccessful HARQ termination for uplink communication, ARQ transmission for uplink control messages, or signaling of uplink ARQ, among other examples, as described in more detail elsewhere herein. For example, the processing system 145 of the network node 110, the processing system 140 of the UE 120, the CU 210, the DU 230, or the RU 240 may perform or direct operations of, for example, process 1100 of FIG. 11, process 1200 of FIG. 12, process 1300 of FIG. 13, process 1400 of FIG. 14, process 1500 of FIG. 15, process 1600 of FIG. 16, process 1700 of FIG. 17, process 1800 of FIG. 18, process 2100 of FIG. 21, process 2200 of FIG. 22, or other processes as described herein (alone or in conjunction with one or more other processors). Memory of the network node 110 may store data and program code (or instructions) for the network node 110, the CU 210, the DU 230, or the RU 240. In some examples, the memory of the network node 110 may store data relating to a UE 120, such as RRC state information or a UE context. Memory of a UE 120 may store data and program code (or instructions) for the UE 120, such as context information. In some examples, the memory of the UE 120 or the memory of the network node 110 may include a non-transitory computer-readable medium storing a set of instructions for wireless communication. For example, the set of instructions, when executed by one or more processors (for example, of the processing system 145 or the processing system 140) of the network node 110, the UE 120, the CU 210, the DU 230, or the RU 240, may cause the one or more processors to perform process 1100 of FIG. 11, process 1200 of FIG. 12, process 1300 of FIG. 13, process 1400 of FIG. 14, process 1500 of FIG. 15, process 1600 of FIG. 16, process 1700 of FIG. 17, process 1800 of FIG. 18, process 2100 of FIG. 21, or process 2200 of FIG. 22, or other processes as described herein. In some examples, executing instructions may include running the instructions, converting the instructions, compiling the instructions, and/or interpreting the instructions, among other examples.

In some aspects, the UE 120 includes means for receiving a first message identifying a resource allocation for a CG-PUSCH communication; means for transmitting, using the resource allocation, the CG-PUSCH communication; and/or means for receiving DCI scheduling a re-transmission of the CG-PUSCH communication, wherein the DCI includes a feedback message associated with one or more prior TBs. The DCI schedules the re-transmission of the CG-PUSCH in a target TB, where the target TB and the one or more prior TBs have a common HARQ ID. In some aspects, the UE 120 includes means for receiving a DCI message associated with scheduling a new TB on a PUSCH, wherein the DCI message includes a feedback indication of a previous TB; and/or means for transmitting one or more uplink communications, wherein whether the one or more uplink communications includes a retransmission of information associated with the previous TB is based on the feedback indication. In some aspects, the UE 120 includes means for receiving a non-scheduling DCI message, wherein the DCI message includes an ARQ feedback indication of a previous TB scheduled in a PUSCH and scheduled by a previous DCI, wherein the non-scheduling DCI includes a configuration associated with validation of the non-scheduling DCI; and/or means for transmitting one or more uplink communications to re-transmit information associated with the previous TB based on the feedback indication.

In some aspects, the UE 120 includes means for receiving, from a network node 110, an indication of an unsuccessful HARQ termination associated with a previous uplink TB, wherein the previous uplink TB includes an uplink control message; and/or means for transmitting, to the network node 110, one or more uplink communications, wherein the one or more uplink communications include a retransmission of the uplink control message. In some aspects, the UE 120 includes means for receiving, via a transceiver from a network node 110, information that indicates one or more unsuccessful HARQ termination events associated with one or more respective uplink TBs associated with one or more HARQ IDs; and/or means for transmitting, via the transceiver to the network node 110, one or more uplink transmissions, wherein the one or more uplink transmissions include a retransmission of at least one of one or more RLC SDUs or one or more RLC SDU segments associated with a respective uplink TB, of the one or more respective uplink TBs, associated with a valid unsuccessful HARQ termination event of the one or more unsuccessful HARQ termination events.

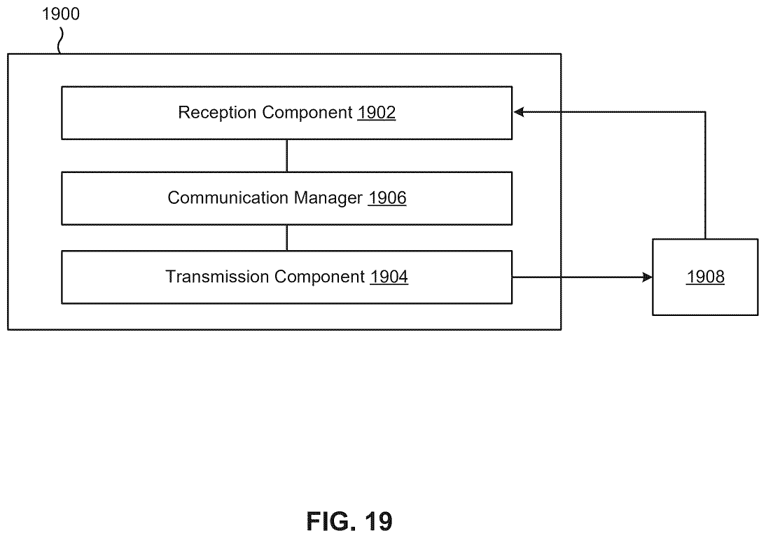

The means for the UE 120 to perform operations described herein may include, for example, one or more of communication manager 150, processing system 140, a radio, one or more RF chains, one or more transceivers, one or more antennas, one or more modems, a reception component (for example, reception component 1902 depicted and described in connection with FIG. 19), and/or a transmission component (for example, transmission component 1904 depicted and described in connection with FIG. 19), among other examples.

In some aspects, the network node 110 includes means for transmitting a first message identifying a resource allocation for a CG-PUSCH communication; and/or means for transmitting DCI scheduling a re-transmission of the CG-PUSCH communication, wherein the DCI includes a feedback message associated with one or more prior TBs. In some aspects, the network node 110 includes means for transmitting a DCI message associated with scheduling a new TB on a physical uplink shared channel, wherein the DCI message includes a feedback indication of a previous TB; and/or means for receiving one or more uplink communications, wherein whether the one or more uplink communications includes a retransmission of information associated with the previous TB is based on the feedback indication. In some aspects, the network node 110 includes means for transmitting a non-scheduling DCI message, wherein the DCI message includes an ARQ feedback indication of a previous TB scheduled in a PUSCH and scheduled by a previous DCI, wherein the non-scheduling DCI includes a configuration associated with validation of the non-scheduling DCI; and/or means for receiving one or more uplink communications to re-transmit information associated with the previous TB based on the feedback indication.

In some aspects, the network node 110 includes means for transmitting, to a UE 120, an indication of an unsuccessful HARQ termination associated with a previous uplink TB, wherein the previous uplink TB includes an uplink control message; and/or means for receiving, from the UE 120, one or more uplink communications, wherein the one or more uplink communications include a retransmission of the uplink control message. In some aspects, the network node 110 includes means for transmitting, via a transceiver to a UE 120, information that indicates one or more unsuccessful HARQ termination events associated with one or more respective uplink TBs associated with one or more HARQ IDs; and/or means for receiving, via the transceiver from the UE 120, one or more uplink transmissions, wherein the one or more uplink transmissions include a retransmission of at least one of one or more RLC SDUs or one or more RLC SDU segments associated with a respective uplink TB, of the one or more respective uplink TBs, associated with a valid unsuccessful HARQ termination event of the one or more unsuccessful HARQ termination events.

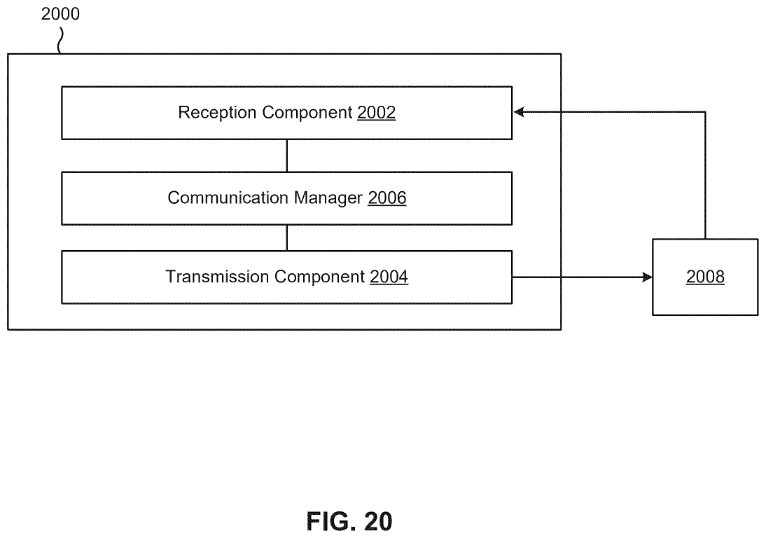

The means for the network node to perform operations described herein may include, for example, one or more of communication manager 155, processing system 145, a radio, one or more RF chains, one or more transceivers, one or more antennas, one or more modems, a reception component (for example, reception component 2002 depicted and described in connection with FIG. 20), and/or a transmission component (for example, transmission component 2004 depicted and described in connection with FIG. 20), among other examples.

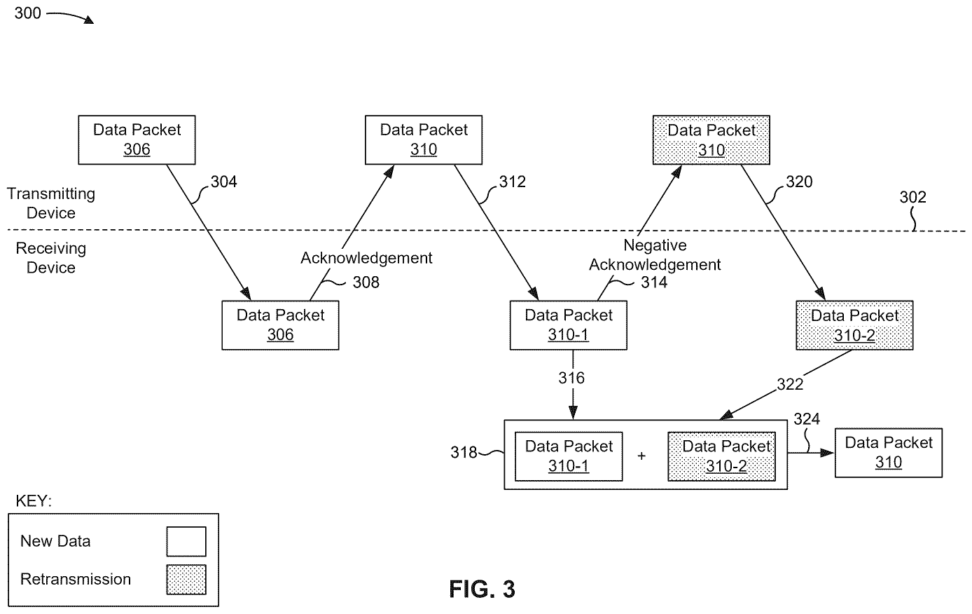

FIG. 3 is a diagram illustrating an example 300 of a HARQ process, in accordance with the present disclosure.

A MAC layer of a protocol stack may implement a HARQ protocol to provide a faster retransmission mechanism relative to other retransmission mechanisms, such as a RLC layer retransmission system. In some examples, the HARQ protocol may include a transmitting device using a retransmission protocol in combination with a receiving device, such as a send and wait (SAW) protocol that enables the receiving device to recover and/or correct data errors in a first HARQ process without hindering data transmissions in a second HARQ process. Accordingly, multiple HARQ processes may operate in parallel, and data errors identified in the first HARQ process may not hinder transmissions in the second HARQ process. Some non-limiting examples of transmitting device-receiving device pairs that may implement a HARQ process in combination may include a network node 110 and a UE 120 (e.g., a downlink HARQ process), a UE 120 and a network node 110 (e.g., an uplink HARQ process), and/or a first UE 120 and a second UE 120 (e.g., a sidelink HARQ process). Thus, a HARQ process may be used for downlink communications, uplink communications, and/or sidelink communications. In some examples, and as part of a HARQ process, a network node may transmit information in DCI that indicates to a receiving device (e.g., a UE 120) which downlink transmission(s) and/or which uplink transmissions to process using a HARQ protocol. Alternatively, or additionally, and as part of the HARQ process, a first UE may transmit information in sidelink control information (SCI) that indicates, to a second UE, which sidelink transmission(s) to process using the HARQ protocol.

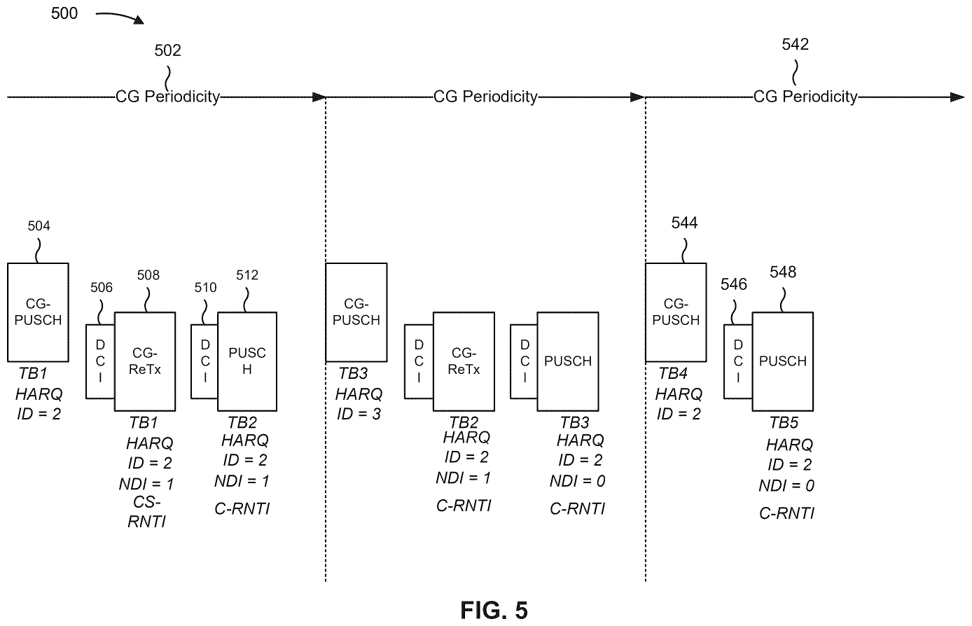

In some examples, a HARQ process and/or HARQ protocol may enable a receiving device to correct errors in a received data packet, such as by correcting errors within a TB based at least in part on soft combining packets in a PHY layer as described below. In some examples, a TB may be partitioned into one or more CBGs, and each CBG may partitioned into one or more CBs as described with regard to FIG. 5. To correct for errors, the receiving device may buffer one or more data packets that have been identified as including an error, combine the data packets, and process the combined data packets to reduce errors. In some examples, “codeword (CW)” may refer to a TB that includes error protection, and a transmission may include multiple CWs.

In the context of feedback information (e.g., HARQ feedback), “codebook” refers to a set of one or more (e.g., a matrix of one or more) feedback indications (e.g., ACK or NACK indications) that can be transmitted via a single transmission (e.g., a single uplink transmission). A HARQ feedback codebook transmission may include a feedback message to provide feedback regarding, for example, downlink data transmission (e.g., transmissions associated with a downlink channel), uplink data transmission (e.g., transmissions associated with an uplink channel), or sidelink data transmission (e.g., transmissions associated with a sidelink channel). As used herein, a codebook may be a sequence of bits, which may be constructed using ACK/NACK feedback associated with multiple communications (e.g., multiple downlink communications) that are received during a feedback window. A codebook may include one or more codewords. A codeword may include a message or communication. For example, a codeword may include one or more ACK/NACK feedback indications (e.g., a sequence of one or more HARQ-ACK bit values and/or HARQ NACK bit values).

The example 300 includes transactions between a transmitting device and a receiving device. Operations and/or data located above dashed line 302 are performed by, and/or reside at, a transmitting device (e.g., a network node 110 for a downlink HARQ process, a UE 120 for an uplink HARQ process, and/or a first UE 120 for a sidelink HARQ process). Operations and/or data located below the dashed line 302 are performed by, and/or reside at, a receiving device (e.g., a UE 120 for a downlink HARQ process, a network node 110 for an uplink HARQ process, and/or a second UE 120 for a sidelink HARQ process). As shown by reference number 304, the transmitting device may transmit a first data packet 306 that is a new transmission of data that is included in the first data packet 306 (e.g., a first transmission of the data, shown through the use of solid white). In some examples, the transmitting device may buffer and/or store the first data packet 306 as part of a HARQ process until receiving an indication from the receiving device that the first data packet 306 has been received and/or recovered with minimal errors (e.g., error-free and/or a number of errors that satisfy a low threshold). Based at least in part on receiving the first data packet 306 with minimal errors, the receiving device may transmit an ACK to the transmitting device as shown by reference number 308, such as a HARQ acknowledgement. The receiving device may validate the first data packet 306 using any suitable error detection mechanism., such as a CRC process that validates the received data by computing a CRC value using the received data and comparing the computed CRC value(s) to a CRC value included with the received data.

Based at least in part receiving the ACK, the transmitting device may transmit a second data packet 310 as shown by reference number 312, and the second data packet 310 may be a new transmission of data (e.g., different data than the data included in the first data packet 306). In a similar manner as the first data packet 306, the transmitting device may store the second data packet 310 in the buffer and/or remove the first data packet 306 from the buffer. In some examples, the receiving device may not receive the second data packet 310 successfully, shown in FIG. 3 as data packet 310-1. For example, the receiving device may identify that the data packet 310-1 was received with a number of errors that do not satisfy the low error threshold. Accordingly, and as shown by reference number 314, the receiving device may transmit a NACK to indicate that the second data packet 310 was received with errors and/or unsuccessfully. Alternatively, or additionally, the receiving device may transmit the NACK to indicate a request for a retransmission of the second data packet 310. In some examples, and as shown by reference number 316, the receiving device may store the data packet 310-1 in a buffer 318.

Based at least in part on receiving the NACK, and as shown by reference number 320, the transmitting device may retransmit the second data packet 310 to the receiving device, where the retransmission is shown by FIG. 3 through the use of a dotted pattern. The receiving device may receive the retransmission of the second data packet 310 (shown as data packet 310-2), and, as shown by reference number 322, the receiving device may store the data packet 310-2 in the buffer 318 and/or may combine the data packet 310 1 with the data packet 310-2. As one example, the receiving device may combine the data packet 310-1 and the data packet 310-2 prior to channel decoding and/or error detection, and may process the combined data packet to mitigate errors as shown by reference number 324. That is, by processing the combined data packet, the receiving device may recover data that includes minimal errors (e.g., is error-free and/or includes a number of errors that satisfy the low error threshold). In some examples, the receiving may combine the data packet 310-1 and the data packet 310-2 using soft combining. “Soft combining” may denote combining multiple received signals based at least in part on a confidence and/or reliability of each received signal, such as by combining received signals using a log likelihood ratio (LLR), to improve a signal quality of the combined data packet and reduce recovery errors.

In some examples, the receiving device may transmit an ACK to the transmitting device, such as in scenarios that the receiving device is able to recover a version of the second data packet 310 that includes minimal errors. In other examples, the receiving device may transmit a NACK to the transmitting device, such as in scenarios that the receiving device is unable to recover a version of the second data packet 310 with minimal errors.

A HARQ process may be used to regulate any combination of PDSCH transmissions, PUSCH transmissions, and/or physical sidelink shared channel (PSSCH) transmissions. Accordingly, the first data packet 306 and/or the second data packet 310 shown by FIG. 3 may be based at least in part on one or more PDSCH transmissions, one or more PUSCH transmissions, and/or one or more PSSCH transmissions. For PDSCH transmissions, the receiving device (e.g., a UE 120) may transmit ACK/NACK feedback via PUCCH or PUSCH. For PUSCH transmission, the receiving device (e.g., a network node 110) may transmit ACK/NACK feedback in an uplink grant (e.g., indicated via DCI). For a sidelink transmission, the receiving device (e.g., a UE 120) may transmit ACK/NACK feedback via a physical sidelink feedback channel (PSFCH).

As indicated above, FIG. 3 is provided as an example. Other examples may differ from what is described with regard to FIG. 3.

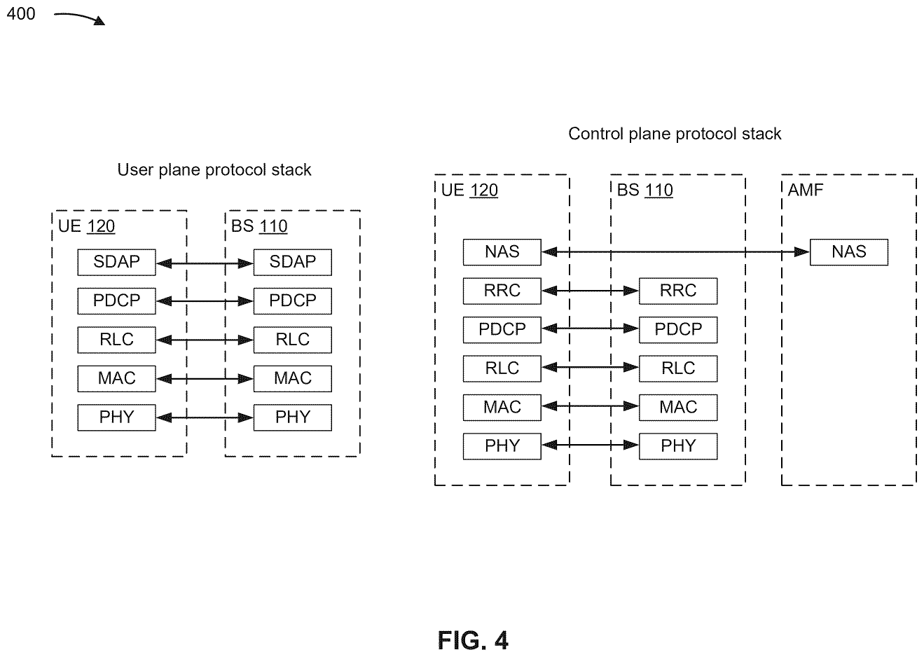

FIG. 4 is a diagram illustrating an example 400 of a user plane protocol stack and a control plane protocol stack for a network node 110 and a core network in communication with a UE 120, in accordance with the present disclosure. In some aspects, the network node 110 may include a plurality of network nodes 110. In some aspects, protocol stack functions of the network node 110 may be distributed across multiple network nodes 110. For example, a first network node 110 may implement a first layer of a protocol stack and a second network node 110 may implement a second layer of the protocol stack. The distribution of the protocol stack across network nodes (in examples where the protocol stack is distributed across network nodes) may be based at least in part on a functional split, as described elsewhere herein. It should be understood that references to “a network node 110” or “the network node 110” can, in some aspects, refer to multiple network nodes.

On the user plane, the UE 120 and the network node 110 may include respective PHY layers, MAC layers, RLC layers, PDCP layers, and SDAP layers. A user plane function may handle transport of user data between the UE 120 and the network node 110. On the control plane, the UE 120 and the network node 110 may include respective RRC layers. Furthermore, the UE 120 may include a non-access stratum (NAS) layer in communication with an NAS layer of an access and management mobility function (AMF). The AMF may be associated with a core network associated with the network node 110, such as a 5G core network (5GC) or a next-generation radio access network (NG-RAN). A control plane function may handle transport of control information between the UE and the core network. Generally, a first layer is referred to as higher than a second layer if the first layer is further from the PHY layer than the second layer. For example, the PHY layer may be referred to as a lowest layer, and the SDAP/PDCP/RLC/MAC layer may be referred to as higher than the PHY layer and lower than the RRC layer. An application (APP) layer, not shown in FIG. 4, may be higher than the SDAP/PDCP/RLC/MAC layer. In some cases, an entity may handle the services and functions of a given layer (e.g., a PDCP entity may handle the services and functions of the PDCP layer), though the description herein refers to the layers themselves as handling the services and functions.

The RRC layer may handle communications related to configuring and operating the UE 120, such as: broadcast of system information related to the access stratum (AS) and the NAS; paging initiated by the 5GC or the NG-RAN; establishment, maintenance, and release of an RRC connection between the UE and the NG-RAN, including addition, modification, and release of carrier aggregation, as well as addition, modification, and release of dual connectivity; security functions including key management; establishment, configuration, maintenance, and release of signaling radio bearers (SRBs) and data radio bearers (DRBs); mobility functions (e.g., handover and context transfer, UE cell selection and reselection and control of cell selection and reselection, inter-RAT mobility); quality of service (QoS) management functions; UE measurement reporting and control of the reporting; detection of and recovery from radio link failure; and NAS message transfer between the NAS layer and the lower layers of the UE 120. The RRC layer is frequently referred to as Layer 3(L3).

The SDAP layer, PDCP layer, RLC layer, and MAC layer may be collectively referred to as L2. Thus, in some cases, the SDAP, PDCP, RLC, and MAC layers are referred to as sublayers of Layer 2. On the transmitting side (e.g., if the UE 120 is transmitting an uplink communication or the network node 110 is transmitting a downlink communication), the SDAP layer may receive a data flow in the form of a QoS flow. A QoS flow is associated with a QoS identifier, which identifies a QoS parameter associated with the QoS flow, and a QoS flow identifier (QFI), which identifies the QoS flow. Policy and charging parameters are enforced at the QoS flow granularity. A QoS flow can include one or more service data flows (SDFs), so long as each SDF of a QoS flow is associated with the same policy and charging parameters. In some aspects, the RRC/NAS layer may generate control information to be transmitted and may map the control information to one or more radio bearers for provision to the PDCP layer.

The SDAP layer, or the RRC/NAS layer, may map QoS flows or control information to radio bearers. Thus, the SDAP layer may be said to handle QoS flows on the transmitting side. The SDAP layer may provide the QoS flows to the PDCP layer via the corresponding radio bearers. The PDCP layer may map radio bearers to RLC channels. The PDCP layer may handle various services and functions on the user plane, including sequence numbering, header compression and decompression (if robust header compression is enabled), transfer of user data, reordering and duplicate detection (if in-order delivery to layers above the PDCP layer is required), PDCP protocol data unit (PDU) routing (in case of split bearers), retransmission of PDCP SDUs, ciphering and deciphering, PDCP SDU discard (e.g., in accordance with a timer, as described elsewhere herein), PDCP re-establishment and data recovery for RLC AM, and duplication of PDCP PDUs. The PDCP layer may handle similar services and functions on the control plane, including sequence numbering, ciphering, deciphering, integrity protection, transfer of control plane data, duplicate detection, and duplication of PDCP PDUs.

The PDCP layer may provide data, in the form of PDCP PDUs, to the RLC layer via RLC channels. The RLC layer may handle transfer of upper layer PDUs to the MAC and/or PHY layers, sequence numbering independent of PDCP sequence numbering, error correction via ARQ, segmentation and re-segmentation, reassembly of an SDU, RLC SDU discard, and RLC re-establishment.

The RLC layer may provide data, mapped to logical channels, to the MAC layer. The services and functions of the MAC layer include mapping between logical channels and transport channels (used by the PHY layer as described below), multiplexing/demultiplexing of MAC SDUs belonging to one or different logical channels into/from TBs delivered to/from the physical layer on transport channels, scheduling information reporting, error correction through HARQ, priority handling between UEs by means of dynamic scheduling, priority handling between logical channels of one UE by means of logical channel prioritization, and padding. Additionally, the MAC layer may be involved in transmission of uplink control messages, such as HARQ feedback, channel state information (CSI), and/or scheduling requests, among other examples. These control messages may be transmitted over PHY channels (e.g., the PUCCH) and/or multiplexed with data on the PUSCH.

The MAC layer may package data from logical channels into TBs, and may provide the TBs on one or more transport channels to the PHY layer. The PHY layer may handle various operations relating to transmission of a data signal, as described in more detail in connection with FIG. 2. The PHY layer is frequently referred to as L1.

On the receiving side (e.g., if the UE 120 is receiving a downlink communication or the network node 110 is receiving an uplink communication), the operations may be similar to those described for the transmitting side, but reversed. For example, the PHY layer may receive TBs and may provide the TBs on one or more transport channels to the MAC layer. The MAC layer may map the transport channels to logical channels and may provide data to the RLC layer via the logical channels. The RLC layer may map the logical channels to RLC channels and may provide data to the PDCP layer via the RLC channels. The PDCP layer may map the RLC channels to radio bearers and may provide data to the SDAP layer or the RRC/NAS layer via the radio bearers.

Data may be passed between the layers in the form of PDUs and SDUs. An SDU is a unit of data that has been passed from a layer or sublayer to a lower layer. For example, the PDCP layer may receive a PDCP SDU. A given layer may then encapsulate the unit of data into a PDU and may pass the PDU to a lower layer. For example, the PDCP layer may encapsulate the PDCP SDU into a PDCP PDU and may pass the PDCP PDU to the RLC layer. The RLC layer may receive the PDCP PDU as an RLC SDU, may encapsulate the RLC SDU into an RLC PDU, and so on. In effect, the PDU carries the SDU as a payload.

As indicated above, FIG. 4 is provided as an example. Other examples may differ from what is described with regard to FIG. 4.

FIG. 5 is a diagram illustrating an example 500 of HARQ identifier sharing, in accordance with the present disclosure.

As shown in FIG. 5, different types of uplink transmissions may share a common HARQ identifier. For example, a first CG periodicity 502 may include a CG-PUSCH communication 504, a DCI 506, a CG retransmission (CG-ReTx) 508, a DCI 510, and a PUSCH 512. For example, a UE 120 may transmit the CG-PUSCH communication 504 to a network node 110 on an uplink, receive the DCI 506 on a downlink, re-transmit the CG-PUSCH communication 504 as CG-ReTx 508 on the uplink, receive the DCI 510 on a downlink, and transmit the PUSCH 512 on an uplink. HARQ identifiers can be used for CG transmission (e.g., and can be configured for the UE 120 via RRC signaling) as well as for a PUSCH transmission scrambled with a C-RNTI. In some examples, the UE 120 may be configured with one or more rules for interpreting configuration parameters for a transmission. For example, in accordance with a first rule, a CG-PUSCH may be associated with an NDI value being toggled (e.g., a new TB or an initial transmission of a TB is transmitted via periodic CG-PUSCH). Additionally, or alternatively, in accordance with a second rule, for PUSCH transmission scrambled with a C-RNTI, if a previous uplink assignment of a same HARQ process identifier was an uplink assignment received for a MAC entity's CS-RNTI (e.g., a CG-ReTx) or a configured uplink assignment (e.g., a CG-PUSCH), the UE 120 may consider the NDI value as toggled, regardless of the actual NDI value.

For example, as shown in the first CG periodicity 502, the CG-PUSCH communication 504 is associated with conveying a first TB, TB1, and is assigned a HARQ identifier of ‘2’. In accordance with the first rule described above, the NDI is toggled. The UE 120 may receive the DCI 506 to schedule the CG-ReTx 508, which may be a retransmission of TB1. The CG-ReTx 508 is scrambled with a CS-RNTI in accordance with being a retransmission of TB1 and has a HARQ identifier of ‘2’ and an NDI value of ‘1’. In this case, the NDI value of 1 associated with the CG-ReTx 508 may be used as a validation bit. The UE 120 may receive the DCI 510 to schedule the PUSCH 512, which may be a transmission of a new TB, TB2. Here, the PUSCH 512 is scrambled with a C-RNTI, has a HARQ ID of ‘2’, and, in accordance with the second rule, has an NDI value that is toggled. Based on the previous uplink assignment for the CG-ReTx 508 having the same HARQ identifier and being scrambled with a CS-RNTI.

Similarly, in a third CG periodicity 542, a CG-PUSCH 544 is used to convey a new TB, TB4, with a HARQ identifier of ‘2’. Here, in accordance with the first rule, an NDI value is assumed to be toggled. The UE 120 receives a DCI 546 scheduling a PUSCH 548, which is associated with a HARQ identifier of ‘2’, is scrambled with a C-RNTI, and, in accordance with the second rule, has an NDI that is toggled.

As indicated above, FIG. 5 is provided as an example. Other examples may differ from what is described with respect to FIG. 5.

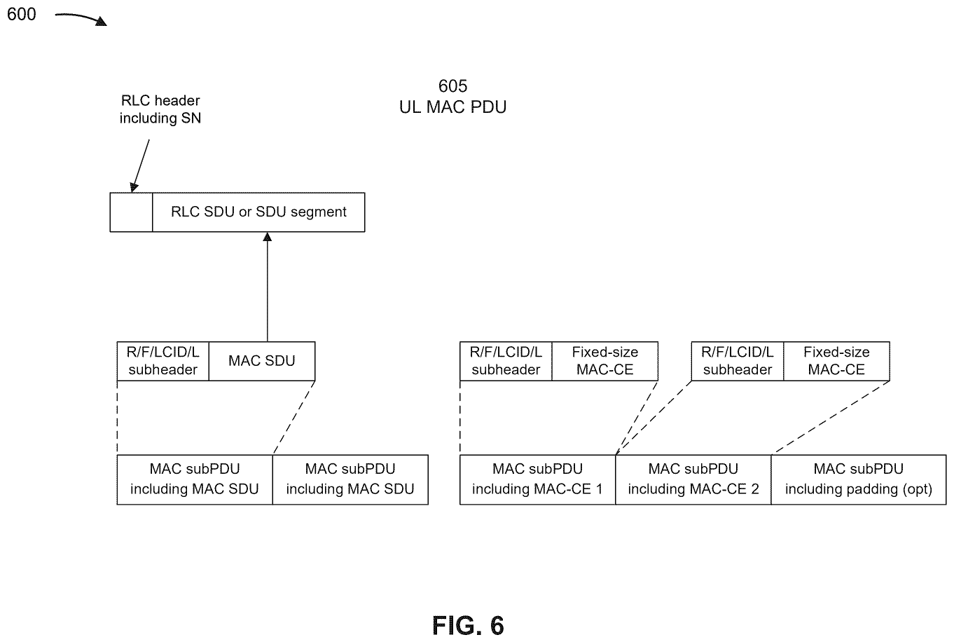

FIG. 6 is a diagram illustrating an example 600 of an uplink MAC PDU, in accordance with the present disclosure.

In some examples, ARQ retransmissions are not available for uplink control messages, as these messages (e.g., HARQ feedback, CSI, SR, or the like) are transmitted at the PHY layer or the MAC layer, which do not support ARQ. For example, in the case of UCIs (e.g., generated at the PHY layer), UCIs are not sent as part of uplink TBs on PUSCH, but UCI can be multiplexed with PUSCH, where ARQ is unsupported. Additionally, and as shown by reference number 605, for uplink MAC-CEs (e.g., generated at the MAC layer), ARQ is not possible because MAC-CEs are not part of RLC SDUs or RLC SDU segments, but are rather added later (e.g., at the MAC layer) as a MAC subPDU, which is part of MAC PDU (e.g., in an uplink TB). In contrast, for example, ARQ retransmissions are supported at the RLC layer.

Additionally, the ARQ mechanism may not be supported for RLC status reports, which are transmitted by a receiver so that a transmitter may know which RLC SDUs and/or RLC SDU segments are associated with an ACK or a NACK (e.g., in RLC AM). For example, in the downlink context, the RLC status report may be transmitted by a UE in an uplink transmission (e.g., as an uplink RLC message) so that a network node may know the downlink packets for which downlink ARQ may be employed.

In some examples, although the RLC status report is generated at the RLC layer, the RLC status report is an RLC control PDU (e.g., not an RLC data PDU). Accordingly, the RLC control PDU does not contain an RLC SDU or RLC SDU segment, and the RLC header of the RLC status does not include an SN for the packet. As a result, ARQ is not supported for the RLC status report, where ARQ retransmissions are supported at the RLC layer.

Additionally, in some examples, where the network node does not receive the RLC status report after one or more uplink HARQ retransmissions (e.g., where uplink ARQ transmissions are not supported), the UE may generate an additional RLC status report. For example, because holes in the SN (e.g., downlink RLC SDUs or downlink RLC SDU segments) are not yet filled as a result of the network node's failure to receive the RLC status report (e.g., to retransmit the missing downlink RLC SDUs or RLC SDU segments via downlink ARQ), the UE may generate the additional RLC status report. In some examples, the process of generating the additional RLC status report may be controlled by a timer (e.g., t-StatusProhibit), which may control the duration that the UE may wait after sending an RLC status report before the UE sends an additional status report (e.g., where the hole in the SN is not yet filled).

As a result of the UE's inability to utilize ARQ retransmission for uplink control messages, the UE and/or network may experience decreased performance in poor network conditions, resource allocation issues, and/or increased power consumption (e.g., where the UE may retransmit uplink control messages at increased transmit power levels).

As indicated above, FIG. 6 is provided as an example. Other examples may differ from what is described with respect to FIG. 6.

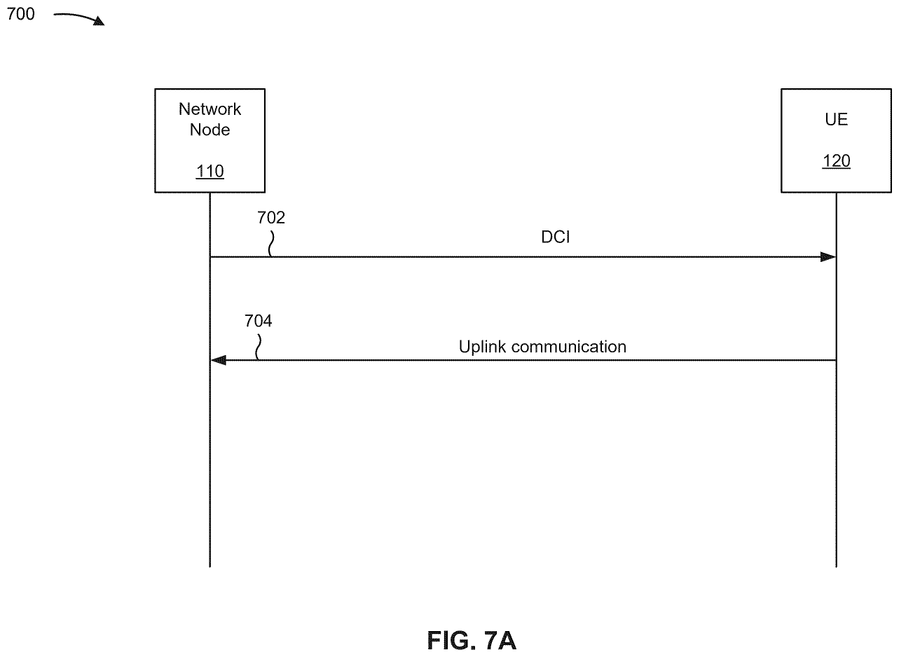

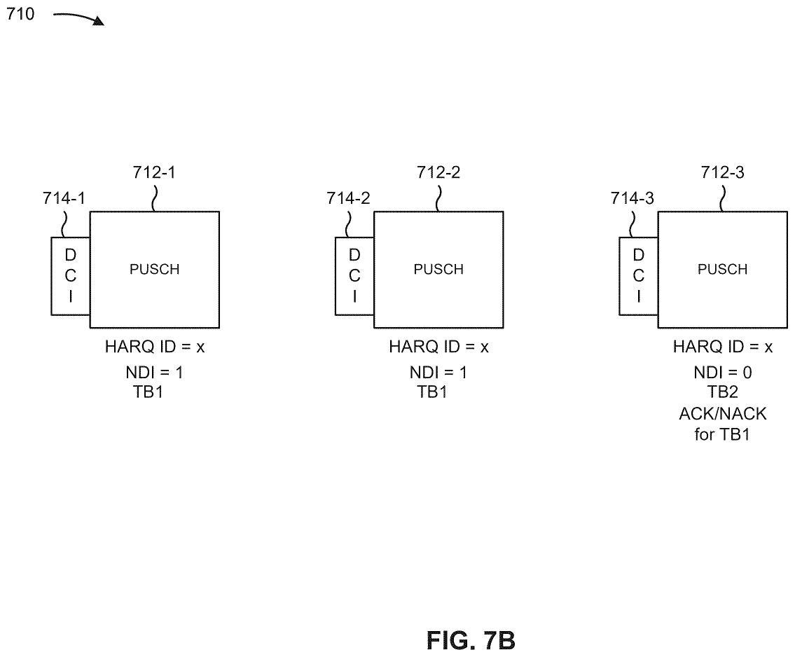

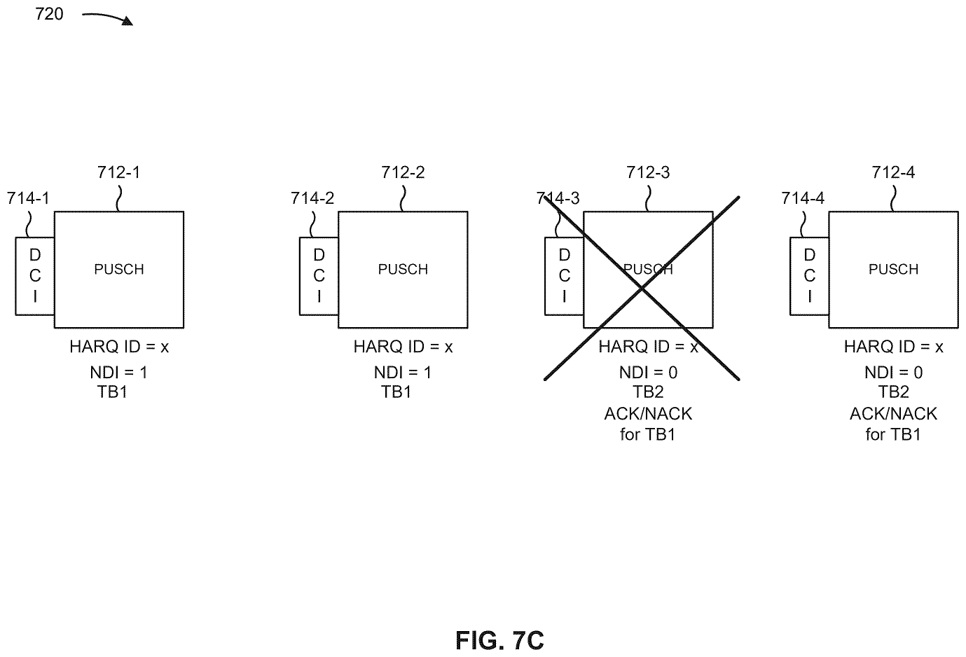

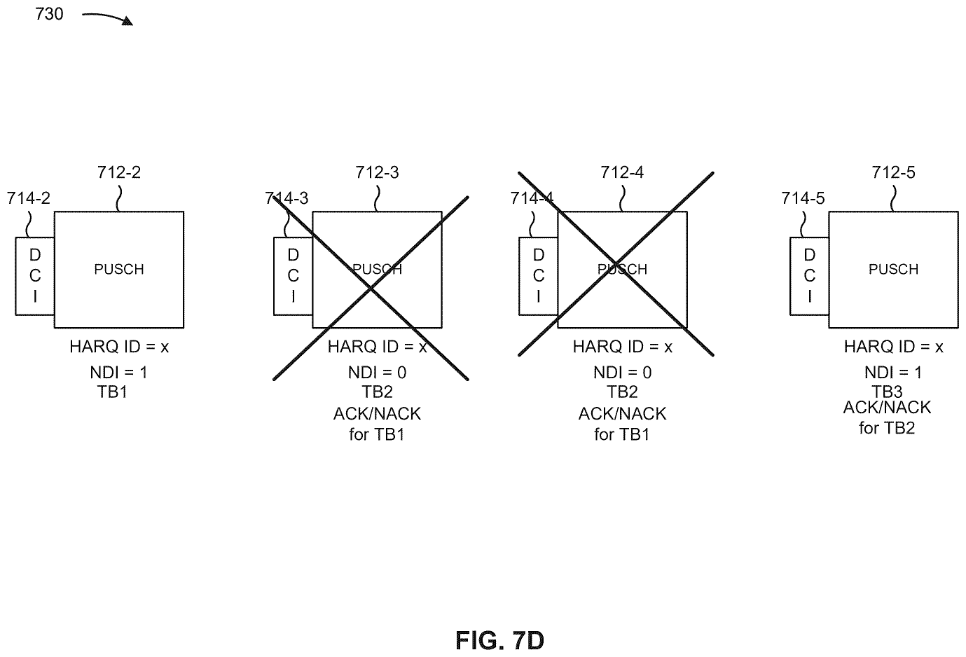

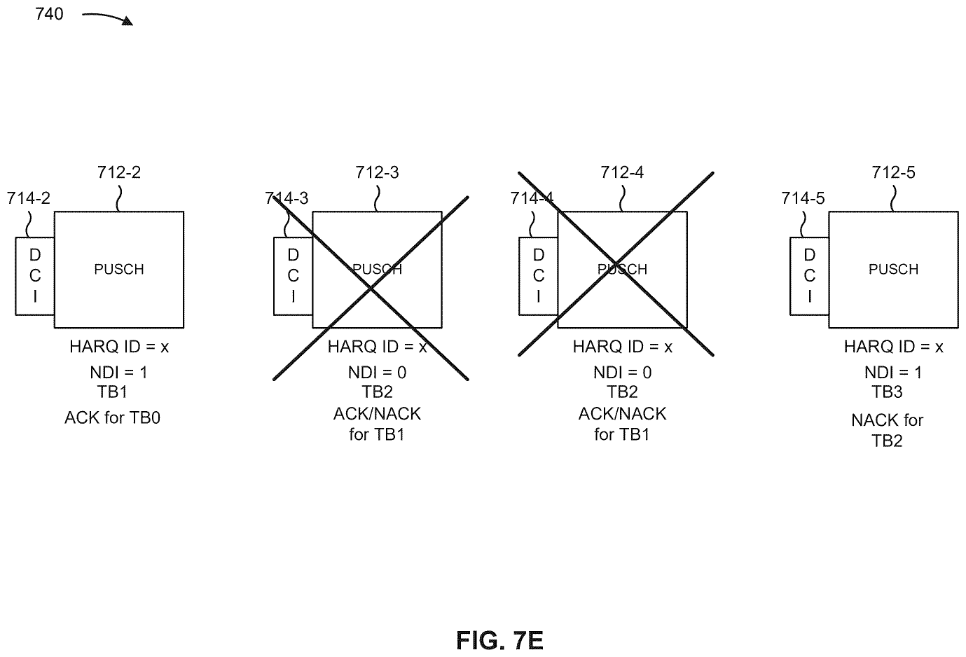

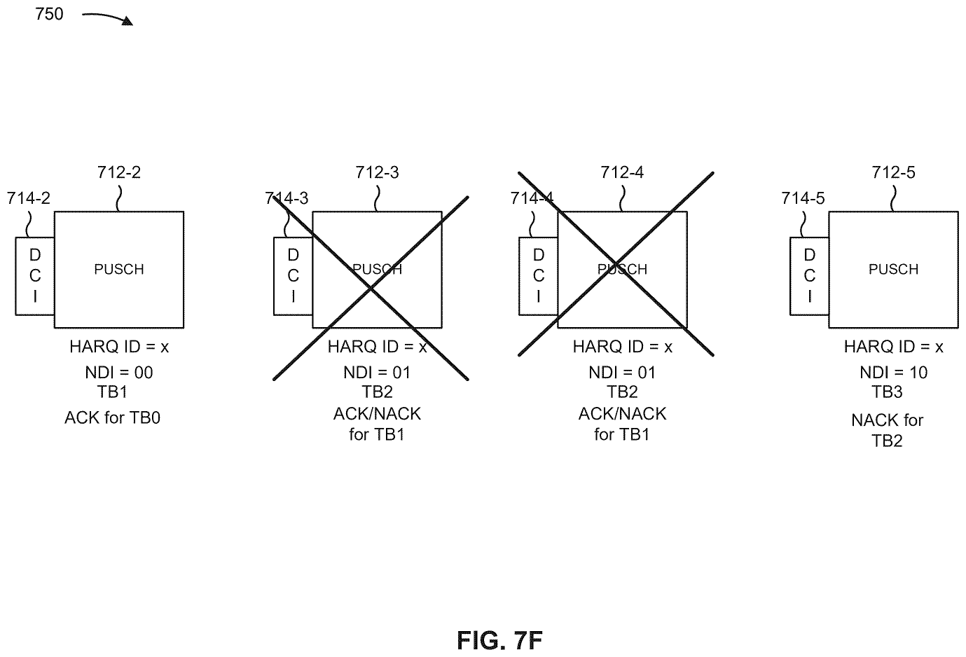

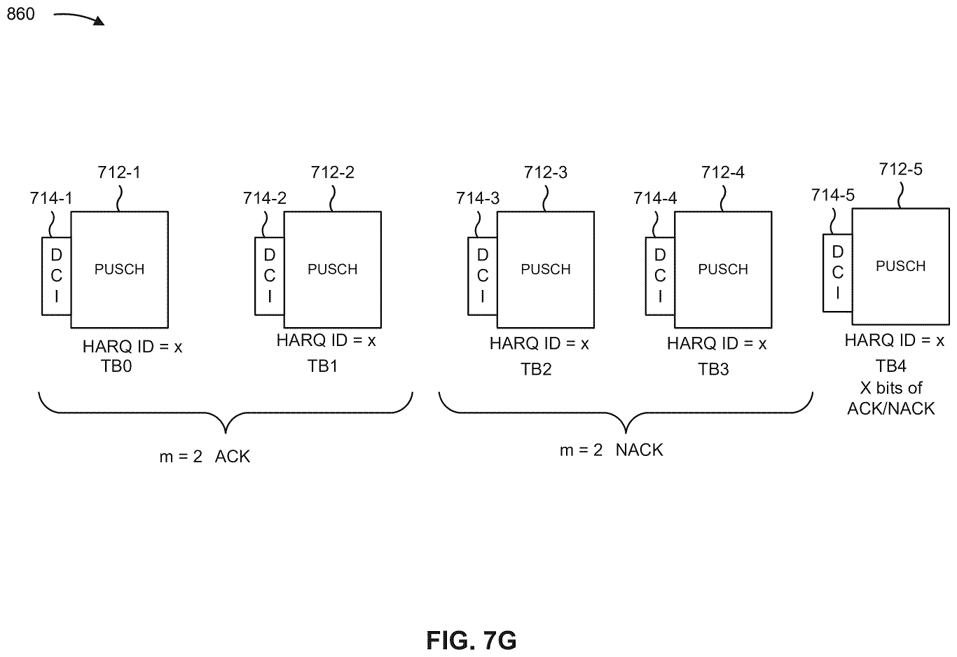

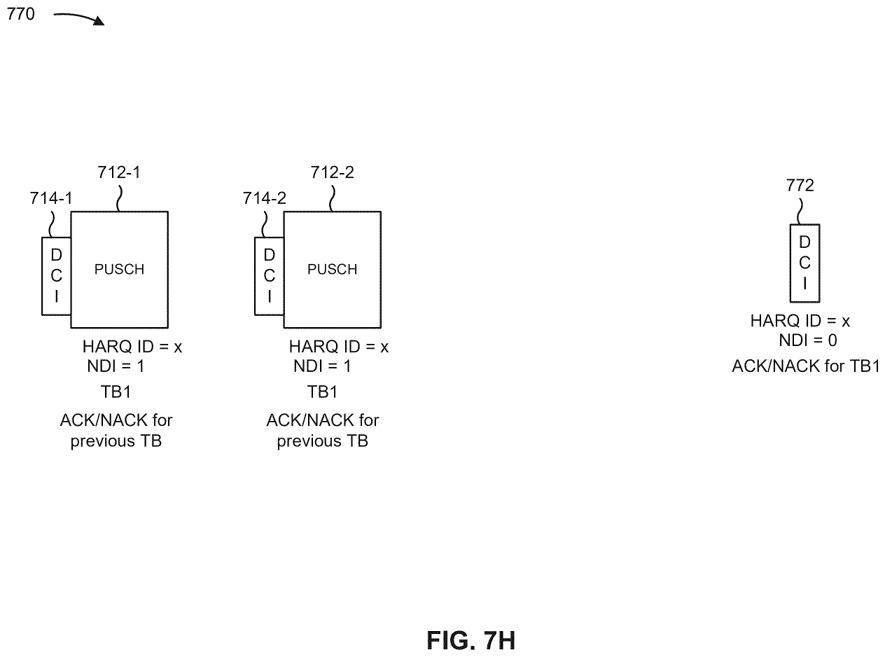

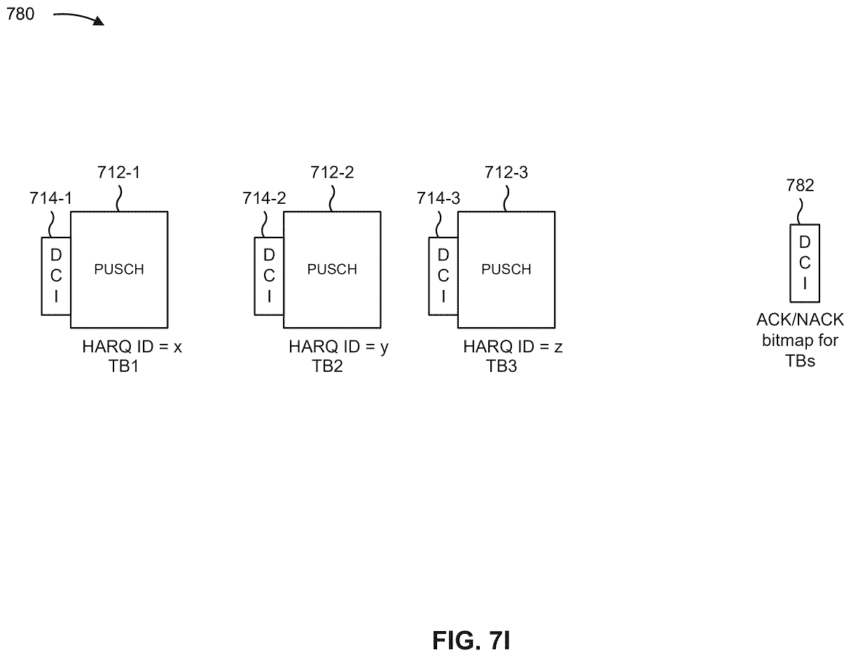

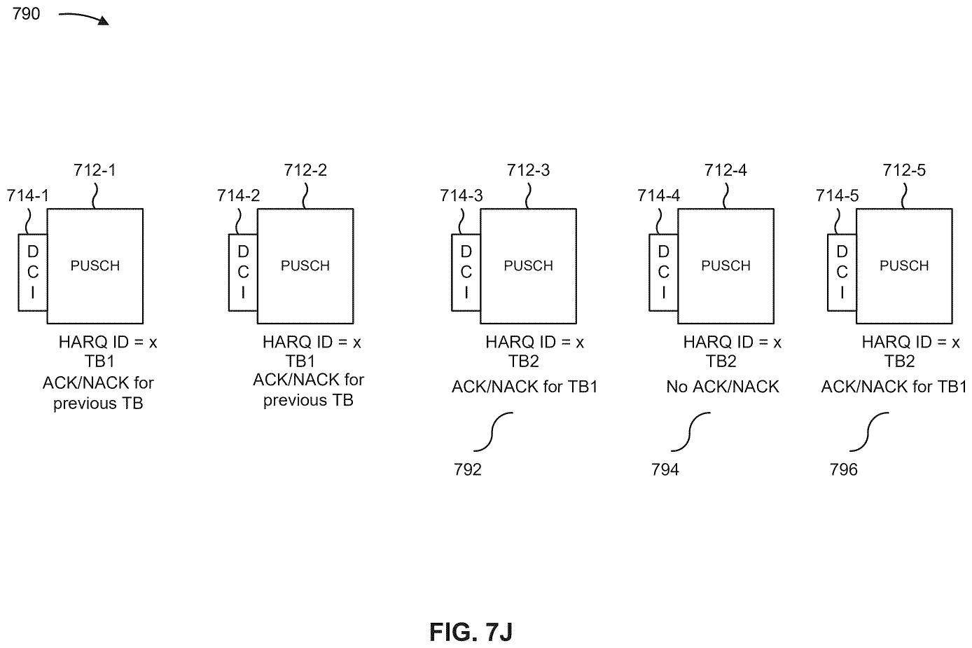

FIGS. 7A-7J are diagrams illustrating an example 700 associated with indication of unsuccessful HARQ termination for uplink communication, in accordance with the present disclosure. As shown in FIG. 7A, example 700 includes communication between a network node 110 and a UE 120.

As further shown in FIG. 7A, and by reference number 702, the UE 120 may receive a message associated with scheduling a communication. For example, the UE 120 may receive, from the network node 110, DCI associated with scheduling a new TB on a PUSCH. As further shown in FIG. 7A, and by reference number 704, the UE 120 may transmit one or more uplink communications. For example, the UE 120 may transmit a PUSCH to convey the new TB based on receiving the DCI. In some aspects, the DCI includes a feedback indication for a previous TB. For example, the DCI associated with scheduling the new TB may include an ACK or NACK for a previous TB. Based on determining that the DCI conveys an ACK, the UE 120 may flush a transmit buffer of data associated with the previous TB. For example, the UE 120 may flush an upper-layer (e.g., RLC entity) transmit buffer of one or more RLC SDUs or SDU segments associated with the previous TB. Alternatively, based on determining that the DCI conveys a NACK, the UE 120 may queue the data associated with the previous TB for retransmission and may, in connection with transmitting the one or more uplink communications, retransmit the previous TB. For example, the UE 120 may queue the one or more RLC SDUs or SDU segments for ARQ retransmission.

In some aspects, the UE 120 may interpret a field in the DCI to determine whether the DCI includes an ACK or a NACK for a prior TB. For example, when the UE 120 receives a DCI scheduling a new TB on a PUSCH (e.g., with a toggled NDI for a particular HARQ ID), the UE may interpret a bit field in the DCI as indicating a NACK or an ACK. As an example, as shown in FIG. 7B, and by example 710, the UE 120 may transmit PUSCH communications 712 based on receiving respective DCI messages 714. For example, the UE 120 receives a first DCI 714-1 scheduling PUSCH communication 712-1 to convey a TB, TB1. The DCI 714-1 is associated with a particular HARQ ID and a particular NDI value (e.g., NDO=1). Similarly, the UE 120 receives a second DCI 714-2 scheduling PUSCH communication 712-2 to convey TB1. The DCI 714-2 is associated with the particular HARQ ID and the particular NDI value, indicating that the DCI 714-2 is scheduling a retransmission of a same TB as a prior DCI (e.g., the DCI 714-1). In contrast, when the UE 120 receives the DCI 714-3, the NDI value is togged to another NDI value (e.g., NDI=0), indicating that the DCI 714-3 is scheduling a PUSCH communication 712-3 to convey a new TB, TB2. In this case, the UE 120 may interpret the DCI 714-3 as also conveying an ACK or NACK for a previous TB, TB1. Accordingly, based on whether the DCI 714-3 conveys an ACK or NACK for TB1, the UE 120 may flush TB1 from a memory or queue TB1 for ARQ retransmission in a buffer. In the particular example of FIG. 7B, TB2 is still being handled by the same HARQ process as TB1, and hence the HARQ ID value remains the same even though the NDI value has been toggled.

As shown in FIG. 7C, and by example 720, in some scenarios, the UE 120 may miss a DCI scheduling an initial transmission of a new TB. For example, the UE 120 may not receive the DCI 714-3 scheduling the PUSCH communication 712-3 for TB2 and conveying an ACK or NACK for TB1. In some aspects, the DCI may convey an ACK or NACK for one or more previous TBs even when there is not an NDI toggling. In other words, rather than only including an ACK or NACK for TB1 in DCI 714-3 (e.g., in which the NDI is toggled from 1 to 0), the network node 110 may also include the ACK or NACK for TB1 in DCI 714-4. Here, DCI 714-4 does not include the NDI bit being toggled from a perspective of the network node 110 (e.g., the NDI bit remains at 0 from DCI 714-3) but may include the NDI bit being toggled from a perspective of the UE 120 (due to missing DCI 714-3), thereby indicating that the DCI 714-3 schedules PUSCH communication 712-4 as a retransmission of TB2 from the perspective of the network node 110.

As shown in FIG. 7D, and by example 730, in some scenarios, the UE 120 may miss all DCIs scheduling an initial transmission of a new TB. For example, the UE 120 may fail to receive DCIs 714-3 and 714-4, but may receive a DCI 714-5, which schedules a new TB, TB3, and indicates an ACK or NACK for a previous TB, TB2. In this case, the DCI 714-5 includes a toggled NDI value relative to DCI 714-4 (e.g., the NDI value changes from 0 to 1), but does not include a toggled NDI value relative to DCI 714-2, which is the most recent DCI that the UE 120 has received.

In some aspects, when the UE 120 receives DCI with an untoggled NDI for an indicated HARQ ID and when the DCI indicates a NACK for a previous TB associated with the same HARQ ID, but the previous DCI with the same NDI and HARQ ID indicated an ACK for a previous TB, the UE 120 may determine that there is a missing NDI. For example, as shown in FIG. 7E, and by example 740, the UE 120 may receive the DCI 714-2 with an NDI value of 1, scheduling transmission of a new TB, TB1, and including an ACK for a previous TB, TB0. The UE 120 may miss receiving DCIs 714-3 and 714-4, but may receive DCI 714-5, which includes an untoggled NDI value of 1 (e.g., untoggled from the UE's perspective having not received DCIs 714-3 and 714-4, but toggled from the network node's perspective having toggled the NDI value in DCIs 714-3 and 714-4) and a NACK for TB2. Based on the ACK for TB0 (in the DCI 714-2 scheduling TB1) being followed by an untoggled NDI and a NACK (in the DCI 714-5 scheduling TB3), the UE 120 may conclude that there is at least one missing TB (e.g., TB2) for which the UE 120 did not receive any DCIs. Accordingly, the UE 120 may, in such a scenario, operate according to at least one of a HARQ behavior or an ARQ behavior. According to the HARQ behavior, the UE 120 may assume that the NDI has been toggled and may transmit a new TB (e.g., TB3) rather than retransmitting a previous TB (e.g., TB1). According to a first type of the ARQ behavior, the UE 120 may buffer RLC SDUs or SDU segments of TB1 for ARQ retransmission. According to a second type of the ARQ behavior, the UE 120 may flush the RLC SDUs or SDU segments of TB1 from a memory. In some aspects, the DCI 714-5 may include an indication of which ARQ behavior the UE 120 is to follow. Similarly, the DCI 714-5 may include a second ACK/NACK bit for TB1. For example, each DCI may indicate 2 bits for ACK/NACK of a previous 2 TBs associated with the same HARQ ID.

In some aspects, the network node 110 may use a multi-bit NDI value. For example, rather than a 1-bit NDI value, the network node 110 may use a multi-bit NDI value. In such an example, as shown in FIG. 7F, by example 750, DCI 714-2 may have an NDI of ‘00’, DCIs 714-3 and 714-4 may have an NDI of ‘01’, and DCI 714-5 may have an NDI of ‘10’. Accordingly, the UE 120 may be able to determine that the DCI 714-5 has been toggled (even though the UE 120 has not received DCI 714-3 and 714-5) because the NDI value of ‘10’ in DCI 714-5 differs from the NDI value of ‘00’ in DCI 714-2. Based on the NDI values, the UE 120 may interpret the DCI 714-5 as scheduling transmission of new data and as including an ACK or NACK for a previous TB (e.g., TB2).

In some aspects, the UE 120 may receive a DCI with an NDI increase of more than one value (e.g., an increase from ‘00’ to ‘10’, as shown in example 750, an increase from ‘10’ to ‘00’ based on a rollover of the bit indicator, etc.). In some aspects, the UE 120 may perform a particular type of ARQ behavior for a missed TB based on an incrementing of the NDI by more than one value for an indicated HARQ ID. For example, in a first ARQ behavior, the UE 120 may disregard the ACK or NACK included in the DCI 714-5. Alternatively, in a second ARQ behavior, the UE 120 may be configured to use the ACK or NACK bit as a validation bit. For example, the network node 110 may include a NACK bit to indicate that the network node 110 has not received a transmission of TB2 (e.g., as the UE 120 did not receive the DCIs 714-3 or 714-4 scheduling transmission of TB2 in PUSCH communications 712-3 or 712-4). Additionally, or alternatively, the UE 120 perform another type of ARQ behavior for a non-missed TB (e.g., a TB that the UE 120 was scheduled to transmit, such as TB1, but for which the UE 120 has not received an ACK or NACK as a result of not receiving the DCIs 714-3 or 714-4). For example, in a first ARQ behavior, the UE 120 may queue RLC SDUs or SDU segments of TB1 for ARQ retransmission. Alternatively, in a second ARQ behavior, the UE 120 may flush RLC SDUs or SDU segments of TB1 from a memory. In some aspects, whether the UE 120 performs the first ARQ behavior or the second ARQ behavior with respect to TB1 may be based on a bit indicator in the DCI 714-5. Similarly, the DCI 714-5 may include a second ACK/NACK bit for TB1. For example, each DCI may indicate 2 bits for ACK/NACK of a previous 2 TBs associated with the same HARQ ID.

In some aspects, the network node 110 may include, in the DCI, an indication of a quantity of previous TBs with the same HARQ ID to which an ACK or NACK in the DCI applies. For example, as shown in FIG. 7G, and by example 760, the network node 110 may transmit DCIs 714-1 through 714-5 scheduling PUSCH communications 712-1 through 712-5. The network node 110 may include, in the DCI 714-5, X bits indicating that a previous m TBs (0≤m≤2^{X}−1) associated with the same HARQ ID are not successfully decoded. In other words, for X=2, the network node 110 may indicate that all previous TBs have been decoded successfully (e.g., for m=0), all TBs except the most recent TB (e.g., TB3) have been decoded successfully (e.g., for m=1), all TBs except the most recent two TBs (e.g., TB3 and TB2, as shown) have been decoded successfully (e.g., for m=2), or all TBs except the most recent three TBs (e.g., TB3, TB2, and TB1) have been decoded successfully, among other examples. Although some aspects are described herein in terms of a particular set of bit indicator interpretations, other assignments of bit values to interpretations by the UE 120 may be used.

In some aspects, the UE 120 may receive a non-scheduling DCI that indicates an ACK or NACK for a previous TB. For example, when the network node 110 is not scheduling a PUSCH with the same HARQ ID as a previous TB for at least a threshold period of time (e.g., at the end of an uplink burst), the network node 110 may transmit a non-scheduling DCI to provide an ACK or NACK for a previous TB. As shown in FIG. 7H, and by example 770, the UE 120 may receive DCIs 714-1 and 714-2 scheduling TB1 for transmission in PUSCH communications 712-1 and 712-2, respectively. In this case, the UE 120 may receive a non-scheduling DCI 772 with the same HARQ ID as the DCIs 714-1 and 714-2. The UE 120 may determine that the DCI 772 conveys an ACK or NACK for the TB1 based on a configuration. For example, the DCI 772 may include an FDRA field set to a reserved value (e.g., indicating that a PUSCH is not scheduled), the NDI value may be toggled relative to the DCIs 714-1 and 714-2, as shown, or the MCS field may be set to a reserved value. In some aspects, the network node 110 may only transmit the DCI 772 to provide a NACK feedback (rather than an ACK or NACK).

In some aspects, the UE 120 may receive a non-scheduling DCI that indicates an ACK or NACK for a plurality of previous TBs. For example, as shown in FIG. 7I, and by example 780, the UE 120 may receive DCIs 714-1 through 714-3 scheduling PUSCH communications 712-1 through 712-3 and associated with a set of HARQ IDs (e.g., HARQ IDs ‘x’, ‘y’, and ‘z’). In this case, the UE 120 may receive a non-scheduling DCI 782 with one or more indicators for providing ACK or NACK feedback for the set of TBs conveyed in connection with the set of HARQ IDs. For example, the DCI 782 may include a bitmap with each bit corresponding to a different HARQ ID. In some aspects, the network node 110 may repurpose one or more fields for conveying the bitmap, such as an FDRA field, a HARQ ID field, an NDI field, an ACK/NACK field, an MCS field, a transmit power control (TPC) field, a time domain resource allocation (TDRA) field, a frequency hopping flag field, or a redundancy version (RV) field, among other examples. In some aspects, the UE 120 may determine that the DCI 782 is a non-scheduling DCI conveying ACK/NACK feedback for a plurality of TBs based on a configuration. For example, one or more fields of the DCI 782 may include a value that indicates a type or purpose of the DCI 782, based on which the UE 120 can interpret the DCI 782 as conveying the ACK/NACK feedback. Additionally, or alternatively, the DCI 782 may use a configured RNTI allocated for indicating a type or purpose of the DCI 782. Additionally, or alternatively, the DCI 782 may include a dedicated field (e.g., a bit indicator) indicating a type or purpose of the DCI 782. Additionally, or alternatively, the DCI 782 may be associated with a particular format that is specified for conveying ACK/NACK feedback for a plurality of TBs. For example, the DCI 782 may be a group-common DCI associated with a type-3 common search space (Type-3 CSS).

In some aspects, rather than receiving ACK or NACK information at a TB level, the UE 120 may interpret the DCI as providing ACK or NACK information at a CB or CBG level within a previous TB. For example, the UE 120 may receive DCI that indicates a NACK for one or more CBs within a TB and may queue one or more RLC SDUs or SDU segments in the one or more CBs for ARQ retransmission. Additionally, or alternatively, the UE 120 may receive DCI that indicates an ACK for one or more CBs within a TB and may flush one or more RLC SDUs or SDU segments in the one or more CBs from a memory. In some aspects, the UE 120 may interpret a field as indicating that the DCI conveys CB or CBG level ACK/NACK information. For example, when an NDI field of the DCI is not toggled in the DCI, the UE 120 may interpret a CBG transmission information (CBGTI) field of the DCI as being associated with a scheduled TB (e.g., for HARQ retransmission). Alternatively, when the NDI field the DCI is toggled, the UE 120 may interpret the CBGTI field of the DCI as being associated with a previous TB that has the same HARQ ID as a TB that is scheduled for transmission in the DCI (e.g., for ARQ or for flushing the RLC buffer). Additionally, or alternatively, when the NDI field the DCI is toggled, and if the TB-level feedback (ACK/NACK) for a previous TB exists in the DCI as described herein, and if the TB-level feedback indicates an ACK, the UE 120 may ignore a CBGTI field and flush an RLC buffer for all RLC SDUs or SDU segments of the previous TB. This may be beneficial in case the UE 120 misses a previous DCI scheduling initial transmission of the TB (since the CBGTI field of the detected DCI after the missing DCI indicates all NACKs for HARQ retransmission of the TB, but the previous TB is correctly decoded based on feedback for previous TB being indicated as Ack).

In some aspects, the UE 120 may interpret the DCI and perform one or more behaviors based on a configuration. For example, the UE 120 may receive RRC configuration information associated with configuring whether to queue data for ARQ retransmission (or flush a memory) in connection with a DCI, as described above. For example, when the UE 120 receives configuration information associated with configuring an RLC acknowledge mode (RLC-AM) for a MAC entity of the UE 120, the UE 120 may determine to interpret DCI as having feedback messages for previous TBs and perform associated ARQ operations, as described above. Additionally, or alternatively, the UE 120 may receive RRC signaling with a parameter associated with configuring ARQ operations on a per MAC entity (e.g., cell group) basis, a per logical channel basis, a per logical channel group basis, a per serving cell basis, a per HARQ ID group basis, or a per HARQ ID basis, among other examples. Similarly, whether the UE 120 interprets the DCI as being on a TB level, a CB level, or a CBG level may be based on a received parameter or a default configuration.

In some aspects, the network node 110 may include an ACK/NACK indicator, as described above, in a particular type of DCI format. For example, the network node 110 may include the ACK/NACK indicator or another indicator in any DCI format for scheduling PUSCH communications. Additionally, or alternatively, the network node 110 may omit the ACK/NACK indicator or another described indicator from one or more DCI formats. For example, network may configure (e.g., by RRC signaling) whether one or more DCI formats include or omit the ACK/NACK indicator (such a configuration can be provided per DCI format). In such an example, the UE 120 may use a default behavior for interpreting a received DCI. For example, if a particular HARQ ID is scheduled by a DCI format, the UE 120 may treat the received DCI as an error case when an ACK/NACK indicator is not included and may log an error message or perform another error behavior. In such a scenario, the UE may expect that all uplink DCI formats include or exclude the new field (e.g., there may be no mixed usage in which some DCI formats include the new field and some DCI formats do not). Alternatively, when the DCI format does not include an ACK/NACK field, the UE 120 may assume that a NACK is provided (e.g., that a previous TB was not decoded) or that an ACK is provided (e.g., that the previous TB was decoded) in accordance with a default or indicated behavior. Additionally, or alternatively, the UE 120 may interpret a lack of an ACK/NACK indicator based on a previous or subsequent indicator (e.g., the UE 120 may assume that a previous TB was decoded unless a previous or subsequent DCI indicated that the previous TB was not decoded). For example, as shown in FIG. 7J, and by example 790, the UE 120 may receive DCIs 714-1 and 714-2 and transmit PUSCH communications 712-1 and 712- to convey TB1.

As shown by reference number 792, when the UE 120 receives DCI 714-3, the DCI 714-3 includes an ACK/NACK indicator for TB1. However, as shown by reference number 794, when the UE 120 receives DCI 714-4, the DCI 714-4 does not include an ACK/NACK indicator for TB1. Accordingly, the UE 120 may use a default assumption for resolving the lack of the ACK/NACK indicator, such as a default behavior of assuming an ACK or a default behavior of assuming a NACK. Alternatively, the UE 120 may use a default assumption of following whichever indicator was included in the prior DCI, DCI 714-3. Alternatively, as shown by reference number 796, the UE 120 may use a default assumption of following whichever indicator is included in a subsequent DCI, DCI 714-5.

In some aspects, the UE 120 may transmit capability signaling indicating one or more behaviors with which the UE 120 is compatible. For example, the UE 120 may transmit capability signaling indicating that the UE 120 can interpret non-scheduling DCI as having an ACK/NACK indicator or that the UE 120 can interpret the ACK/NACK indicator on a TB level or on a CB or a CBG level.

As indicated above, FIGS. 7A-7J are provided as an example. Other examples may differ from what is described with respect to FIGS. 7A-7J.

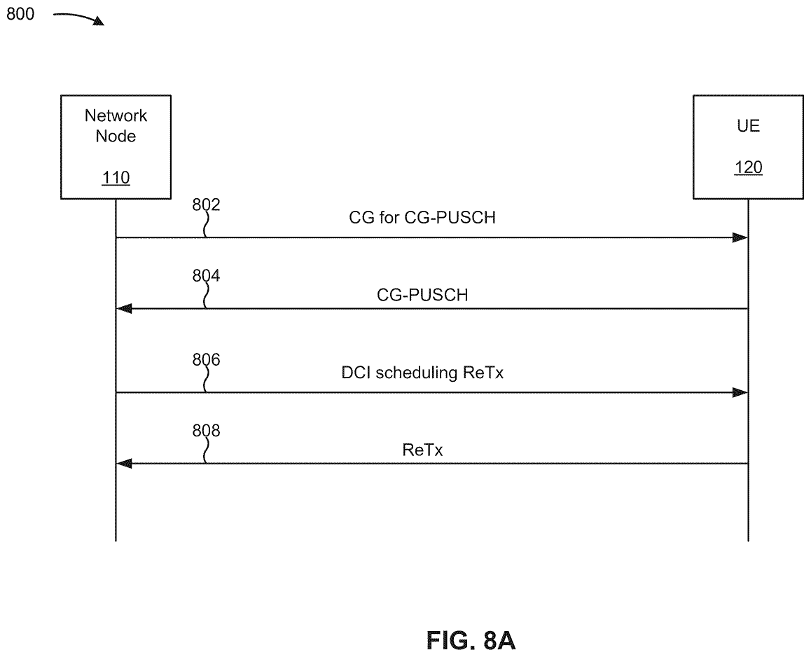

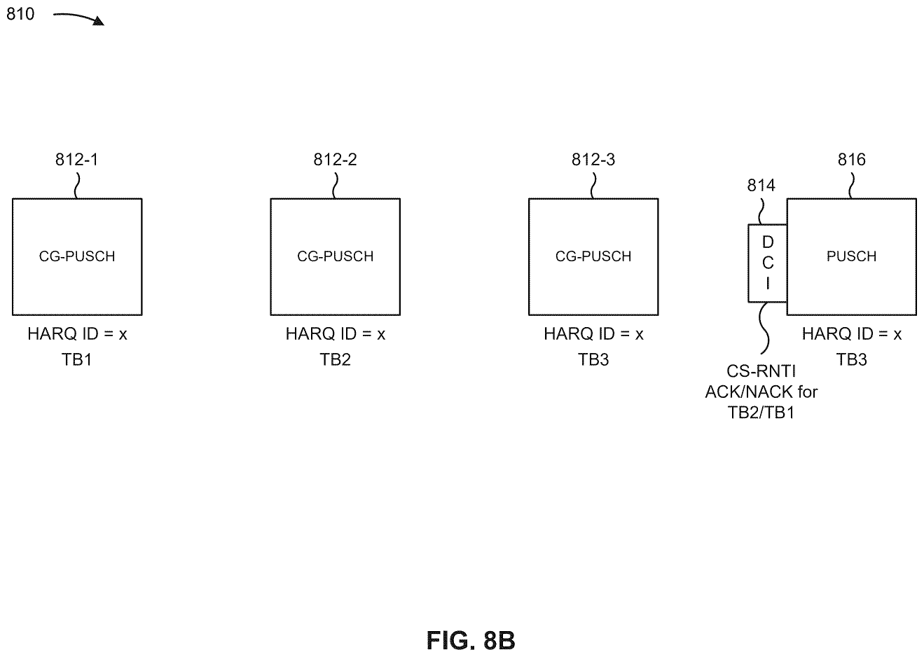

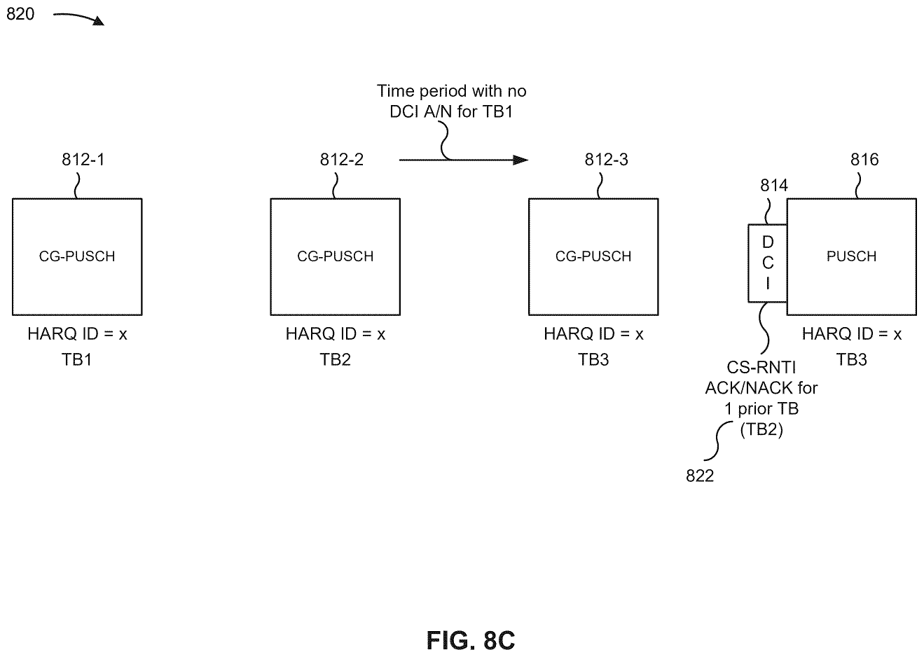

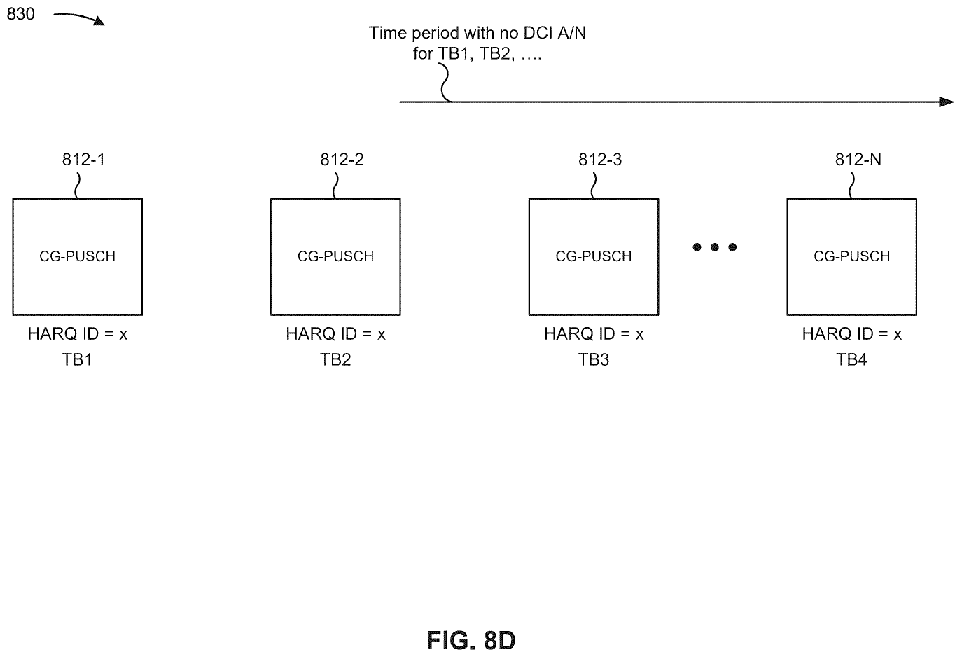

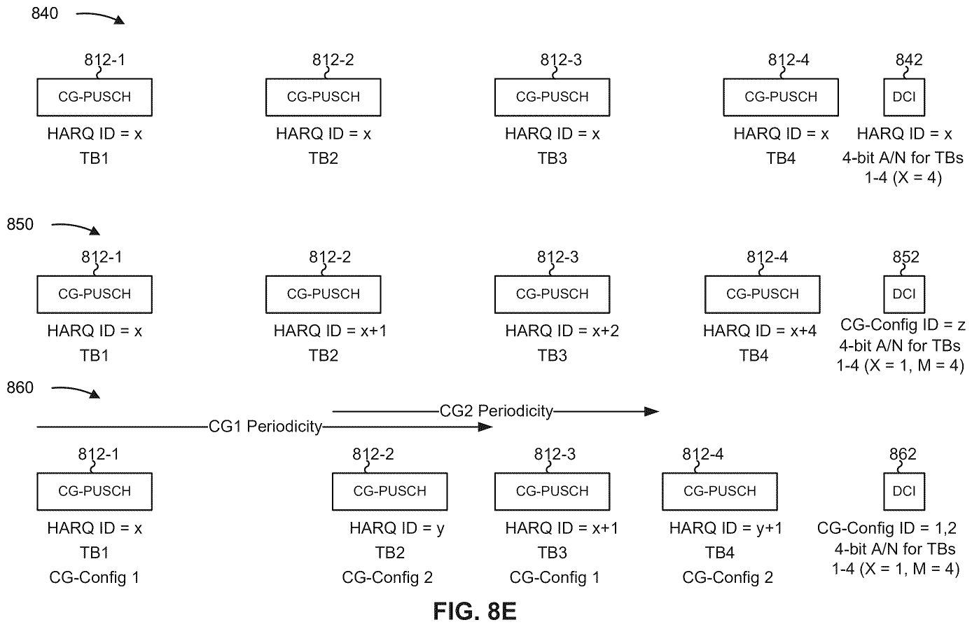

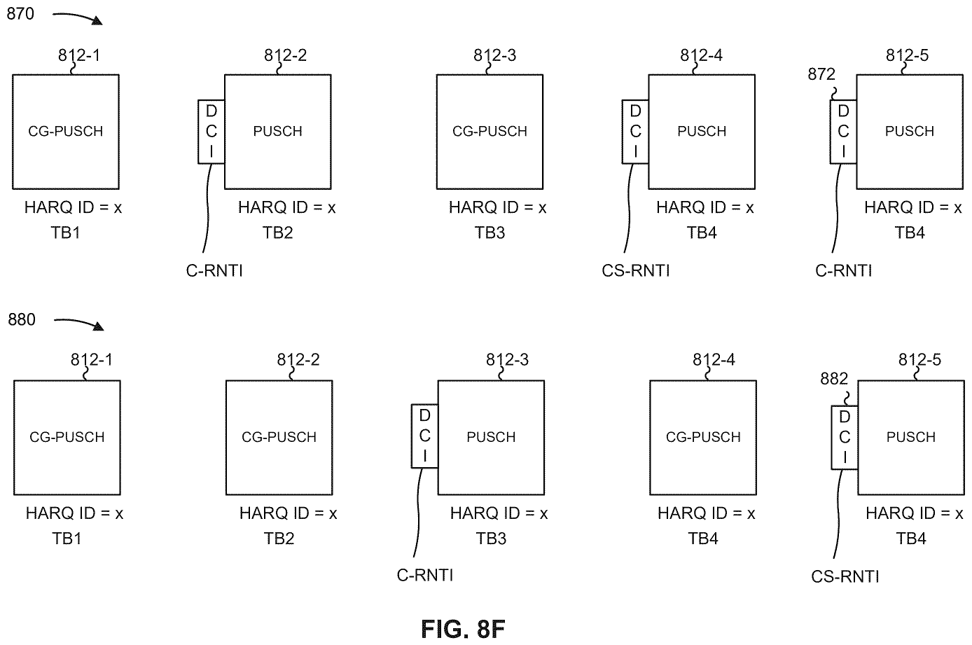

FIGS. 8A-8F are diagrams illustrating an example 800 associated with feedback messaging for CG communication, in accordance with the present disclosure. As shown in FIG. 8A, example 800 includes communication between a network node 110 and a UE 120.

As further shown in FIG. 8A, and by reference number 802, the UE 120 may receive signaling associated with configuring a grant for CG-PUSCH communication. For example, the network node 110 may transmit RRC signaling identifying one or more parameters for CG-PUSCH communication, such as a periodicity of a resource allocation for CG-PUSCH communication. Additionally, or alternatively, the UE 120 may receive an activation indication for the CG-PUSCH communication. For example, as described above, the UE 120 may determine that the UE 120 is triggered to transmit using the grant for CG-PUSCH communication based on receiving the grant for CG-PUSCH communication (e.g., via RRC signaling) or based on receiving subsequent activation signaling (e.g., via DCI signaling).

As further shown in FIG. 8A, and by reference number 804, the UE 120 may transmit a CG-PUSCH communication. For example, the UE 120 may identify data queued for uplink transmission to the network node 110 and may transmit the data via the configured grant. In some aspects, the UE 120 may transmit a set of CG-PUSCH communications. For example, the UE 120 may transmit a set of TBs via a set of CG-PUSCH communications and using one or more HARQ IDs.

As further shown in FIG. 8A, and by reference number 806, the UE 120 may receive DCI. For example, the UE 120 may receive, from the network node 110, DCI associated with scheduling a HARQ retransmission of a CG-PUSCH communication (e.g., a CG-ReTx). Accordingly, as shown by reference number 808, the UE 120 may transmit a CG-ReTx communication to the network node 110 based on information included in the DCI.

In some aspects, the DCI may include information indicating whether one or more prior TBs are to be retransmitted. For example, as shown in FIG. 8B, and by example 810, after a set of CG-PUSCHs 812 associated with a set of TBs (e.g., TB1, TB2, and TB3), the network node 110 may transmit DCI 814 (e.g., scheduling HARQ retransmission of a CG-PUSCH TB, such as TB3, with a particular HARQ ID, such as HARQ ID=x) with a CRC scrambled with a CS-RNTI and an NDI value set to a particular value (e.g., ‘1’).

In this case, the network node 110 may include, in the DCI 814, information indicating whether one or more prior TBs (e.g., TB1 and TB2) with the same HARQ ID (e.g., HARQ ID=x) as a current TB (e.g., TB3) and associated with the same CS-RNTI (e.g., in earlier CG occasions) were successfully received or not. In other words, the DCI 814 conveys an additional HARQ ACK or NACK for one or more prior TBs (e.g., one or more TBs occurring prior to a current TB, for which the DCI 814 is configured to provide a HARQ ACK or NACK). In some aspects, the DCI 814 may include information scheduling re-transmission of a CG-PUSCH in a target TB that has a common HARQ ID with the one or more prior TBs. When the UE 120 receives the DCI 814, the UE 120 may determine, based on the DCI 814, that a prior TB was not successfully received and may add one or more RLC SDUs or SDU segments of the previous TB to a queue for ARQ retransmission. The UE 120 queues the one or more RLC SDUs or SDU segments for ARQ retransmission, rather than HARQ retransmission, as a HARQ process for the previous TB has already terminated. Additionally, or alternatively, the UE 120 may determine, based on the DCI 814, that a prior TB was successfully received. In this case, an upper layer entity of the UE (e.g., an RLC entity) may flush a transmit buffer, thereby removing one or more RLC SDUs or SDU segments of the successfully received prior TB from a memory. Additionally, or alternatively, when the UE 120 receives the DCI but has not transmitted a CG-PUSCH in earlier CG occasions, the UE 120 may forgo using the indication for prior TBs in the DCI 814. As shown by reference number 816, the UE 120 may transmit a PUSCH to convey a retransmission of the TB3 based on receiving the DCI 814. Additionally, or alternatively, the UE 120 may transmit (e.g., in the PUSCH or another uplink communication) a retransmission of the TB1 or the TB2 based on the ACK or NACK indication in the DCI 814.

In some aspects, the ACK or NACK indication in the DCI scheduling a CG-ReTx may be associated with a particular quantity of prior transport blocks. For example, as shown in FIG. 8C, and by example 820, the UE 120 may transmit the CG-PUSCH communications 812, but may not receive a DCI during a period between the CG-PUSCH communication 812-2 and the CG-PUSCH communication 812-3 (e.g., which could provide an ACK or NACK for the CG-PUSCH communication 812-1 conveying TB1). Accordingly, when the UE 120 receives the DCI 814, the UE 120 may interpret the DCI 814 as including an ACK or NACK for a configured quantity of prior TBs. In some aspects, the DCI 814 includes an indication of a quantity of prior TBs for which the DCI 814 is applicable. For example, as shown by reference number 822, the DCI 814 may include an indication that the DCI 814 conveys an ACK or NACK for only one prior TB (e.g., TB2). Additionally, or alternatively, the UE 120 may be configured with a fixed value for the quantity of prior TBs to which a DCI can apply. Additionally, or alternatively, the UE 120 may be configured via semi-static signaling (e.g., the RRC signaling configuring the grant for the CG-PUSCH communications) with the quantity of prior TBs to which a DCI can apply.

In some aspects, the DCI may include a particular format for conveying an indication of the quantity of prior TBs to which the DCI applies. For example, when the DCI is to apply to a single prior TB, the DCI may include a one-bit field (e.g., with a first bit value indicating an ACK and a second bit value indicating a NACK for the single prior TB). Additionally, or alternatively, when the DCI is to apply to a plurality of prior TBs, the DCI may include a bitmap of a plurality of bits with values to indicate ACKs or NACKs for the plurality of prior TBs. Additionally, or alternatively, when the DCI is to apply to a plurality of prior TBs, the DCI may include a single bit bundling ACKs or NACKs for a set of prior TBs. In this case, a NACK value in the DCI may indicate that at least one TB of the set of prior TBs was not successfully received and an ACK value in the DCI may indicate that all TBs of the set of prior TBs were successfully received.

Additionally, or alternatively, the DCI may divide the prior TBs into a set of k bundles and the DCI may include k bits indicating ACKs or NACKs for each bundle of prior TBs. In this case, when a bit indicator conveys a NACK for a bundle of prior TBs, the UE 120 may queue RLC SDUs or SDU segments for all TBs of the bundle of prior TBs for ARQ retransmission. In contrast, when the bit indicator conveys an ACK for a bundle of prior TBs, the UE 120 may flush RLC SDUs or SDU segments for all TBs of the bundle of prior TBs. Additionally, or alternatively, the DCI may include an indicator of a quantity of TBs that were not successfully decoded. For example, when the DCI applies to X TBs, the DCI may include log₂(X+1) bits to indicate a quantity x of prior TBs that are not successfully decoded (e.g., where 0≤x≤X), which also indicates that the other TBs (other than the x prior TBs) are successfully decoded.

In some aspects, the UE 120 may set a timer associated with receiving DCI conveying an ACK or NACK for one or more prior TBs. For example, after transmitting a particular TB (e.g., TB1), the UE 120 may start an ACK timer. In this case, when the timer expires (e.g., when the timer is at a configured value), the UE 120 may determine a NACK for the particular TB (e.g., and may queue one or more RLC SDUs or SDU segments of the particular TB for ARQ retransmission). Alternatively, when the timer expires, the UE 120 may determine an ACK for the particular TB (e.g., and may flush RLC SDUs or SDU segments for the particular TB). In some aspects, the UE 120 may determine a behavior (e.g., whether to treat timer expiration as an ACK or NACK) or the amount of time for which the timer is set based on a default configuration or a received (e.g., RRC) configuration, among other examples. Additionally, or alternatively, the UE 120 may derive a parameter, such as the amount of time for the timer, such as deriving the amount of time as a function of at least one of a quantity of prior TBs to which DCI applies, a CG periodicity, or a quantity of HARQ IDs that are configured for a CG occasion, among other examples.

In some aspects, the UE 120 may not receive any DCI scheduling a CG-ReTx for at least a threshold period of time (e.g., as a result of the network node 110 not transmitting the DCI or the UE 120 not receiving the DCI). For example, as shown in FIG. 8D and example 830, the UE 120 may transmit CG-PUSCH communications 812-1 through 812-N without receiving DCI scheduling a CG-ReTx. In such an example, a large value for X, the quantity of prior TBs to which a DCI can apply, may allow for many CG-PUSCH communications to be ACKed or NACKed, but may result in a relatively large DCI overhead. Similarly, as described above, different formats for DCI indications may result in large amounts of ARQ retransmission or packet loss.

Accordingly, in some aspects, the network node 110 may transmit, and the UE 120 may receive, a non-scheduling DCI (e.g., a dummy DCI) that provides an ACK or NACK indication for one or more prior TBs for previous CG occasions, as shown in FIG. 8E and by examples 840, 850, and 860. For example, the UE 120 may receive a non-scheduling DCI (e.g., DCI not scheduling a CG-ReTx) that indicates an ACK or NACK for one or more prior TBs associated with one or more prior CG-PUSCH occasions. In this case, a CRC of the non-scheduling DCI may be scrambled with a CS-RNTI associated with the one or more prior CG-PUSCH occasions. In some aspects, the UE 120 may validate the DCI as a non-scheduling DCI for prior TB ACK or NACK based on a field in the DCI, such as an explicit indicator field or a set of reserved fields with a particular value. For example, when the frequency domain resource allocation (FDRA) field or modulation and coding scheme (MCS) field is set to a particular value, the UE 120 may determine that the DCI is a non-scheduling DCI conveying an ACK or NACK for one or more prior TBs.

In some aspects, the non-scheduling DCI may indicate one or more ACKs or NACKs for one or more prior TBs associated with the same HARQ ID that is indicated in the non-scheduling DCI. For example, as shown in example 840, the non-scheduling DCI 842 may include a HARQ ID that is the same as the HARQ ID of CG-PUSCH communications 812-1 through 812-4. In this case, the DCI 842 includes a 4-bit bitmap to provide ACKs or NACKs for a set of 4 (e.g., X=4) prior TBs. Additionally, or alternatively, the DCI 842 may include a different type or format of ACK or NACK indicator, such as a single bit indicator or a set of bundled bit indicators, among other examples, as described above.

In some aspects, the non-scheduling DCI may indicate one or more ACKs or NACKs for one or more prior TBs for each HARQ ID associated with a particular CG configuration. For example, as shown by example 850, a CG configuration is configured with 4 HARQ IDs (e.g., “x”, “x+1”, “x+2”, and “x+3”) corresponding to CG-PUSCH communications 812-1 through 812-4. Here, the DCI 852 includes an indication of the CG configuration identifier for the CG configuration that applies to CG-PUSCH communications 812-1 through 812-4 and includes an M ×X bitmap (e.g., a 4-bit bitmap), where M represents a total quantity of HARQ IDs and X represents a quantity of prior TBs with the same HARQ ID. Here, with 4 configured HARQ IDs and each HARQ ID being used for one prior TB, the DCI 842 includes a 4-bit bitmap providing ACKs or NACKs for the 4 prior TBs.

In some aspects, the non-scheduling DCI may indicate one or more ACKs or NACKs for one or more prior TBs for each HARQ ID associated with a plurality of CG configurations in a particular carrier (e.g., a CC). For example, as shown by example 860, CG-PUSCHs 812-1 and 812-3 are associated with a first CG configuration (e.g., CG-Config 1) and a set of two HARQ IDs, and CG-PUSCHs 812-2 and 812-4 are associated with a second CG configuration (e.g., CG-Config 2) and another set of two HARQ IDs. Accordingly, the DCI 862 includes an indicator of the CG configurations to which the DCI 862 is applicable and includes a 4-bit bitmap for providing ACKs or NACKs for TBs thereof.

In some aspects, the UE 120 may receive and interpret a DCI associated with DG-PUSCH communication. For example, the UE 120 may receive the DCI and may determine that the DCI is associated with scheduling a DG-PUSCH communication (e.g., rather than a CG-ReTx). In some aspects, the UE 120 may operate a set of separate processes for indication of unsuccessful HARQ termination or indication of ACK or NACK for prior TBs based on whether a C-RNTI or CS-RNTI is used for scrambling. For example, when a C-RNTI is used for scrambling, the UE 120 may interpret the DG-PUSCH DCI as indicating an ACK or NACK for prior TBs associated with the C-RNTI. Similarly, when a CS-RNTI is used for scrambling, the UE 120 may interpret the DCI scheduling CG-ReTx as indicating an ACK or NACK for prior TBs associated with the CS-RNTI. For example, as shown in FIG. 8F, and by example 870, when the UE 120 receives DCI 872, which is scrambled with a C-RNTI and associated with scheduling a DG-PUSCH communication 812-5, the UE 120 may interpret the DCI 872 as including an ACK or NACK for TB2 of the PUSCH communication 812-2, which was also scheduled by a DCI scrambled using a C-RNTI. In contrast, as shown by example 880, when the UE 120 receives DCI 882, which is scrambled with a CS-RNTI (and is scheduling a CG-ReTx of CG-PUSCH communication 812-4), the UE 120 may interpret the DCI 882 as including an ACK or NACK for TB2 of CG-PUSCH communication 812-2.

In some aspects, the UE 120 may allow cross-process signaling of ACKs or NACKs in DCI when DG-PUSCH operation overlaps with CG-PUSCH operation. For example, returning to example 870, the UE 120 may interpret the DCI 872, which is associated with a C-RNTI, as conveying an ACK or NACK for TB3 of the CG-PUSCH communication 812-3 (e.g., associated with a CS-RNTI). Similarly, returning to example 880, the UE 120 may interpret the DCI 882, which is associated with a CS-RNTI, as conveying an ACK or NACK for the TB3 of the DG-PUSCH communication 812-3 (e.g., associated with a C-RNTI). In other words, rather than treating C-RNTI-associated communications and CS-RNTI-associated communications separately, the UE 120 may treat C-RNTI-associated communications and CS-RNTI-associated communications jointly with respect to prior TB ACKs or NACKs in a DCI.

As indicated above, FIGS. 8A-8F are provided as examples. Other examples may differ from what is described with respect to FIGS. 8A-8F.

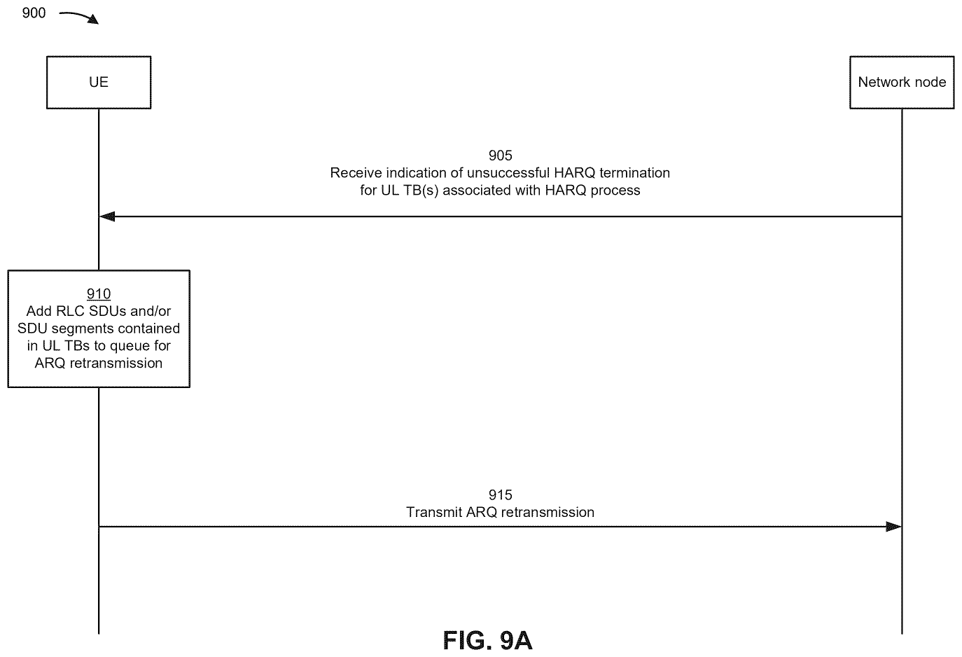

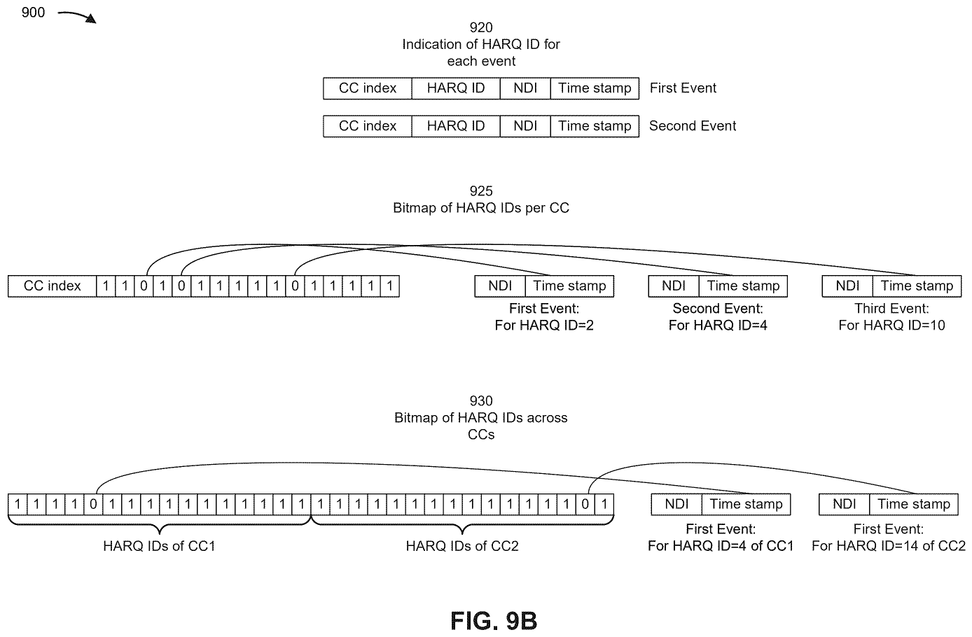

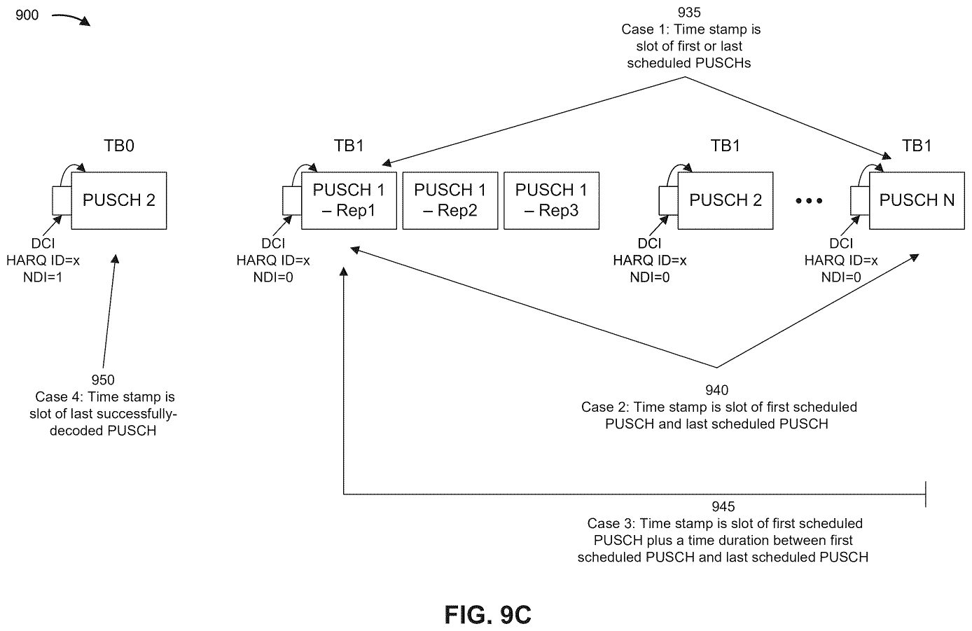

FIGS. 9A-9C are diagrams illustrating examples 900 associated with signaling of uplink ARQ, in accordance with the present disclosure. As shown in FIGS. 9A-9C, a network node and a UE may communicate with one another.

As shown in FIG. 9A, the network node may indicate, to the UE, one or more unsuccessful HARQ termination events for one or more uplink TBs associated with a given HARQ process. After receiving the indication from the network node, the UE may add RLC SDUs or RLC SDU segments included in the one or more uplink TBs to a transmission queue (e.g., a transmission buffer) for ARQ retransmission.

As shown by reference number 905, the network node may transmit, and the UE may receive, information that indicates one or more unsuccessful HARQ termination events associated with one or more respective uplink TBs associated with one or more HARQ IDs. In some aspects, the information may indicate a CC index, a HARQ ID, an NDI, and/or a time stamp associated with each unsuccessful HARQ termination event. In some aspects the network may transmit the information via a MAC-CE (e.g., at the MAC layer).

Additionally, or alternatively, the network node may transmit the information via an RLC status report (e.g., at the RLC layer). In some aspects, where the network node transmits the information via the RLC status report, the information may indicate NACK for an uplink TB (e.g., a MAC PDU), rather than for an RLC SDU SN. Additionally, in some aspects, the MAC layer at the network node may indicate, to the RLC layer at the network node, the unsuccessful HARQ termination event and the corresponding payload, thereby enabling preparation of the RLC status report. Similarly, the MAC layer at the UE may indicate, to the RLC layer at the UE, a mapping between TBs (e.g., at the HARQ ID level and/or in the MAC layer) and RLC SDUs or RLC SDU segments (e.g., at the RLC layer), thereby enabling correct interpretation of the RLC status report.

As shown by reference number 910, after receiving the information from the network node (e.g., via MAC-CE and/or via an RLC status report, among other examples), the UE may add the RLC SDUs or RLC SDU segments included in the uplink TBs to the transmission queue (e.g., the transmission buffer) for ARQ retransmission.

As shown by reference number 915, the UE may transmit, and the network node may receive, one or more uplink transmissions that include a retransmission of at least one or more RLC SDUs or RLC SDU segments associated with the respective uplink TB for the unsuccessful HARQ termination event.

As shown in FIG. 9B, the payload structure of the information received from the network node may be associated with an explicit indication of a HARQ ID for each event, a bitmap of HARQ IDs associated with a CC index, or a bitmap of HARQ IDs across CCs. For example, and as shown by reference number 920, the information may contain an indication of the HARQ ID for each unsuccessful HARQ termination event, including a CC index, a HARQ ID, an NDI, and/or a time stamp, among other examples.

As shown by reference number 925, the information may contain a bitmap of HARQ IDs (e.g., per CC) associated with one or more uplink TBs. In some aspects the information may indicate a CC index associated with the bitmap (e.g., associated with the corresponding unsuccessful HARQ termination events). In some aspects, the value of a bit (e.g., 0) in the bitmap may indicate that the HARQ ID is associated with an unsuccessful HARQ termination event. Additionally, the information may indicate an NDI and/or a time stamp associated with each unsuccessful HARQ termination event.

As shown by reference number 930, the information may be a bitmap that includes a bit to represent a HARQ ID associated with one or more uplink TBs. In some aspects, the value of the bit (e.g., 0) may indicate that the HARQ ID is associated with an unsuccessful HARQ termination event. Additionally, the information may indicate an NDI and/or a time stamp associated with each unsuccessful HARQ termination event for the HARQ ID of the associated CC.

Accordingly, where the information received from the network node indicates a CC index associated with the bitmap and/or the bitmap is associated with one or more CCs, transmission overhead may be reduced, for example, in circumstances of a relatively high quantity of unsuccessful HARQ termination events during a time period.

As shown in FIG. 9C, the information may include a time stamp to indicate the uplink TB to which the unsuccessful HARQ termination event refers. For example, where a downlink MAC-CE may be decoded after multiple HARQ retransmissions, the use of a time stamp may improve the accuracy of identifying the respective uplink TB relative to the use of a HARQ ID and/NDI, alone. For example, where multiple HARQ retransmissions have occurred, an NDI associated with a HARQ ID may have been reused one or more times, resulting in a potential reduction in accuracy when identifying the respective uplink TB.

In some aspects, the information received from the network node may indicate a time stamp for each unsuccessful HARQ termination event, where the time stamp indicates one or more time periods associated with one or more scheduled PUSCHs associated with each respective uplink TB. For example, the time stamp may indicate the slot, subframe, and/or frame of one or more scheduled PUSCHs associated with each respective uplink TB that is associated with an unsuccessful HARQ termination event (e.g., TB1). As shown by reference number 935, in a first case, the time stamp indicates one or more time periods associated with a first scheduled PUSCH or a last scheduled PUSCH.

As shown by reference number 940, in a second case, the time stamp indicates one or more time periods associated with a first scheduled PUSCH and a last scheduled PUSCH. As shown by reference number 945, in a third case, the time stamp indicates one or more time periods that include a first scheduled PUSCH and a time period occurring between the first scheduled PUSCH and the last scheduled PUSCH.

In some aspects, the UE may identify the respective uplink TB for a scheduled PUSCH based on any transmitted PUSCH (e.g., a PUSCH scheduled between the first scheduled PUSCH and the last scheduled PUSCH) that is associated with a matching HARQ ID and/or NDI (e.g., having the same value). Additionally, in the first case and/or the second case, the UE may identify the uplink TB associated with a PUSCH in circumstances where the DCI that scheduled the PUSCH (e.g., the PUSCH to which the time stamp refers) is missed by the UE (e.g., the UE may be unaware of the scheduled PUSCH, and as a result, the UE does not transmit in the scheduled PUSCH). In some aspects, where a scheduled PUSCH includes multiple PUSCH repetitions in multiple time periods (e.g., slots), the time period associated with the first PUSCH repetition and/or the last PUSCH repetition may be indicated by the network node.

As shown by reference number 950, in a fourth case, the time stamp indicates a time period associated with a PUSCH message that was successfully decoded most recently before transmission of a respective uplink TB having a HARQ ID that matches (e.g., has a same value) of the PUSCH message. For example, the time stamp may be associated with a slot, subframe, and/or frame of the most recent successfully decoded PUSCH (e.g., TB0) prior to the uplink TB that is associated with an unsuccessful HARQ termination event (e.g., TB1) having a matching HARQ ID. In some aspects, the UE may identify the uplink TB based on any PUSCH, transmitted after the time stamp, that is associated with a HARQ ID that matches (e.g., has a same value) a HARQ ID of a PUSCH that is transmitted and decoded at the time indicated by the time stamp.

Additionally, or alternatively, in some aspects, the UE may determine that an indication of unsuccessful HARQ termination for an uplink TB is invalid, and as a result, the UE may ignore the indication (e.g., refrain from ARQ retransmission). In some examples, the UE may be unaware or effectively unaware of the uplink TB that is indicated to be associated with an unsuccessful HARQ termination event. For example, where the UE is configured to enable uplink skipping, the UE may skip transmitting a PUSCH message (e.g., where the UE's buffer contains no uplink data), but the network node is unaware of the skipped transmission. As a result, the network node may incorrectly determine that the PUSCH message was not decoded, rather than determining that the transmission was skipped. Similarly, the network node may have missed the PUSCH message due to poor channel conditions and/or high interference. Additionally, the UE may have missed one or more DCIs that scheduled the uplink TB on the PUSCH (e.g., DCIs scheduling an initial transmission, DCIs that scheduled HARQ retransmissions, or the like). As a result, the network node may transmit potentially invalid (e.g., incorrect) information indicating an unsuccessful HARQ termination event.

In some aspects, the UE may skip an uplink transmission (e.g., ARQ retransmission) based on a determination that the UE did not receive an uplink grant scheduling a PUSCH transmission associated with an NDI and/or HARQ ID that matches a respective NDI and/or HARQ ID for a respective uplink TB that is associated with an indicated unsuccessful HARQ termination event. For example, the UE may determine that such an indication (e.g., of an unsuccessful HARQ termination event) is invalid based on a missing NDI (e.g., where NDI bitwidth is two bits) for the indicated HARQ ID (e.g., where the UE failed to detect an uplink DCI including the information associated with the NDI and/or HARQ ID during a time period associated with a time stamp).

In some aspects, the UE may skip an uplink transmission (e.g., an ARQ retransmission) based on a determination that the UE previously skipped one or more uplink transmissions associated with an NDI and/or a HARQ ID that corresponds to an NDI and/or HARQ ID associated with a respective uplink TB for an indicated unsuccessful HARQ termination event. Additionally, in some aspects, the UE may skip an uplink transmission (e.g., an ARQ retransmission) based on a determination that the information received from the network node indicates that the respective uplink TB for an unsuccessful HARQ termination event is not associated with an RLC SDU or RLC SDU segment. For example, where the UE is not configured for uplink skipping and the UE transmits only padding (e.g., unintelligible or corrupted data), the uplink TB may exist, but does not contain actual data (e.g., the UE may discard or ignore the existence of the uplink TB).

Additionally, or alternatively, in some aspects, the UE may discard RLC SDUs or RLC SDU segments for a respective uplink TB associated with an indicated unsuccessful HARQ termination event. The decision to discard the RLC SDUs or RLC SDU segments may be based on a determination that the UE has not received, during a time period (e.g., a threshold time period), an indication of one or more unsuccessful HARQ termination events associated with the respective uplink TB. In some aspects, the time period may be measured from an immediately preceding transmission of the respective uplink TB. For example, the network node my configure the UE with a value for a timer, where the timer may be used to measure the time period for determining whether to discard the RLC SDUs or RLC SDU segments.

In some aspects, the UE may be configured to start the timer after a PUSCH transmission containing an uplink TB, where the timer may be maintained for the uplink TB. The timer may be stopped and reset when the UE receives a grant for a HARQ retransmission of the uplink TB, and the timer may be restarted after the retransmission of the uplink TB. Where the timer satisfies (e.g., meets or exceeds) a threshold associated with a time period, and the UE has not received an indication of an unsuccessful HARQ termination event associated with the uplink TB, the UE may discard the RLC SDUs or RLC SDU segments associated with the uplink TB.

In some aspects, the value of the time period may be configured (e.g., via RRC configuration) for one or more of a cell group, a CC, a set of HARQ IDs, or a HARQ ID, among other examples. For example, the network node may configure the value of the time period based on scheduling decisions and/or reliability thresholds associated with the UE (e.g., interference conditions, signal quality and coverage, channel conditions, or the like). As a result, by discarding the RLC SDUs or RLC SDU segments according to the network-configured conditions, the UE may efficiently manage a transmission buffer, thereby resulting in a potential reduction in transmission buffer size.

As described herein, a UE may receive information indicating an unsuccessful HARQ termination event for an uplink TB associated with a HARQ ID, and the UE may transmit RLC SDUs or RLC SDU segments associated with the respective uplink TB of the unsuccessful HARQ termination event. In some examples, the described techniques can be used to reduce latency and to provide feedback signaling regarding unsuccessful HARQ termination events. For example, the described techniques can be used to reduce the probability of dropped communications or a latency associated with retransmitting missed communications. Additionally, the described techniques can be used to reduce the downlink overhead for reporting unsuccessful HARQ termination events and to efficiently manage the transmission buffer by removing potential outdated and/or irrelevant data.

As indicated above, FIGS. 9A-9C are provided as examples. Other examples may differ from what is described with respect to FIGS. 9A-9C.

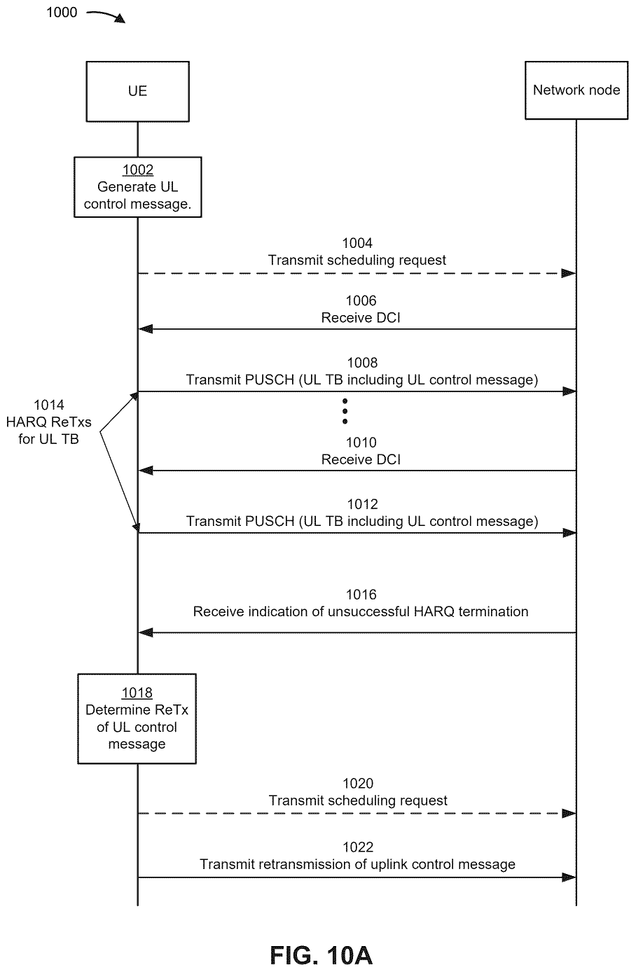

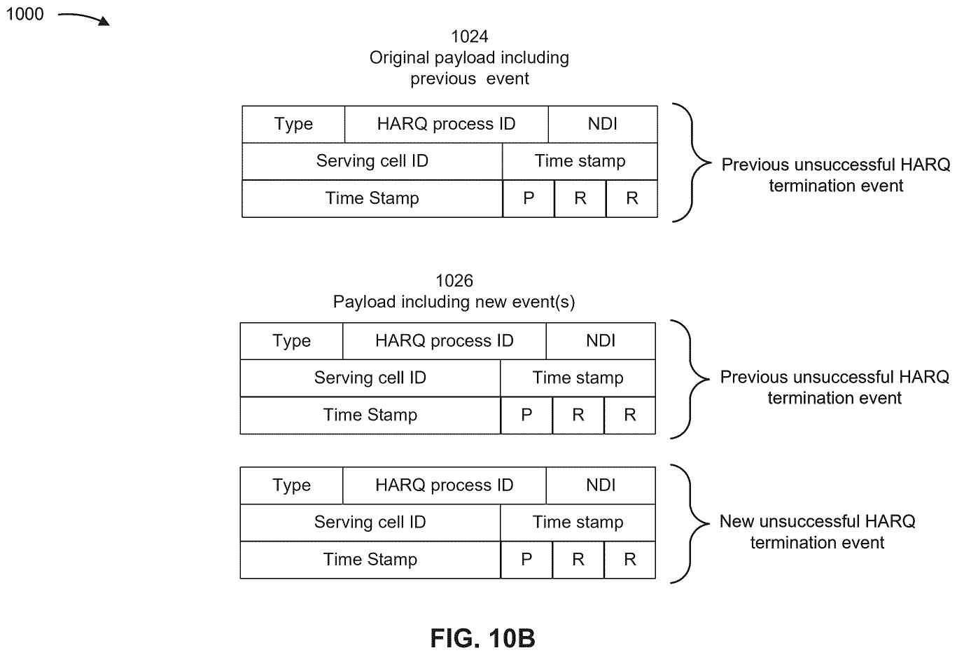

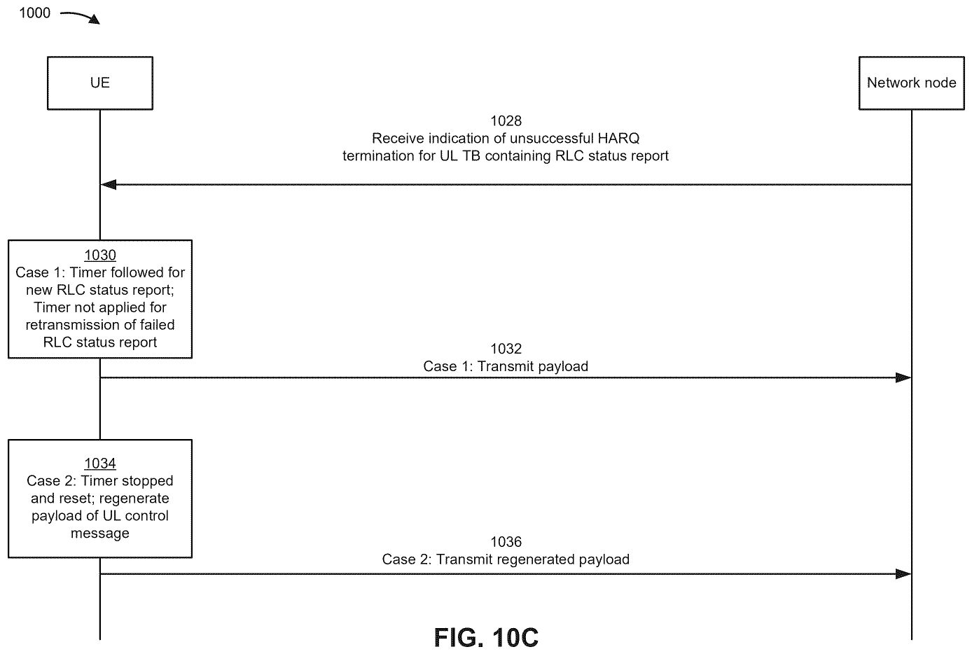

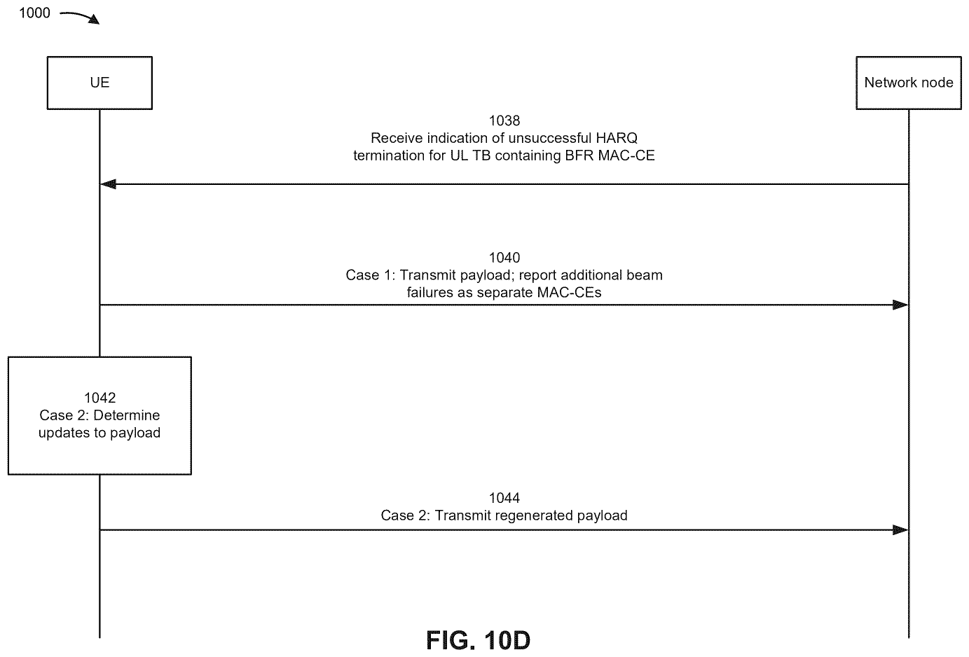

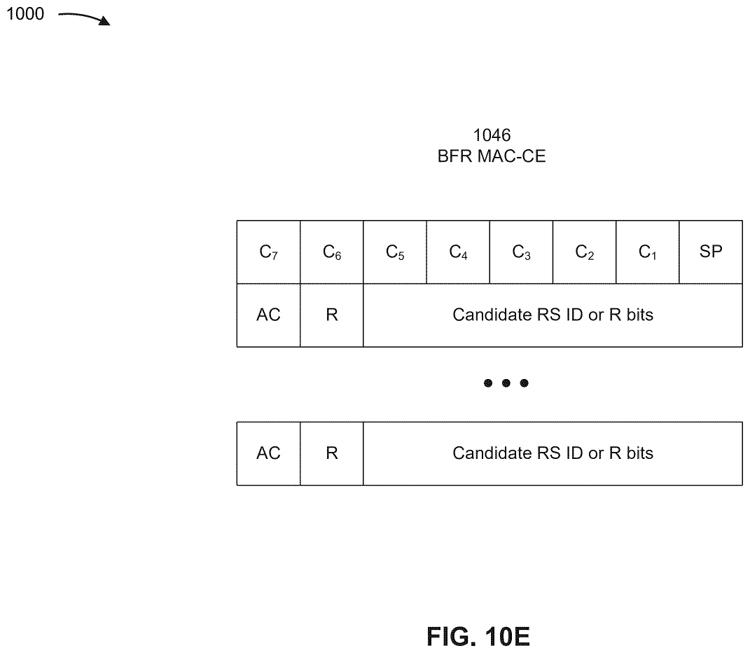

FIGS. 10A-10E are diagrams illustrating examples 1000 associated with ARQ transmission for uplink control messages, in accordance with the present disclosure.

As shown in FIG. 10A, example 1000 includes communication between a network node and a UE. In some aspects, the network node and the UE may be included in a wireless network, such as wireless network 100. The network node and the UE may communicate via a wireless access link, which may include an uplink and a downlink.

In some aspects, where the UE is able to determine whether an uplink control message is associated with a respective uplink TB (e.g., based on an association with a HARQ process, including CC, HARQ ID, and/or NDI, among other examples), the indication of an unsuccessful HARQ termination may enable ARQ retransmission of the uplink control message. For example, as shown in FIG. 10A, the UE may receive an indication of an unsuccessful HARQ termination associated with a previous uplink TB that included an uplink control message, and the UE may transmit uplink communications including a retransmission of the uplink control message. As shown by reference number 1002, the UE may generate an uplink control message, which may include an RLC status report for downlink, an indication of a downlink unsuccessful HARQ termination, and/or an uplink MAC-CE (e.g., BFR MAC-CE, buffer status report MAC-CE, power headroom report MAC-CE, CG configuration MAC-CE, listen-before-talk failure MAC-CE, or the like), among other examples. In some aspects, the uplink control message may be generated at the PHY layer, the MAC layer, or the RLC layer.

As shown by reference number 1004, the UE may transmit, and the network node may receive, an SR message, where the UE has not yet obtained an uplink transmission grant. As shown by reference number 1006, the network node may transmit, and the UE may receive, DCI. As shown by reference number 1008, the UE may transmit a PUSCH message containing an uplink TB that includes the uplink control message. As shown by reference numbers 1010 and 1012, the UE may receive DCI from the network node, and the UE may transmit the PUSCH message containing the uplink TB that includes the uplink control message.

As shown by reference number 1014, the transmissions of the PUSCH message containing the uplink TB (e.g., including the uplink control message) may include one or more HARQ retransmissions for the uplink TB (e.g., PUSCHs associated with the same HARQ ID and/or the same NDI as the previous uplink TB).

As shown by reference number 1016, the network node may transmit, and the UE may receive, an indication of an unsuccessful HARQ termination. For example, the indication may indicate the unsuccessful HARQ termination associated with the previous uplink TB, which included the uplink control message. In some aspects, the indication of the unsuccessful HARQ termination may be received via DCI (e.g., DCI that schedules a new uplink TB indicating NACK for the previous uplink TB) and/or via downlink MAC-CE.

As shown by reference number 1018, the UE may determine the retransmission of the uplink control message based on receipt of the indication of the unsuccessful HARQ termination. In some aspects, the UE may retransmit the uplink control message as including the same payload as used in the original transmission of the uplink control message. Alternatively, the uplink control message may be regenerated (e.g., including a new payload, new fields, or the like) and transmitted to the network node. In some aspects, the retransmission (e.g., retransmitting the same payload as used in the original transmission of the uplink control message or transmitting a regeneration of the uplink control message) may utilize a different CC and/or HARQ ID than the CC and/or HARQ ID associated with the previous uplink TB that included the uplink control message. For example, the retransmission may utilize the different CC and/or HARQ ID depending on the earliest uplink grant for a PUSCH that is able to carry the uplink control message.

As shown by reference number 1020, the UE may transmit, and the network node may receive, an SR message, where the UE has not obtained an uplink transmission grant. As shown by reference number 1022, the UE may transmit, and the network node may receive, one or more uplink communications that include the retransmission of the uplink control message.

As shown in FIG. 10B, where the uplink control message is associated with an indication of a downlink unsuccessful HARQ termination event, and new downlink unsuccessful HARQ termination events have occurred since the last uplink control message was transmitted (e.g., but unsuccessfully received), the UE may include the new unsuccessful HARQ termination events in the retransmission of the uplink control message.

As shown by reference number 1024, in some aspects, the previously-transmitted uplink control message may be associated with an indication of a downlink unsuccessful HARQ termination event. In some aspects, however, new downlink unsuccessful HARQ termination events may occur following the transmission of the previously-transmitted uplink control message.

As shown by reference number 1026, where the retransmitted uplink control message includes a regeneration of the uplink control message included in the previous TB, the regenerated payload may include the indications of both the previous downlink unsuccessful HARQ termination event and the new downlink unsuccessful HARQ termination event. As a result, the network node may receive a relatively more recent and potentially complete indication of downlink unsuccessful HARQ termination events.

Alternatively, the new unsuccessful HARQ termination event may be indicated as a separate MAC-CE transmitted to the network node. In some aspects, the indication of the new unsuccessful HARQ termination event may be associated with a lower transmission priority than a transmission priority associated with the retransmission of the uplink control message (e.g., the uplink control message associated with the indication of the previous downlink unsuccessful HARQ termination event). For example, where an uplink MAC PDU has sufficient capacity to include the indications of both the previous downlink unsuccessful HARQ termination event and the new downlink unsuccessful HARQ termination event, the UE may include both indications in the retransmission of the uplink control message. Alternatively, where the uplink MAC PDU lacks sufficient capacity to include both such indications, the UE may include the indication associated with the previous downlink unsuccessful HARQ termination event in the retransmission of the uplink control message. As a result, the indication of the new downlink unsuccessful HARQ termination event may be queued for subsequent transmission (e.g., based on subsequent uplink grants), thereby improving resource allocation efficiency and reducing potential latency resulting from the regeneration of the uplink control message.

In some aspects, the UE may transmit a UE capability indicator that identifies the UE's capability for storing one or more unsuccessful downlink HARQ termination events associated with previous downlink TBs. For example, the UE may indicate a threshold time duration for which the UE is capable of storing the content of an unsuccessful downlink HARQ termination event, including a downlink HARQ ID, a CC, an NDI, and/or a time stamp associated with the unsuccessful downlink HARQ termination event. Additionally, the UE may indicate a threshold (e.g., a maximum) quantity of unsuccessful downlink HARQ termination events that the UE is capable of storing. Similarly, the UE may indicate a threshold (e.g., a maximum) quantity of unsuccessful downlink HARQ termination events that the UE is capable of storing for a threshold (e.g., maximum) time duration. For example, the UE may indicate a capability of storing up to 4 unsuccessful downlink HARQ termination events for a threshold time duration of 100 milliseconds (ms) and a capability of storing up to 32 unsuccessful downlink HARQ termination events for a threshold duration of 30 ms. In some aspects, the threshold time duration or the threshold quantity of unsuccessful downlink HARQ termination events that the UE is capable of storing may be reported per CC or across multiple CCs.

In some aspects the UE may indicate a threshold quantity of unsuccessful downlink HARQ termination events that the UE is capable of storing at any time or at a configured time. For example, the UE may indicate a capability of storing up to eight unsuccessful downlink HARQ termination events, without an associated threshold time duration. Additionally, the threshold quantity of unsuccessful downlink HARQ termination events that the UE is capable of storing at any time or at a configured time may be reported per CC or across multiple CCs.

In some aspects, where the UE stores a quantity of unsuccessful downlink HARQ termination events that satisfies (e.g., meets or exceeds) one or more thresholds, the UE may discard one or more unsuccessful downlink HARQ termination events. In some aspects, the UE may discard the unsuccessful downlink HARQ termination events according to a priority associated with each unsuccessful downlink HARQ termination event. For example, the UE may discard the unsuccessful downlink HARQ termination events based on a priority associated with a serving cell (e.g., a PCell may be accorded a higher priority than an SCell), based on the quantity of retransmissions associated with the unsuccessful downlink HARQ termination event, or based on the time duration since the last transmission that included an indication of the unsuccessful downlink HARQ termination event, among other examples.

In some aspects, the network node may transmit, and the UE may receive, an RRC message that configures a threshold time duration, where the UE may optionally retransmit, or may refrain from retransmitting, the uplink control message associated with the unsuccessful downlink HARQ termination event after the threshold time duration has been satisfied (e.g., exceeded). For example, where the threshold time duration has been satisfied with respect to receipt of an indication of an unsuccessful downlink HARQ termination event, the UE may choose whether to retransmit an uplink control message associated with the unsuccessful downlink HARQ termination event. In some aspects, the network node may configure different threshold time durations for different quantities of unsuccessful downlink HARQ termination events.

As shown in FIG. 10C, where an uplink control message is associated with an RLC status report for a downlink communication, the UE may retransmit the uplink control message according to one or more threshold time periods. For example, a timer (e.g., t-StatusProhibit) associated with a threshold time period may be ignored, followed, or stopped and reset based on the UE receiving an indication of an unsuccessful downlink HARQ termination event for an uplink TB containing the RLC status report. As shown by reference number 1028, the network node may transmit, and the UE may receive, an indication of an unsuccessful HARQ termination event for an uplink TB that includes an RLC status report.

As shown by reference number 1030, in a first case, the UE may transmit one or more new RLC status reports (e.g., RLC status reports generated after transmission of the previous uplink TB) according to the timer. However, the UE may ignore the timer for the purpose of transmitting an RLC status report, where the RLC status report is associated with the uplink control message included in the previous uplink TB. Additionally, or alternatively, and as shown by reference number 1032, the UE may transmit, and the network node may receive, a retransmission of the uplink control message that includes a retransmission of a payload associated with the uplink control message. As a result, by ignoring the timer associated with transmission of an RLC status report associated with the previous uplink TB, the UE may ensure that the RLC status report is transmitted to the network node regardless of timing, thereby removing the effects of the missed transmission. Similarly, by following the timer for any new RLC status reports, the UE may reduce unnecessary signaling and/or retransmissions while ensuring transmission of the RLC status report associated with the previous uplink TB (e.g., the original RLC status report).

As shown by reference number 1034, in a second case, the UE may stop and reset the timer based on a determination that the uplink control message included in the previous uplink TB is associated with the RLC status report. Additionally, or alternatively, and as shown by reference number 1036, the UE may transmit, and the network node may receive, a retransmission of the uplink control message that includes a regeneration of the uplink control message included in the previous uplink TB. In some aspects, the regenerated uplink control message may include an ACK or a NACK indication for each SN associated with an RLC SDU or an RLC SDU segment received since the transmission of the previous uplink TB. Accordingly, by stopping and resetting a timer associated with transmission of the RLC status report associated with the previous uplink TB, the UE may increase the probability of the uplink communications including an ACK or NACK for the SNs associated with an RLC SDU or RLC SDU segment received since transmission of the previous uplink TB.

Additionally, or alternatively, where the uplink control message is associated with a BFR MAC-CE, a BFR operation may be completed when the UE receives an indication of a successful HARQ termination for the previous uplink TB (e.g., the uplink TB including the uplink control message). For example, the BFR operation may include resetting one or more beams or one or more uplink power control parameters based on one or more identified beams, among other examples. However, where the uplink control message is associated with a BFR MAC-CE and the UE receives an indication of an unsuccessful HARQ termination associated with the uplink control message included in the previous uplink TB, the UE may retransmit the uplink control message.

For example, as shown in FIG. 10D, and as shown by reference number 1038, the network node may transmit, and the UE may receive, an indication of an unsuccessful HARQ termination event for a previous uplink TB that includes BFR MAC-CE. As shown by reference number 1040, in a first case, where there are one or more new beam failure events (e.g., associated with one or more different SCells) that occurred since a transmission of the previous uplink TB including the BFR MAC-CE, the UE may transmit one or more new indications associated with the new beam failure events. In some aspects, each new indication associated with a respective new beam failure event may be transmitted in a separate MAC-CE. Additionally, in some aspects, the new indications may be included in a retransmission of a payload associated with the uplink control message associated with the previous uplink TB. Additionally, or alternatively, in some aspects, the indication of the new beam failure events may be associated with a lower transmission priority than a transmission priority associated with the retransmission of the uplink control message associated with the previous uplink TB. For example, where an uplink MAC PDU has sufficient capacity to include both the indications of both the new beam failure events and the beam failure events included in the uplink control message of the previous uplink TB, the UE may include both indications in the retransmission of the uplink control message.

As shown by reference number 1042, in a second case, where there are one or more new beam failure events that occurred since a transmission of the previous uplink TB including the BFR MAC-CE, the retransmitted uplink control message may include a regeneration of the uplink control message included in the previous uplink TB. In some aspects, the retransmitted uplink TB may include one or more updated fields associated with the BFR MAC-CE based on one or more beam conditions received since a transmission of the previous uplink TB. As shown by reference number 1044, the UE may transmit, and the network node may receive, the regeneration of the uplink control message that was included in the previous uplink TB. Additionally, the regeneration of the uplink control message may include one or more updated fields associated with the BFR MAC-CE.

For example, as shown in FIG. 10E, and by reference number 1046, one or more fields in the regenerated BFR MAC-CE payload may be updated based on one or more updated beam conditions received since the transmission of the previous uplink TB. For example, the Candidate RS ID (e.g., corresponding to new beams identified since the transmission of the previous uplink TB) may be updated to include new beams having one or more qualities (e.g., RSRP, interference, signal-to-interference-plus-noise ratio (SINR), or the like) that satisfy a threshold. Additionally, the UE may change the values in one or more Cᵢ fields (e.g., corresponding to SCells with beam failure) to 1, where additional SCells have experienced beam failure since the transmission of the previous uplink TB. For example, by changing a Cᵢ field value to 1, the UE may indicate a beam for inclusion in a candidate set for beam recovery. Additionally, for Cᵢ fields that were previously set to a value of 1, the UE may be configured so that the Cᵢ field value remains at 1. Additionally, or alternatively, for Cᵢ fields that were previously set to a value of 1, the UE may be configured so that the UE may change the value of the Cᵢ field to 0. For example, where beam failure is subsequently resolved, the UE may be configured so that it may change the value of the Cᵢ field to 0, which may indicate that the beam is not included in the candidate set for beam recovery or that the beam is inactive.

Additionally, or alternatively, in some aspects, the network node may transmit, and the UE may receive, an RRC message indicating one or more conditions for retransmitting the uplink control message. For example, the RRC configuration may enable or disable a retransmission capability for uplink control messages. Additionally, the RRC message may configure a threshold quantity (e.g., a maximum) of retransmissions for the uplink control message. For example, where the quantity of retransmissions satisfies (e.g., meets or exceeds) the threshold quantity, the UE may be disabled from transmitting additional retransmissions of the uplink control message. Additionally, the RRC message may configure a threshold (e.g., a minimum or a maximum) time duration between consecutive retransmissions of the uplink control message. Similarly, the RRC message may configure a threshold (e.g., a maximum) time duration across all retransmissions of the uplink control message. For example, after a threshold time duration has been satisfied (e.g., met or exceeded), based on a time duration measured from the first retransmission of the uplink control message, the UE may be disabled from transmitting additional retransmissions of the uplink control message.

In some aspects, the one or more conditions for retransmitting the uplink control message may be applied based on an uplink control message type associated with the uplink control message. For example, the network node may configure different conditions based on the uplink control message having an uplink control message type that is associated with an indication of an unsuccessful HARQ termination event, an RLC status report, or MAC-CEs (e.g., including different MAC-CE types), among other examples. By configuring the retransmission of uplink control messages based on the type of uplink control message or according to a retransmission quantity threshold or time duration threshold, the network node may improve spectral efficiency by preventing unnecessary transmissions and/or transmissions associated with a relatively lower priority, or transmissions having a lower threshold for reliability, depending on network traffic, available resources, or the like.

As described herein, a UE may receive an indication of an unsuccessful HARQ termination associated with a previous uplink TB including an uplink control message, and the UE may transmit one or more uplink communications that includes a retransmission of the uplink control message. In some examples, the described techniques can be used to decrease latency, improve network communication reliability, and ensure efficient resource allocation. For example, where the UE retransmits uplink control messages upon receipt of an indication of an unsuccessful HARQ termination, the UE may increase the probability of consistent, reliable data delivery, thereby increasing spectral efficiency and decreasing latency due to a reduced quantity of repeated transmissions (e.g., as a result of missed or failed transmissions). Additionally, where the retransmission of the uplink control message includes a new indication of downlink HARQ termination events and the new indications are given a relatively lower transmission priority, the UE may prioritize retransmission of the original uplink control message prior to providing the network node with a new indication, while conserving transmit and power resources.

As indicated above, FIGS. 10A-10E are provided as examples. Other examples may differ from what is described with respect to FIGS. 10A-10E.

FIG. 11 is a diagram illustrating an example process 1100 performed, for example, at a UE or an apparatus of a UE, in accordance with the present disclosure. Example process 1100 is an example where the apparatus or the UE (e.g., UE 120) performs operations associated with feedback messaging for CG communication.

As shown in FIG. 11, in some aspects, process 1100 may include receiving, via a transceiver, a first message identifying a resource allocation for a CG-PUSCH communication (block 1110). For example, the UE (e.g., using communication manager 150 and/or reception component 1902, depicted in FIG. 19) may receive a first message identifying a resource allocation for a CG-PUSCH communication, as described above, for example, with reference to FIGS. 8A-8F.

As further shown in FIG. 11, in some aspects, process 1100 may include transmitting, via the transceiver and using the resource allocation, the CG-PUSCH communication (block 1120). For example, the UE (e.g., using communication manager 150 and/or transmission component 1904, depicted in FIG. 19) may transmit, using the resource allocation, the CG-PUSCH communication, as described above, for example, with reference to FIGS. 8A-8F.

As further shown in FIG. 11, in some aspects, process 1100 may include receiving, via the transceiver, DCI scheduling a re-transmission of the CG-PUSCH communication, wherein the DCI includes a feedback message associated with one or more prior TBs (block 1130). For example, the UE (e.g., using communication manager 150 and/or reception component 1902, depicted in FIG. 19) may receive DCI scheduling a re-transmission of the CG-PUSCH communication, wherein the DCI includes a feedback message associated with one or more prior TBs, as described above, for example, with reference to FIGS. 8A-8F.

Process 1100 may include additional aspects, such as any single aspect or any combination of aspects described below and/or in connection with one or more other processes described elsewhere herein.

In a first aspect, the feedback message includes a negative acknowledgment for the one or more prior TBs, and process 1100 includes transmitting a re-transmission of another communication associated with the one or more prior TBs.

In a second aspect, alone or in combination with the first aspect, the feedback message indicates an acknowledgement for the one or more prior TBs, and process 1100 includes deleting one or more data units associated with a transmit buffer for the one or more prior TBs.

In a third aspect, alone or in combination with one or more of the first and second aspects, the DCI includes an indication of a quantity of prior TBs to which the feedback message applies.

In a fourth aspect, alone or in combination with one or more of the first through third aspects, the feedback message includes at least one of a bitmap of bits corresponding to the one or more prior TBs, a bit indicator identifying a collective feedback state for an entirety of the one or more prior TBs, a plurality of sets of bits corresponding to a plurality of subsets of the one or more prior TBs, or an indicator of a quantity of the one or more prior TBs to which a feedback state applies.

In a fifth aspect, alone or in combination with one or more of the first through fourth aspects, process 1100 includes starting, based on transmitting the one or more prior TBs, a feedback timer, and stopping, based on receiving the DCI, the feedback timer, wherein an expiration of the feedback timer is associated with a default behavior for automatic repeat request re-transmission, wherein a duration of the feedback timer is based on a received indication or a function of one or more parameters relating to the CG-PUSCH communication.

In a sixth aspect, alone or in combination with one or more of the first through fifth aspects, the DCI is a scheduling DCI associated with scheduling a CG re-transmission.

In a seventh aspect, alone or in combination with one or more of the first through sixth aspects, the DCI is a non-scheduling DCI, and wherein a configuration of the DCI is associated with the CG-PUSCH communication, wherein the configuration includes a scrambling of a cyclic redundancy check.

In an eighth aspect, alone or in combination with one or more of the first through seventh aspects, the DCI is a non-scheduling DCI, and the non-scheduling DCI and the one or more prior TBs are associated with a common feedback message identifier.

In a ninth aspect, alone or in combination with one or more of the first through eighth aspects, the DCI is a non-scheduling DCI, and the non-scheduling DCI includes an indication of at least one of a CG configuration associated with the one or more prior TBs, or a carrier associated with the one or more prior TBs.

In a tenth aspect, alone or in combination with one or more of the first through ninth aspects, the DCI is for a DG-PUSCH communication and is associated with a cyclic redundancy check scrambled with a configured-scheduling radio network temporary identifier.

In an eleventh aspect, alone or in combination with one or more of the first through tenth aspects, the one or more prior TBs are associated with a configured-scheduling radio network temporary identifier associated with one or more prior CG-PUSCH communications.

In a twelfth aspect, alone or in combination with one or more of the first through eleventh aspects, the one or more prior TBs are associated with a latest of a cell radio network temporary identifier or a configured-scheduling radio network temporary identifier.

In a thirteenth aspect, alone or in combination with one or more of the first through twelfth aspects, the one or more prior TBs and the CG-PUSCH communication are associated with a common hybrid automatic repeat request identifier.

In a fourteenth aspect, alone or in combination with one or more of the first through thirteenth aspects, the received DCI schedules the re-transmission of the CG-PUSCH in a target transport block, wherein the one or more prior transport blocks and the target transport block are associated with a common hybrid automatic repeat request identifier.

Although FIG. 11 shows example blocks of process 1100, in some aspects, process 1100 may include additional blocks, fewer blocks, different blocks, or differently arranged blocks than those depicted in FIG. 11. Additionally, or alternatively, two or more of the blocks of process 1100 may be performed in parallel.

FIG. 12 is a diagram illustrating an example process 1200 performed, for example, at a network node or an apparatus of a network node, in accordance with the present disclosure. Example process 1200 is an example where the apparatus or the network node (e.g., network node 110) performs operations associated with feedback messaging for CG communication.

As shown in FIG. 12, in some aspects, process 1200 may include transmitting, via a transceiver, a first message identifying a resource allocation for a CG-PUSCH communication (block 1210). For example, the network node (e.g., using communication manager 150 and/or transmission component 2004, depicted in FIG. 20) may transmit a first message identifying a resource allocation for a CG-PUSCH communication, as described above, for example, with reference to FIGS. 8A-8F.

As further shown in FIG. 12, in some aspects, process 1200 may include transmitting, via the transceiver, DCI scheduling a re-transmission of the CG-PUSCH communication, wherein the DCI includes a feedback message associated with one or more prior TBs (block 1220). For example, the network node (e.g., using communication manager 150 and/or transmission component 2004, depicted in FIG. 20) may transmit DCI scheduling a re-transmission of the CG-PUSCH communication, wherein the DCI includes a feedback message associated with one or more prior TBs, as described above, for example, with reference to FIGS. 8A-8F.

Process 1200 may include additional aspects, such as any single aspect or any combination of aspects described below and/or in connection with one or more other processes described elsewhere herein.

In a first aspect, the feedback message includes a negative acknowledgment for the one or more prior TBs, and process 1200 includes receiving a re-transmission of another communication associated with the one or more prior TBs.

In a second aspect, alone or in combination with the first aspect, the feedback message indicates an acknowledgement for the one or more prior TBs.

In a third aspect, alone or in combination with one or more of the first and second aspects, the DCI includes an indication of a quantity of prior TBs to which the feedback message applies.

In a fourth aspect, alone or in combination with one or more of the first through third aspects, the feedback message includes at least one of a bitmap of bits corresponding to the one or more prior TBs, a bit indicator identifying a collective feedback state for an entirety of the one or more prior TBs, a plurality of sets of bits corresponding to a plurality of subsets of the one or more prior TBs, or an indicator of a quantity of the one or more prior TBs to which a feedback state applies.

In a fifth aspect, alone or in combination with one or more of the first through fourth aspects, the DCI is a scheduling DCI associated with scheduling a CG re-transmission.

In a sixth aspect, alone or in combination with one or more of the first through fifth aspects, the DCI is a non-scheduling DCI, and a configuration of the DCI is associated with the CG-PUSCH communication, wherein the configuration includes a scrambling of a cyclic redundancy check.

In a seventh aspect, alone or in combination with one or more of the first through sixth aspects, the DCI is a non-scheduling DCI, and the non-scheduling DCI and the one or more prior TBs are associated with a common feedback message identifier.

In an eighth aspect, alone or in combination with one or more of the first through seventh aspects, the DCI is a non-scheduling DCI, and the non-scheduling DCI includes an indication of at least one of a CG configuration associated with the one or more prior TBs, or a carrier associated with the one or more prior TBs.

In a ninth aspect, alone or in combination with one or more of the first through eighth aspects, the DCI is for a DG-PUSCH communication and is associated with a cyclic redundancy check scrambled with a configured-scheduling radio network temporary identifier.

In a tenth aspect, alone or in combination with one or more of the first through ninth aspects, the one or more prior TBs are associated with a configured-scheduling radio network temporary identifier associated with one or more prior CG-PUSCH communications.

In an eleventh aspect, alone or in combination with one or more of the first through tenth aspects, the one or more prior TBs are associated with a latest of a cell radio network temporary identifier or a configured-scheduling radio network temporary identifier.

In a twelfth aspect, alone or in combination with one or more of the first through eleventh aspects, the transmitted DCI schedules the re-transmission of the CG-PUSCH in a target transport block, wherein the one or more prior transport blocks and the target transport block are associated with a common hybrid automatic repeat request identifier.

In a thirteenth aspect, alone or in combination with one or more of the first through twelfth aspects, the one or more prior TBs are associated with a configured-scheduling radio network temporary identifier.

Although FIG. 12 shows example blocks of process 1200, in some aspects, process 1200 may include additional blocks, fewer blocks, different blocks, or differently arranged blocks than those depicted in FIG. 12. Additionally, or alternatively, two or more of the blocks of process 1200 may be performed in parallel.

FIG. 13 is a diagram illustrating an example process 1300 performed, for example, at a UE or an apparatus of a UE, in accordance with the present disclosure. Example process 1300 is an example where the apparatus or the UE (e.g., UE 120) performs operations associated with indication of HARQ termination for uplink communication.

As shown in FIG. 13, in some aspects, process 1300 may include receiving a DCI message associated with scheduling a new TB on a physical uplink shared channel, wherein the DCI message includes a feedback indication of a previous TB (block 1310). For example, the UE (e.g., using communication manager 150 and/or reception component 1902, depicted in FIG. 19) may receive a DCI message associated with scheduling a new TB on a physical uplink shared channel, wherein the DCI message includes a feedback indication of a previous TB, as described above, for example, with reference to FIGS. 7A-7J.

As further shown in FIG. 13, in some aspects, process 1300 may include transmitting one or more uplink communications, wherein whether the one or more uplink communications includes a retransmission of information associated with the previous TB is based on the feedback indication (block 1320). For example, the UE (e.g., using communication manager 150 and/or transmission component 1904, depicted in FIG. 19) may transmit one or more uplink communications, wherein whether the one or more uplink communications includes a retransmission of information associated with the previous TB is based on the feedback indication, as described above, for example, with reference to FIGS. 7A-7J.

Process 1300 may include additional aspects, such as any single aspect or any combination of aspects described below and/or in connection with one or more other processes described elsewhere herein.

In a first aspect, the DCI message includes an indication of a particular HARQ ID for the new TB, and the feedback indication of the previous TB is associated with the particular HARQ ID.

In a second aspect, alone or in combination with the first aspect, process 1300 includes receiving another DCI message with an untoggled new data indicator value scheduling a retransmission of a new TB, where the other DCI message includes a same feedback indication for the previous TB as the feedback indication included in the DCI message.

In a third aspect, alone or in combination with one or more of the first and second aspects, the DCI message includes an untoggled new data indicator value for a feedback identifier and the DCI message indicates a negative acknowledgment for the previous TB associated with the feedback identifier, and a previous DCI message with a same new data indicator value and feedback identifier indicates an acknowledgment for the previous TB.

In a fourth aspect, alone or in combination with one or more of the first through third aspects, the UE is configured to transmit a new TB based on the DCI message.

In a fifth aspect, alone or in combination with one or more of the first through fourth aspects, the UE is configured to perform ARQ retransmission for one or more radio link control service data units associated with the previous TB based on the DCI message.

In a sixth aspect, alone or in combination with one or more of the first through fifth aspects, the UE is configured to flush one or more radio link control service data units associated with the previous TB based on the DCI message.

In a seventh aspect, alone or in combination with one or more of the first through sixth aspects, whether the UE is configured to retransmit or flush one or more radio link control service data units associated with the previous TB is based on an indicator value in the DCI message.

In an eighth aspect, alone or in combination with one or more of the first through seventh aspects, the DCI message includes a new data indicator value that is increased, relative to a previous new data indicator value, by more than one increment for an indicated feedback identifier and is associated with a plurality of previous TBs.

In a ninth aspect, alone or in combination with one or more of the first through eighth aspects, the DCI message includes a two-bit new data indicator associated with indicating the new TB.

In a tenth aspect, alone or in combination with one or more of the first through ninth aspects, the DCI message includes a set of bits associated with identifying a set of TBs, with a common identifier, that are triggered for re-transmission.

In an eleventh aspect, alone or in combination with one or more of the first through tenth aspects, the feedback indication applies to one or more indicated code blocks or code block groups of the previous TB, wherein an interpretation of a code block indication field is associated with a value in another field.

In a twelfth aspect, alone or in combination with one or more of the first through eleventh aspects, process 1300 includes receiving configuration information associated with identifying a feedback mode, and receiving the DCI message comprises receiving the DCI message based on the feedback mode.

In a thirteenth aspect, alone or in combination with one or more of the first through twelfth aspects, process 1300 includes transmitting a UE capability indicator identifying a capability for a feedback mode, and receiving the DCI message comprises receiving the DCI message based on transmitting the UE capability indicator.

Although FIG. 13 shows example blocks of process 1300, in some aspects, process 1300 may include additional blocks, fewer blocks, different blocks, or differently arranged blocks than those depicted in FIG. 13. Additionally, or alternatively, two or more of the blocks of process 1300 may be performed in parallel.

FIG. 14 is a diagram illustrating an example process 1400 performed, for example, at a network node or an apparatus of a network node, in accordance with the present disclosure. Example process 1400 is an example where the apparatus or the network node (e.g., network node 110) performs operations associated with indication of unsuccessful HARQ termination for uplink communication.

As shown in FIG. 14, in some aspects, process 1400 may include transmitting a DCI message associated with scheduling a new TB on a physical uplink shared channel, wherein the DCI message includes a feedback indication of a previous TB (block 1410). For example, the network node (e.g., using communication manager 150 and/or transmission component 2004, depicted in FIG. 20) may transmit a DCI message associated with scheduling a new TB on a physical uplink shared channel, wherein the DCI message includes a feedback indication of a previous TB, as described above, for example, with reference to FIGS. 7A-7J.

As further shown in FIG. 14, in some aspects, process 1400 may include receiving one or more uplink communications, wherein whether the one or more uplink communications includes a retransmission of information associated with the previous TB is based on the feedback indication (block 1420). For example, the network node (e.g., using communication manager 150 and/or reception component 2002, depicted in FIG. 20) may receive one or more uplink communications, wherein whether the one or more uplink communications includes a retransmission of information associated with the previous TB is based on the feedback indication, as described above, for example, with reference to FIGS. 7A-7J.

Process 1400 may include additional aspects, such as any single aspect or any combination of aspects described below and/or in connection with one or more other processes described elsewhere herein.

In a first aspect, the DCI message includes an indication of a particular HARQ ID for the new TB, and the feedback indication of the previous TB is associated with the particular HARQ ID.

In a second aspect, alone or in combination with the first aspect, process 1400 includes transmitting another DCI message with an untoggled new data indicator value scheduling a retransmission of a new TB, where the other DCI message includes a same feedback indication for the previous TB as the feedback indication included in the DCI message.

In a third aspect, alone or in combination with one or more of the first and second aspects, the DCI message includes an untoggled new data indicator value for a feedback identifier and the DCI message indicates a negative acknowledgment for the previous TB associated with the feedback identifier, and a previous DCI message with a same new data indicator value and feedback identifier indicates an acknowledgment for the previous TB.

In a fourth aspect, alone or in combination with one or more of the first through third aspects, the DCI message is associated with a configuration of a transmission of a new TB.

In a fifth aspect, alone or in combination with one or more of the first through fourth aspects, the DCI message is associated with a configuration of ARQ retransmission for one or more radio link control service data units associated with the previous TB.

In a sixth aspect, alone or in combination with one or more of the first through fifth aspects, the DCI message is associated with a configuration of a flush one or more radio link control service data units associated with the previous TB.

In a seventh aspect, alone or in combination with one or more of the first through sixth aspects, whether the DCI message is associated with a configuration of a retransmission or a flush of one or more radio link control service data units associated with the previous TB is based on an indicator value in the DCI message.

In an eighth aspect, alone or in combination with one or more of the first through seventh aspects, the DCI message includes a new data indicator value that is increased, relative to a previous new data indicator value, by more than one increment for an indicated feedback identifier and is associated with a plurality of previous TBs.

In a ninth aspect, alone or in combination with one or more of the first through eighth aspects, the DCI message includes a two-bit new data indicator associated with indicating the new TB.

In a tenth aspect, alone or in combination with one or more of the first through ninth aspects, the DCI message includes a set of bits associated with identifying a set of TBs, with a common identifier, that are triggered for re-transmission.

In an eleventh aspect, alone or in combination with one or more of the first through tenth aspects, the feedback indication applies to one or more indicated code blocks or code block groups of the previous TB, wherein an interpretation of a code block indication field is associated with a value in another field.

In a twelfth aspect, alone or in combination with one or more of the first through eleventh aspects, process 1400 includes transmitting configuration information associated with identifying a feedback mode, and transmitting the DCI message comprises transmitting the DCI message in accordance with the feedback mode.

In a thirteenth aspect, alone or in combination with one or more of the first through twelfth aspects, process 1400 includes receiving a UE capability indicator identifying a capability for a feedback mode, and transmitting the DCI message comprises transmitting the DCI message based on receiving the UE capability indicator.

Although FIG. 14 shows example blocks of process 1400, in some aspects, process 1400 may include additional blocks, fewer blocks, different blocks, or differently arranged blocks than those depicted in FIG. 14. Additionally, or alternatively, two or more of the blocks of process 1400 may be performed in parallel.

FIG. 15 is a diagram illustrating an example process 1500 performed, for example, at a UE or an apparatus of a UE, in accordance with the present disclosure. Example process 1500 is an example where the apparatus or the UE (e.g., UE 120) performs operations associated with ARQ transmission for uplink control messages.

As shown in FIG. 15, in some aspects, process 1500 may include receiving, from a network node, an indication of an unsuccessful HARQ termination associated with a previous uplink TB, wherein the previous uplink TB includes an uplink control message (block 1510). For example, the UE (e.g., using communication manager 150 and/or reception component 1902, depicted in FIG. 19) may receive, from a network node, an indication of an unsuccessful HARQ termination associated with a previous uplink TB, wherein the previous uplink TB includes an uplink control message, as described above, for example, with reference to FIGS. 10A, 10B, 10C, 10D, and/or 10E.

As further shown in FIG. 15, in some aspects, process 1500 may include transmitting, to the network node, one or more uplink communications, wherein the one or more uplink communications include a retransmission of the uplink control message (block 1520). For example, the UE (e.g., using communication manager 150 and/or transmission component 1904, depicted in FIG. 19) may transmit, to the network node, one or more uplink communications, wherein the one or more uplink communications include a retransmission of the uplink control message, as described above, for example, with reference to FIGS. 10A, 10B, 10C, 10D, and/or 10E.

Process 1500 may include additional aspects, such as any single aspect or any combination of aspects described below and/or in connection with one or more other processes described elsewhere herein.

In a first aspect, the one or more uplink communications are associated with a different CC or HARQ ID than a CC or HARQ ID associated with the previous uplink TB.

In a second aspect, alone or in combination with the first aspect, the retransmission of the uplink control message includes a retransmission of a payload associated with the uplink control message.

In a third aspect, alone or in combination with one or more of the first and second aspects, the retransmitted uplink control message includes a regeneration of the uplink control message included in the previous uplink TB.

In a fourth aspect, alone or in combination with one or more of the first through third aspects, the uplink control message is associated with an indication that indicates one or more unsuccessful downlink HARQ termination events associated with one or more previous downlink TBs.

In a fifth aspect, alone or in combination with one or more of the first through fourth aspects, the one or more uplink communications include a new indication associated with at least one unsuccessful downlink HARQ termination event, of the one or more unsuccessful downlink HARQ termination events, that occurred since a transmission of the previous uplink TB.

In a sixth aspect, alone or in combination with one or more of the first through fifth aspects, the new indication has a lower transmission priority than a transmission priority associated with the retransmission of the uplink control message.

In a seventh aspect, alone or in combination with one or more of the first through sixth aspects, the retransmitted uplink control message includes a regeneration of the uplink control message included in the previous uplink TB, and the regenerated uplink control message includes the new indication.

In an eighth aspect, alone or in combination with one or more of the first through seventh aspects, process 1500 includes transmitting a UE capability indicator identifying a capability associated with storing the one or more unsuccessful downlink HARQ termination events associated with the one or more previous downlink TBs.

In a ninth aspect, alone or in combination with one or more of the first through eighth aspects, process 1500 includes ignoring a timer associated with a threshold time period associated with a transmission of a RLC status report, based on a determination that the uplink control message included in the previous uplink TB is associated with the RLC status report.

In a tenth aspect, alone or in combination with one or more of the first through ninth aspects, process 1500 includes transmitting, to the network node, one or more new RLC status reports according to the timer, wherein the one or more new RLC status reports are generated after a transmission of the previous uplink TB.

In an eleventh aspect, alone or in combination with one or more of the first through tenth aspects, process 1500 includes stopping and resetting a timer associated with a threshold time period associated with a transmission of a RLC status report, based on a determination that the uplink control message included in the previous uplink TB is associated with an RLC status report, wherein the regenerated uplink control message includes a positive acknowledgement or a negative acknowledgement indication for each SN, of one or more SNs, associated with an RLC SDU or an RLC SDU segment received since a transmission of the previous uplink TB.

In a twelfth aspect, alone or in combination with one or more of the first through eleventh aspects, process 1500 includes performing a BFR operation based on receiving an indication of successful HARQ termination of the previous uplink TB, wherein the uplink control message included in the previous uplink TB is associated with a BFR MAC-CE.

In a thirteenth aspect, alone or in combination with one or more of the first through twelfth aspects, the one or more uplink communications includes one or more new indications associated with one or more respective beam failure events that occurred since a transmission of the previous uplink TB, based on a determination that the uplink control message included in the previous uplink TB is associated with a BFR MAC-CE, and each new indication of the one or more new indications is transmitted as a separate MAC-CE.

In a fourteenth aspect, alone or in combination with one or more of the first through thirteenth aspects, the uplink control message included in the previous uplink TB is associated with a BFR MAC-CE, wherein the retransmitted uplink control message includes a regeneration of the uplink control message included in the previous uplink TB, including one or more updated fields associated with the BFR MAC-CE based on one or more beam conditions received since a transmission of the previous uplink TB.

In a fifteenth aspect, alone or in combination with one or more of the first through fourteenth aspects, process 1500 includes receiving, from the network node, an RRC message indicating one or more conditions for retransmitting the uplink control message.

In a sixteenth aspect, alone or in combination with one or more of the first through fifteenth aspects, each condition of the one or more conditions is applied based on an uplink control message type associated with the uplink control message.

Although FIG. 15 shows example blocks of process 1500, in some aspects, process 1500 may include additional blocks, fewer blocks, different blocks, or differently arranged blocks than those depicted in FIG. 15. Additionally, or alternatively, two or more of the blocks of process 1500 may be performed in parallel.

FIG. 16 is a diagram illustrating an example process 1600 performed, for example, at a network node or an apparatus of a network node, in accordance with the present disclosure. Example process 1600 is an example where the apparatus or the network node (e.g., network node 110) performs operations associated with ARQ transmission for uplink control messages.

As shown in FIG. 16, in some aspects, process 1600 may include transmitting, to a UE, an indication of an unsuccessful HARQ termination associated with a previous uplink TB, wherein the previous uplink TB includes an uplink control message (block 1610). For example, the network node (e.g., using communication manager 150 and/or transmission component 2004, depicted in FIG. 20) may transmit, to a UE, an indication of an unsuccessful HARQ termination associated with a previous uplink TB, wherein the previous uplink TB includes an uplink control message, as described above, for example, with reference to FIGS. 10A, 10B, 10C, 10D, and/or 10E.

As further shown in FIG. 16, in some aspects, process 1600 may include receiving, from the UE, one or more uplink communications, wherein the one or more uplink communications include a retransmission of the uplink control message (block 1620). For example, the network node (e.g., using communication manager 150 and/or reception component 2002, depicted in FIG. 20) may receive, from the UE, one or more uplink communications, wherein the one or more uplink communications include a retransmission of the uplink control message, as described above, for example, with reference to FIGS. 10A, 10B, 10C, 10D, and/or 10E.

Process 1600 may include additional aspects, such as any single aspect or any combination of aspects described below and/or in connection with one or more other processes described elsewhere herein.

In a first aspect, the one or more uplink communications are associated with a different CC or HARQ ID than a CC or HARQ ID associated with the previous uplink TB.

In a second aspect, alone or in combination with the first aspect, the retransmission of the uplink control message includes a retransmission of a payload associated with the uplink control message.

In a third aspect, alone or in combination with one or more of the first and second aspects, the retransmitted uplink control message includes a regeneration of the uplink control message included in the previous uplink TB.

In a fourth aspect, alone or in combination with one or more of the first through third aspects, the uplink control message is associated with an indication that indicates one or more unsuccessful downlink HARQ termination events associated with one or more previous downlink TBs.

In a fifth aspect, alone or in combination with one or more of the first through fourth aspects, the one or more uplink communications include a new indication associated with at least one unsuccessful downlink HARQ termination event, of the one or more unsuccessful downlink HARQ termination events, that occurred since a transmission of the previous uplink TB.

In a sixth aspect, alone or in combination with one or more of the first through fifth aspects, the retransmitted uplink control message includes a regeneration of the uplink control message included in the previous uplink TB, and the regenerated uplink control message includes the new indication.

In a seventh aspect, alone or in combination with one or more of the first through sixth aspects, process 1600 includes receiving a UE capability indicator identifying a capability associated with storing the one or more unsuccessful downlink HARQ termination events associated with the one or more previous downlink TBs.

In an eighth aspect, alone or in combination with one or more of the first through seventh aspects, the one or more uplink communications includes one or more new indications associated with one or more respective beam failure events that occurred since a transmission of the previous uplink TB, and each new indication of the one or more new indications is transmitted as a separate MAC-CE.

In a ninth aspect, alone or in combination with one or more of the first through eighth aspects, the uplink control message included in the previous uplink TB is associated with a BFR MAC-CE, wherein the retransmitted uplink control message includes a regeneration of the uplink control message included in the previous uplink TB, including one or more updated fields associated with the BFR MAC-CE.

In a tenth aspect, alone or in combination with one or more of the first through ninth aspects, process 1600 includes transmitting, to the UE, an RRC message indicating one or more conditions for retransmitting the uplink control message.

In an eleventh aspect, alone or in combination with one or more of the first through tenth aspects, each condition of the one or more conditions is applied based on an uplink control message type associated with the uplink control message.

Although FIG. 16 shows example blocks of process 1600, in some aspects, process 1600 may include additional blocks, fewer blocks, different blocks, or differently arranged blocks than those depicted in FIG. 16. Additionally, or alternatively, two or more of the blocks of process 1600 may be performed in parallel.

FIG. 17 is a diagram illustrating an example process 1700 performed, for example, at a UE or an apparatus of a UE, in accordance with the present disclosure. Example process 1700 is an example where the apparatus or the UE (e.g., UE 120) performs operations associated with signaling of uplink ARQ.

As shown in FIG. 17, in some aspects, process 1700 may include receiving, via a transceiver from a network node, information that indicates one or more unsuccessful HARQ termination events associated with one or more respective uplink TBs associated with one or more IDs (block 1710). For example, the UE (e.g., using communication manager 150 and/or reception component 1902, depicted in FIG. 19) may receive, via the transceiver from a network node, information that indicates one or more unsuccessful HARQ termination events associated with one or more respective uplink TBs associated with one or more HARQ IDs, as described above, for example, with reference to FIGS. 9A, 9B, and/or 9C.

As further shown in FIG. 17, in some aspects, process 1700 may include transmitting, to the network node, one or more uplink transmissions, wherein the one or more uplink transmissions include a retransmission of at least one of one or more RLC SDUs or one or more RLC SDU segments associated with a respective uplink TB, of the one or more respective uplink TBs, associated with a valid unsuccessful HARQ termination event of the one or more unsuccessful HARQ termination events (block 1720). For example, the UE (e.g., using communication manager 150 and/or transmission component 1904, depicted in FIG. 19) may transmit, to the network node, one or more uplink transmissions, wherein the one or more uplink transmissions include a retransmission of at least one of one or more RLC SDUs or one or more RLC SDU segments associated with a respective uplink TB, of the one or more respective uplink TBs, associated with a valid unsuccessful HARQ termination event of the one or more unsuccessful HARQ termination events, as described above, for example, with reference to FIGS. 9A, 9B, and/or 9C.

Process 1700 may include additional aspects, such as any single aspect or any combination of aspects described below and/or in connection with one or more other processes described elsewhere herein.

In a first aspect, the information is received via a MAC-CE.

In a second aspect, the information is received via an RLC status report that indicates a NACK associated with one or more of the one or more respective uplink TBs.

In a third aspect, the information indicates a CC index, a HARQ ID of the one or more HARQ IDs, an NDI, and a time stamp associated with each unsuccessful HARQ termination event of the one or more unsuccessful HARQ termination events.

In a fourth aspect, the information is a bitmap that includes a bit to represent a HARQ ID associated with one or more uplink TBs, and a value of the bit indicates that the HARQ ID is associated with an unsuccessful HARQ termination event of the one or more unsuccessful HARQ termination events.

In a fifth aspect, the information indicates a CC index associated with the bitmap.

In a sixth aspect, the bitmap is associated with one or more CCs.

In a seventh aspect, the information indicates an NDI and a time stamp associated with each unsuccessful HARQ termination event of the one or more unsuccessful HARQ termination events.

In an eighth aspect, the information indicates a time stamp for each unsuccessful HARQ termination event of the one or more unsuccessful HARQ termination events, and the time stamp indicates one or more time periods associated with one or more scheduled PUSCHs associated with each respective uplink TB of the one or more respective uplink TBs.

In a ninth aspect, the one or more scheduled PUSCHs includes a first scheduled PUSCH or a last scheduled PUSCH.

In a tenth aspect, the one or more scheduled PUSCHs includes a first scheduled PUSCH and a last scheduled PUSCH.

In an eleventh aspect, the one or more time periods include a first scheduled PUSCH and a time period occurring between the first scheduled PUSCH and a last scheduled PUSCH.

In a twelfth aspect, the information includes a time stamp that indicates a time period associated with a PUSCH message that was successfully decoded most recently before a transmission of a respective uplink TB, of the one or more respective uplink TBs, having a HARQ ID that matches a HARQ ID of the PUSCH message.

In a thirteenth aspect, process 1700 includes skipping transmission of the one or more uplink transmissions based on a determination that the UE did not receive an uplink grant scheduling a physical uplink shared channel transmission associated with an NDI and a HARQ ID that match an NDI and a HARQ ID associated with the respective uplink TB of the one or more respective uplink TBs.

In a fourteenth aspect, process 1700 includes skipping transmission of the one or more uplink transmissions based on a determination that the UE previously skipped one or more uplink transmissions associated with an NDI and a HARQ ID that correspond to an NDI and a HARQ ID associated with the respective uplink TB of the one or more respective uplink TBs.

In a fifteenth aspect, process 1700 includes skipping transmission of the one or more uplink transmissions based on a determination that the information indicates that the respective uplink TB of the one or more respective uplink TBs is not associated with an RLC SDU or an RLC SDU segment.

In a sixteenth aspect, process 1700 includes discarding all RLC SDUs and all RLC SDU segments associated with the respective uplink TB of the one or more respective uplink TBs, based on a determination that the UE has not received, during a time period, an indication of one or more unsuccessful HARQ termination events associated with the respective uplink TB of the one or more respective uplink TBs, wherein the time period is measured from an immediately preceding transmission of the respective uplink TB.

In a seventeenth aspect, the time period is configured for one or more of a cell group, a CC, a set of HARQ IDs, or a HARQ ID.

Although FIG. 17 shows example blocks of process 1700, in some aspects, process 1700 may include additional blocks, fewer blocks, different blocks, or differently arranged blocks than those depicted in FIG. 17. Additionally, or alternatively, two or more of the blocks of process 1700 may be performed in parallel.

FIG. 18 is a diagram illustrating an example process 1800 performed, for example, at a network node or an apparatus of a network node, in accordance with the present disclosure. Example process 1800 is an example where the apparatus or the network node (e.g., network node 110) performs operations associated with signaling of uplink ARQ.

As shown in FIG. 18, in some aspects, process 1800 may include transmitting, via a transceiver to a UE, information that indicates one or more unsuccessful HARQ termination events associated with one or more respective uplink TBs associated with one or more HARQ IDs (block 1810). For example, the network node (e.g., using communication manager 150 and/or transmission component 2004, depicted in FIG. 20) may transmit, via the transceiver to a UE, information that indicates one or more unsuccessful HARQ termination events associated with one or more respective uplink TBs associated with one or more HARQ IDs, as described above, for example, with reference to FIGS. 9A, 9B, and/or 9C.

As further shown in FIG. 18, in some aspects, process 1800 may include receiving, via the transceiver from the UE, one or more uplink transmissions, wherein the one or more uplink transmissions include a retransmission of at least one of one or more RLC SDUs or one or more RLC SDU segments associated with a respective uplink TB, of the one or more respective uplink TBs, associated with a valid unsuccessful HARQ termination event of the one or more unsuccessful HARQ termination events (block 1820). For example, the network node (e.g., using communication manager 150 and/or reception component 2002, depicted in FIG. 20) may receive, via the transceiver from the UE, one or more uplink transmissions, wherein the one or more uplink transmissions include a retransmission of at least one of one or more RLC SDUs or one or more RLC SDU segments associated with a respective uplink TB, of the one or more respective uplink TBs, associated with a valid unsuccessful HARQ termination event of the one or more unsuccessful HARQ termination events, as described above, for example, with reference to FIGS. 9A, 9B, and/or 9C.

Process 1800 may include additional aspects, such as any single aspect or any combination of aspects described below and/or in connection with one or more other processes described elsewhere herein.

In a first aspect, the information is transmitted via a MAC-CE.

In a second aspect, the information is transmitted via an RLC status report that indicates a NACK associated with one or more of the one or more respective uplink TBs.

In a third aspect, the information indicates a CC index, a HARQ ID of the one or more HARQ IDs, an NDI, and a time stamp associated with each unsuccessful HARQ termination event of the one or more unsuccessful HARQ termination events.

In a fourth aspect, the information is a bitmap that includes a bit to represent a HARQ ID associated with one or more uplink TBs, and a value of the bit indicates that the HARQ ID is associated with an unsuccessful HARQ termination event of the one or more unsuccessful HARQ termination events.

In a fifth aspect, the information indicates a CC index associated with the bitmap.

In a sixth aspect, the bitmap is associated with one or more CCs.

In a seventh aspect, the information indicates an NDI and a time stamp associated with each unsuccessful HARQ termination event of the one or more unsuccessful HARQ termination events.

In an eighth aspect, the information indicates a time stamp for each unsuccessful HARQ termination event of the one or more unsuccessful HARQ termination events, and the time stamp indicates one or more time periods associated with one or more scheduled PUSCHs associated with each respective uplink TB of the one or more respective uplink TBs.

In a ninth aspect, the one or more scheduled PUSCHs includes a first scheduled PUSCH or a last scheduled PUSCH.

In a tenth aspect, the one or more scheduled PUSCHs includes a first scheduled PUSCH and a last scheduled PUSCH.

In an eleventh aspect, the one or more time periods include a first scheduled PUSCH and a time period occurring between the first scheduled PUSCH and a last scheduled PUSCH.

In a twelfth aspect, the information includes a time stamp that indicates a time period associated with a PUSCH message that was successfully decoded most recently before a transmission of a respective uplink TB, of the one or more respective uplink TBs, having a HARQ ID that matches a HARQ ID of the PUSCH message.

In a thirteenth aspect, process 1800 includes transmitting, to the UE, a configuration defining a time period associated with the UE retaining one or more RLC SDUs or one or more RLC SDU segments associated with the respective uplink TB of the one or more respective uplink TBs.

In a fourteenth aspect, the time period is configured for one or more of a cell group, a CC, a set of HARQ IDs, or a HARQ ID.

Although FIG. 18 shows example blocks of process 1800, in some aspects, process 1800 may include additional blocks, fewer blocks, different blocks, or differently arranged blocks than those depicted in FIG. 18. Additionally, or alternatively, two or more of the blocks of process 1800 may be performed in parallel.

FIG. 19 is a diagram of an example apparatus 1900 for wireless communication, in accordance with the present disclosure. The apparatus 1900 may be a UE, or a UE may include the apparatus 1900. In some aspects, the apparatus 1900 includes a reception component 1902, a transmission component 1904, and/or a communication manager 1906, which may be in communication with one another (for example, via one or more buses and/or one or more other components). In some aspects, the communication manager 1906 is the communication manager 150 described in connection with FIG. 1. As shown, the apparatus 1900 may communicate with another apparatus 1908, such as a UE or a network node (such as a CU, a DU, an RU, or a base station), using the reception component 1902 and the transmission component 1904. The communication manager 1906 may be included in, or implemented via, a processing system (for example, the processing system 140 described in connection with FIG. 1) of the UE.

In some aspects, the apparatus 1900 may be configured to perform one or more operations described herein in connection with FIGS. 7A-7J, 8A-8F, 9A-9C, and/or 10A-10E. Additionally, or alternatively, the apparatus 1900 may be configured to perform one or more processes described herein, such as process 1100 of FIG. 11, process 1300 of FIG. 13, process 1500 of FIG. 15, process 1700 of FIG. 17, process 2100 of FIG. 21, or a combination thereof. In some aspects, the apparatus 1900 and/or one or more components shown in FIG. 19 may include one or more components of the UE described in connection with FIG. 1. Additionally, or alternatively, one or more components shown in FIG. 19 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1902 may receive communications, such as reference signals, control information, data communications, or a combination thereof, from the apparatus 1908. The reception component 1902 may provide received communications to one or more other components of the apparatus 1900. In some aspects, the reception component 1902 may perform signal processing on the received communications, and may provide the processed signals to the one or more other components of the apparatus 1900. In some aspects, the reception component 1902 may include one or more components of the UE described above in connection with FIG. 1, such as a radio, one or more RF chains, one or more transceivers, or one or more modems, each of which may in turn be coupled with one or more antennas of the UE.

The transmission component 1904 may transmit communications, such as reference signals, control information, data communications, or a combination thereof, to the apparatus 1908. In some aspects, one or more other components of the apparatus 1900 may generate communications and may provide the generated communications to the transmission component 1904 for transmission to the apparatus 1908. In some aspects, the transmission component 1904 may perform signal processing on the generated communications, and may transmit the processed signals to the apparatus 1908. In some aspects, the transmission component 1904 may include one or more components of the UE described above in connection with FIG. 1, such as a radio, one or more RF chains, one or more transceivers, or one or more modems, each of which may in turn be coupled with one or more antennas of the UE described in connection with FIG. 1. In some aspects, the transmission component 1904 may be co-located with the reception component 1902.

The communication manager 1906 may support operations of the reception component 1902 and/or the transmission component 1904. For example, the communication manager 1906 may receive information associated with configuring reception of communications by the reception component 1902 and/or transmission of communications by the transmission component 1904. Additionally, or alternatively, the communication manager 1906 may generate and/or provide control information to the reception component 1902 and/or the transmission component 1904 to control reception and/or transmission of communications.

The reception component 1902 may receive a first message identifying a resource allocation for a CG-PUSCH communication. The transmission component 1904 may transmit, using the resource allocation, the CG-PUSCH communication. The reception component 1902 may receive DCI scheduling a re-transmission of the CG-PUSCH communication, wherein the DCI includes a feedback message associated with one or more prior TBs. The communication manager 1906 may start, based on transmitting the one or more prior TBs, a feedback timer. The communication manager 1906 may stop, based on receiving the DCI, the feedback timer, wherein an expiration of the feedback timer is associated with a default behavior for automatic repeat request re-transmission, wherein a duration of the feedback timer is based on a received indication or a function of one or more parameters relating to the CG-PUSCH communication.

The reception component 1902 may receive a DCI message associated with scheduling a new TB on a physical uplink shared channel, wherein the DCI message includes a feedback indication of a previous TB. The transmission component 1904 may transmit one or more uplink communications, wherein whether the one or more uplink communications includes a retransmission of information associated with the previous TB is based on the feedback indication. The reception component 1902 may receive another DCI message with an untoggled new data indicator value scheduling a retransmission of a new TB, where the other DCI message includes a same feedback indication for the previous TB as the feedback indication included in the DCI message. The reception component 1902 may receive configuration information associated with identifying a feedback mode. The transmission component 1904 may transmit a UE capability indicator identifying a capability for a feedback mode.

The reception component 1902 may receive a non-scheduling DCI message, wherein the DCI message includes an ARQ feedback indication of a previous TB scheduled in a PUSCH and scheduled by a previous DCI, wherein the non-scheduling DCI includes a configuration associated with validation of the non-scheduling DCI. The transmission component 1904 may transmit one or more uplink communications to re-transmit information associated with the previous TB based on the feedback indication.

The reception component 1902 may receive, from a network node, an indication of an unsuccessful HARQ termination associated with a previous uplink TB, wherein the previous uplink TB includes an uplink control message. The transmission component 1904 may transmit, to the network node, one or more uplink communications, wherein the one or more uplink communications include a retransmission of the uplink control message.

The transmission component 1904 may transmit a UE capability indicator identifying a capability associated with storing the one or more unsuccessful downlink HARQ termination events associated with the one or more previous downlink TBs.

The communication manager 1906 may ignore a timer associated with a threshold time period associated with a transmission of an RLC status report, based on a determination that the uplink control message included in the previous uplink TB is associated with the RLC status report.

The transmission component 1904 may transmit, to the network node, one or more new RLC status reports according to the timer, wherein the one or more new RLC status reports are generated after a transmission of the previous uplink TB.

The communication manager 1906 may stop and reset a timer associated with a threshold time period associated with a transmission of an RLC status report, based on a determination that the uplink control message included in the previous uplink TB is associated with an RLC status report, wherein the regenerated uplink control message includes a positive acknowledgement or a negative acknowledgement indication for each SN, of one or more SNs, associated with an RLC SDU or an RLC SDU segment received since a transmission of the previous uplink TB.

The communication manager 1906 may perform a BFR operation based on receiving an indication of successful HARQ termination of the previous uplink TB, wherein the uplink control message included in the previous uplink TB is associated with a BFR MAC-CE.

The reception component 1902 may receive, from the network node, an RRC message indicating one or more conditions for retransmitting the uplink control message.

The reception component 1902 may receive, via a transceiver from a network node, information that indicates one or more unsuccessful HARQ termination events associated with one or more respective uplink TBs associated with one or more HARQ IDs. The transmission component 1904 may transmit, via the transceiver to the network node, one or more uplink transmissions, wherein the one or more uplink transmissions include a retransmission of at least one of one or more RLC SDUs or one or more RLC SDU segments associated with a respective uplink TB, of the one or more respective uplink TBs, associated with a valid unsuccessful HARQ termination event of the one or more unsuccessful HARQ termination events.

The communication manager 1906 may skip transmission of one or more uplink transmissions associated with an invalid unsuccessful HARQ termination event, of the one or more unsuccessful HARQ termination events, based on a determination that the UE did not receive an uplink grant scheduling a PUSCH transmission associated with an NDI and a HARQ ID that match an NDI and a HARQ ID associated with the respective uplink TB of the one or more respective uplink TBs.

The communication manager 1906 may skip transmission of one or more uplink transmissions associated with an invalid unsuccessful HARQ termination event, of the one or more unsuccessful HARQ termination events, based on a determination that the UE previously skipped one or more uplink transmissions associated with an NDI and a HARQ ID that correspond to an NDI and a HARQ ID associated with the respective uplink TB of the one or more respective uplink TBs.

The communication manager 1906 may skip transmission of one or more uplink transmissions associated with an invalid unsuccessful HARQ termination event, of the one or more unsuccessful HARQ termination events, based on a determination that the information indicates that the respective uplink TB of the one or more respective uplink TBs is not associated with an RLC SDU or an RLC SDU segment.

The communication manager 1906 may discard all RLC SDUs and all RLC SDU segments associated with the respective uplink TB of the one or more respective uplink TBs, based on a determination that the UE has not received, during a time period, an indication of one or more unsuccessful HARQ termination events associated with the respective uplink TB of the one or more respective uplink TBs, wherein the time period is measured from an immediately preceding transmission of the respective uplink TB.

The number and arrangement of components shown in FIG. 19 are provided as an example. In practice, there may be additional components, fewer components, different components, or differently arranged components than those shown in FIG. 19. Furthermore, two or more components shown in FIG. 19 may be implemented within a single component, or a single component shown in FIG. 19 may be implemented as multiple, distributed components. Additionally, or alternatively, a set of (one or more) components shown in FIG. 19 may perform one or more functions described as being performed by another set of components shown in FIG. 19.

FIG. 20 is a diagram of an example apparatus 2000 for wireless communication, in accordance with the present disclosure. The apparatus 2000 may be a network node, or a network node may include the apparatus 2000. In some aspects, the apparatus 2000 includes a reception component 2002, a transmission component 2004, and/or a communication manager 2006, which may be in communication with one another (for example, via one or more buses and/or one or more other components). In some aspects, the communication manager 2006 is the communication manager 155 described in connection with FIG. 1. As shown, the apparatus 2000 may communicate with another apparatus 2008, such as a UE or a network node (such as a CU, a DU, an RU, or a base station), using the reception component 2002 and the transmission component 2004. The communication manager 2006 may be included in, or implemented via, a processing system (for example, the processing system 145 described in connection with FIG. 1) of the network node.

In some aspects, the apparatus 2000 may be configured to perform one or more operations described herein in connection with FIGS. 7A-7J, 8A-8F, 9A-9C, and/or 10A-10E. Additionally, or alternatively, the apparatus 2000 may be configured to perform one or more processes described herein, such as process 1200 of FIG. 12, process 1400 of FIG. 14, process 1600 of FIG. 16, process 1800 of FIG. 18, process 2200 of FIG. 20, or a combination thereof. In some aspects, the apparatus 2000 and/or one or more components shown in FIG. 20 may include one or more components of the network node described in connection with FIG. 1. Additionally, or alternatively, one or more components shown in FIG. 20 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 2002 may receive communications, such as reference signals, control information, data communications, or a combination thereof, from the apparatus 2008. The reception component 2002 may provide received communications to one or more other components of the apparatus 2000. In some aspects, the reception component 2002 may perform signal processing on the received communications, and may provide the processed signals to the one or more other components of the apparatus 2000. In some aspects, the reception component 2002 may include one or more components of the network node described above in connection with FIG. 1, such as a radio, one or more RF chains, one or more transceivers, or one or more modems, each of which may in turn be coupled with one or more antennas of the network node. In some aspects, the reception component 2002 and/or the transmission component 2004 may include or may be included in a network interface. The network interface may be configured to obtain and/or output signals for the apparatus 2000 via one or more communications links, such as a backhaul link, a midhaul link, and/or a fronthaul link.

The transmission component 2004 may transmit communications, such as reference signals, control information, data communications, or a combination thereof, to the apparatus 2008. In some aspects, one or more other components of the apparatus 2000 may generate communications and may provide the generated communications to the transmission component 2004 for transmission to the apparatus 2008. In some aspects, the transmission component 2004 may perform signal processing on the generated communications, and may transmit the processed signals to the apparatus 2008. In some aspects, the transmission component 2004 may include one or more components of the network node described above in connection with FIG. 1, such as a radio, one or more RF chains, one or more transceivers, or one or more modems, each of which may in turn be coupled with one or more antennas of the network node described in connection with FIG. 1. In some aspects, the transmission component 2004 may be co-located with the reception component 2002.

The communication manager 2006 may support operations of the reception component 2002 and/or the transmission component 2004. For example, the communication manager 2006 may receive information associated with configuring reception of communications by the reception component 2002 and/or transmission of communications by the transmission component 2004. Additionally, or alternatively, the communication manager 2006 may generate and/or provide control information to the reception component 2002 and/or the transmission component 2004 to control reception and/or transmission of communications.

The transmission component 2004 may transmit a first message identifying a resource allocation for a CG-PUSCH communication. The transmission component 2004 may transmit DCI scheduling a re-transmission of the CG-PUSCH communication, wherein the DCI includes a feedback message associated with one or more prior TBs.

The transmission component 2004 may transmit a DCI message associated with scheduling a new TB on a PUSCH, wherein the DCI message includes a feedback indication of a previous TB. The reception component 2002 may receive one or more uplink communications, wherein whether the one or more uplink communications includes a retransmission of information associated with the previous TB is based on the feedback indication. The transmission component 2004 may transmit another DCI message with an untoggled new data indicator value scheduling a retransmission of a new TB, where the other DCI message includes a same feedback indication for the previous TB as the feedback indication included in the DCI message. The transmission component 2004 may transmit configuration information associated with identifying a feedback mode. The reception component 2002 may receive a UE capability indicator identifying a capability for a feedback mode.

The transmission component 2004 may transmit a non-scheduling DCI message, wherein the DCI message includes an ARQ feedback indication of a previous TB scheduled in a PUSCH and scheduled by a previous DCI, wherein the non-scheduling DCI includes a configuration associated with validation of the non-scheduling DCI. The reception component 2002 may receive one or more uplink communications to re-transmit information associated with the previous TB based on the feedback indication.

The transmission component 2004 may transmit, to a UE, an indication of an unsuccessful HARQ termination associated with a previous uplink TB, wherein the previous uplink TB includes an uplink control message. The reception component 2002 may receive, from the UE, one or more uplink communications, wherein the one or more uplink communications include a retransmission of the uplink control message.

The reception component 2002 may receive a UE capability indicator identifying a capability associated with storing the one or more unsuccessful downlink HARQ termination events associated with the one or more previous downlink TBs.

The transmission component 2004 may transmit, to the UE, an RRC message indicating one or more conditions for retransmitting the uplink control message.

The transmission component 2004 may transmit, via a transceiver to a UE, information that indicates one or more unsuccessful HARQ termination events associated with one or more respective uplink TBs associated with one or more HARQ IDs. The reception component 2002 may receive, via the transceiver from the UE, one or more uplink transmissions, wherein the one or more uplink transmissions include a retransmission of at least one of one or more RLC SDUs or one or more RLC SDU segments associated with a respective uplink TB, of the one or more respective uplink TBs, associated with a valid unsuccessful HARQ termination event of the one or more unsuccessful HARQ termination events.

The transmission component 2004 may transmit, to the UE, a configuration defining a time period associated with the UE retaining one or more RLC SDUs or one or more RLC SDU segments associated with the respective uplink TB of the one or more respective uplink TBs.

The number and arrangement of components shown in FIG. 20 are provided as an example. In practice, there may be additional components, fewer components, different components, or differently arranged components than those shown in FIG. 20. Furthermore, two or more components shown in FIG. 20 may be implemented within a single component, or a single component shown in FIG. 20 may be implemented as multiple, distributed components. Additionally, or alternatively, a set of (one or more) components shown in FIG. 20 may perform one or more functions described as being performed by another set of components shown in FIG. 20.

FIG. 21 is a diagram illustrating an example process 2100 performed, for example, at a UE or an apparatus of a UE, in accordance with the present disclosure. Example process 2100 is an example where the apparatus or the UE (e.g., UE 120) performs operations associated with indication of unsuccessful HARQ termination for uplink communication.

As shown in FIG. 21, in some aspects, process 2100 may include receiving a non-scheduling DCI message, wherein the non-scheduling DCI message includes an ARQ feedback indication of a previous TB scheduled in a PUSCH and scheduled by a previous DCI message, wherein the non-scheduling DCI message includes a configuration associated with validation of the non-scheduling DCI message (block 2110). For example, the UE (e.g., using communication manager 150 and/or reception component 1902, depicted in FIG. 19) may receive a non-scheduling DCI message, wherein the non-scheduling DCI message includes an ARQ feedback indication of a previous TB scheduled in a PUSCH and scheduled by a previous DCI message, wherein the non-scheduling DCI message includes a configuration associated with validation of the non-scheduling DCI message, as described above, for example, with reference to FIGS. 7A-7J.

As further shown in FIG. 21, in some aspects, process 2100 may include transmitting one or more uplink communications to re-transmit information associated with the previous TB based on the feedback indication (block 2120). For example, the UE (e.g., using communication manager 150 and/or transmission component 1904, depicted in FIG. 19) may transmit one or more uplink communications to re-transmit information associated with the previous TB based on the feedback indication, as described above, for example, with reference to FIGS. 7A-7J.

Process 2100 may include additional aspects, such as any single aspect or any combination of aspects described below and/or in connection with one or more other processes described elsewhere herein.

In a first aspect, the feedback indication is a negative acknowledgment message.

In a second aspect, alone or in combination with the first aspect, the non-scheduling DCI message includes the feedback indication for a plurality of TBs associated with a plurality of different process identifiers.

In a third aspect, alone or in combination with one or more of the first and second aspects, the feedback indication includes a bitmap with a set of bits that maps to the plurality of TBs.

In a fourth aspect, alone or in combination with one or more of the first through third aspects, the configuration includes at least one of a configuration of a field of the non-scheduling DCI message, a configuration of a radio network temporary identifier associated with the non-scheduling DCI message, or a configuration of a format of the non-scheduling DCI message.

Although FIG. 21 shows example blocks of process 2100, in some aspects, process 2100 may include additional blocks, fewer blocks, different blocks, or differently arranged blocks than those depicted in FIG. 21. Additionally, or alternatively, two or more of the blocks of process 2100 may be performed in parallel.

FIG. 22 is a diagram illustrating an example process 2200 performed, for example, at a network node or an apparatus of a network node, in accordance with the present disclosure. Example process 2200 is an example where the apparatus or the network node (e.g., network node 110) performs operations associated with indication of unsuccessful HARQ termination for uplink communication.

As shown in FIG. 22, in some aspects, process 2200 may include transmitting a non-scheduling DCI message, wherein the non-scheduling DCI message includes an ARQ feedback indication of a TB scheduled in a PUSCH and scheduled by a previous DCI message, wherein the non-scheduling DCI message includes a configuration associated with validation of the non-scheduling DCI message (block 2210). For example, the network node (e.g., using communication manager 150 and/or transmission component 2004, depicted in FIG. 20) may transmit a non-scheduling DCI message, wherein the DCI message includes an ARQ feedback indication of a previous TB scheduled in a PUSCH and scheduled by a previous DCI message, wherein the non-scheduling DCI message includes a configuration associated with validation of the non-scheduling DCI message, as described above, for example, with reference to FIGS. 7A-7J.

As further shown in FIG. 22, in some aspects, process 2200 may include receiving one or more uplink communications to re-transmit information associated with the previous TB based on the feedback indication (block 2220). For example, the network node (e.g., using communication manager 150 and/or reception component 2002, depicted in FIG. 20) may receive one or more uplink communications to re-transmit information associated with the previous TB based on the feedback indication, as described above, for example, with reference to FIGS. 7A-7J.

Process 2200 may include additional aspects, such as any single aspect or any combination of aspects described below and/or in connection with one or more other processes described elsewhere herein.

In a first aspect, the feedback indication is a negative acknowledgment message.

In a second aspect, alone or in combination with the first aspect, the DCI message includes the feedback indication for a plurality of TBs associated with a plurality of different process identifiers.

In a third aspect, alone or in combination with one or more of the first and second aspects, the feedback indication includes a bitmap with a set of bits that maps to the plurality of TBs.

In a fourth aspect, alone or in combination with one or more of the first through third aspects, the configuration includes at least one of a configuration of a field of the non-scheduling DCI message, a configuration of a radio network temporary identifier associated with the non-scheduling DCI message, or a configuration of a format of the non-scheduling DCI message.

Although FIG. 22 shows example blocks of process 2200, in some aspects, process 2200 may include additional blocks, fewer blocks, different blocks, or differently arranged blocks than those depicted in FIG. 22. Additionally, or alternatively, two or more of the blocks of process 2200 may be performed in parallel.

The following provides an overview of some Aspects of the present disclosure:
Aspect 1: A method of wireless communication performed by a user equipment (UE), comprising: receiving, via a transceiver, a first message identifying a resource allocation for a configured grant (CG) physical uplink shared channel (PUSCH) (CG-PUSCH) communication; transmitting, via the transceiver and using the resource allocation, the CG-PUSCH communication; and receiving, via the transceiver, downlink control information (DCI) scheduling a re-transmission of the CG-PUSCH communication, wherein the DCI includes a feedback message associated with one or more prior transport blocks.
Aspect 2: The method of Aspect 1, wherein the feedback message includes a negative acknowledgment for the one or more prior transport blocks, and further comprising: transmitting a re-transmission of another communication associated with the one or more prior transport blocks.
Aspect 3: The method of any of Aspects 1-2, wherein the feedback message indicates an acknowledgement for the one or more prior transport blocks, and further comprising: deleting one or more data units associated with a transmit buffer for the one or more prior transport blocks.
Aspect 4: The method of any of Aspects 1-3, wherein the DCI includes an indication of a quantity of prior transport blocks to which the feedback message applies.
Aspect 5: The method of any of Aspects 1-4, wherein the feedback message includes at least one of: a bitmap of bits corresponding to the one or more prior transport blocks, a bit indicator identifying a collective feedback state for an entirety of the one or more prior transport blocks, a plurality of sets of bits corresponding to a plurality of subsets of the one or more prior transport blocks, or an indicator of a quantity of the one or more prior transport blocks to which a feedback state applies.
Aspect 6: The method of any of Aspects 1-5, further comprising: starting, based on transmitting the one or more prior transport blocks, a feedback timer; and stopping, based on receiving the DCI, the feedback timer, wherein an expiration of the feedback timer is associated with a default behavior for automatic repeat request re-transmission, wherein a duration of the feedback timer is based on a received indication or a function of one or more parameters relating to the CG-PUSCH communication.
Aspect 7: The method of any of Aspects 1-6, wherein the DCI is a scheduling DCI associated with scheduling a CG re-transmission.
Aspect 8: The method of any of Aspects 1-7, wherein the DCI is a non-scheduling DCI, and wherein a configuration of the DCI is associated with the CG-PUSCH communication, wherein the configuration includes a scrambling of a cyclic redundancy check.
Aspect 9: The method of any of Aspects 1-8, wherein the DCI is a non-scheduling DCI, and wherein the non-scheduling DCI and the one or more prior transport blocks are associated with a common feedback message identifier.
Aspect 10: The method of any of Aspects 1-9, wherein the DCI is a non-scheduling DCI, and wherein the non-scheduling DCI includes an indication of at least one of: a CG configuration associated with the one or more prior transport blocks, or a carrier associated with the one or more prior transport blocks.
Aspect 11: The method of any of Aspects 1-10, wherein the DCI is for a dynamic grant (DG) PUSCH communication and is associated with a cyclic redundancy check scrambled with a configured-scheduling radio network temporary identifier.
Aspect 12: The method of any of Aspects 1-11, wherein the one or more prior transport blocks are associated with a configured-scheduling radio network temporary identifier associated with one or more prior CG-PUSCH communications.
Aspect 13: The method of any of Aspects 1-12, wherein the one or more prior transport blocks are associated with a latest of a cell radio network temporary identifier or a configured-scheduling radio network temporary identifier.
Aspect 14: The method of any of Aspects 1-13, wherein the received DCI schedules the re-transmission of the CG-PUSCH in a target transport block, wherein the one or more prior transport blocks and the target transport block are associated with a common hybrid automatic repeat request identifier.
Aspect 15: The method of any of Aspects 1-14, wherein the one or more prior transport blocks are associated with a configured-scheduling radio network temporary identifier.
Aspect 16: A method of wireless communication performed by a network node, comprising: transmitting, via a transceiver, a first message identifying a resource allocation for a configured grant (CG) physical uplink shared channel (PUSCH) (CG-PUSCH) communication; and transmitting, via a transceiver, downlink control information (DCI) scheduling a re-transmission of the CG-PUSCH communication, wherein the DCI includes a feedback message associated with one or more prior transport blocks.
Aspect 17: The method of Aspect 16, wherein the feedback message includes a negative acknowledgment for the one or more prior transport blocks, and further comprising: receiving a re-transmission of another communication associated with the one or more prior transport blocks.
Aspect 18: The method of any of Aspects 16-17, wherein the DCI includes an indication of a quantity of prior transport blocks to which the feedback message applies.
Aspect 19: The method of any of Aspects 16-18, wherein the feedback message includes at least one of: a bitmap of bits corresponding to the one or more prior transport blocks, a bit indicator identifying a collective feedback state for an entirety of the one or more prior transport blocks, a plurality of sets of bits corresponding to a plurality of subsets of the one or more prior transport blocks, or an indicator of a quantity of the one or more prior transport blocks to which a feedback state applies.
Aspect 20: The method of any of Aspects 16-19, wherein the DCI is a scheduling DCI associated with scheduling a CG re-transmission.
Aspect 21: The method of any of Aspects 16-20, wherein the DCI is a non-scheduling DCI, and wherein a configuration of the DCI is associated with the CG-PUSCH communication, wherein the configuration includes a scrambling of a cyclic redundancy check.
Aspect 22: The method of any of Aspects 16-21, wherein the DCI is a non-scheduling DCI, and wherein the non-scheduling DCI and the one or more prior transport blocks are associated with a common feedback message identifier.
Aspect 23: The method of any of Aspects 16-22, wherein the DCI is a non-scheduling DCI, and wherein the non-scheduling DCI includes an indication of at least one of: a CG configuration associated with the one or more prior transport blocks, or a carrier associated with the one or more prior transport blocks.
Aspect 24: The method of any of Aspects 16-23, wherein the DCI is for a dynamic grant (DG) PUSCH communication and is associated with a cyclic redundancy check scrambled with a configured-scheduling radio network temporary identifier.
Aspect 25: The method of any of Aspects 16-24, wherein the one or more prior transport blocks are associated with a configured-scheduling radio network temporary identifier associated with one or more prior CG-PUSCH communications.
Aspect 26: The method of any of Aspects 16-25, wherein the one or more prior transport blocks are associated with a latest of a cell radio network temporary identifier or a configured-scheduling radio network temporary identifier.
Aspect 27: The method of any of Aspects 16-26, wherein the received DCI schedules the re-transmission of the CG-PUSCH in a target transport block, wherein the one or more prior transport blocks and the target transport block are associated with a common hybrid automatic repeat request identifier.
Aspect 28: The method of any of Aspects 16-27, wherein the one or more prior transport blocks are associated with a configured-scheduling radio network temporary identifier.
Aspect 29: A method of wireless communication performed by a user equipment (UE), comprising: receiving, from a network node, an indication of an unsuccessful hybrid automatic repeat request (HARQ) termination associated with a previous uplink transport block (TB), wherein the previous uplink TB includes an uplink control message; and transmitting, to the network node, one or more uplink communications, wherein the one or more uplink communications include a retransmission of the uplink control message.
Aspect 30: The method of Aspect 29, wherein the one or more uplink communications are associated with a different component carrier (CC) or HARQ identifier (ID) than a CC or HARQ ID associated with the previous uplink TB.
Aspect 31: The method of any of Aspects 29-30, wherein the retransmission of the uplink control message includes a retransmission of a payload associated with the uplink control message.
Aspect 32: The method of any of Aspects 29-31, wherein the retransmitted uplink control message includes a regeneration of the uplink control message included in the previous uplink TB.
Aspect 33: The method of any of Aspects 29-32, wherein the uplink control message is associated with an indication that indicates one or more unsuccessful downlink HARQ termination events associated with one or more previous downlink TBs.
Aspect 34: The method of Aspect 33, wherein the one or more uplink communications include a new indication associated with at least one unsuccessful downlink HARQ termination event, of the one or more unsuccessful downlink HARQ termination events, that occurred since a transmission of the previous uplink TB.
Aspect 35: The method of Aspect 34, wherein the new indication has a lower transmission priority than a transmission priority associated with the retransmission of the uplink control message.
Aspect 36: The method of Aspect 34, wherein the retransmitted uplink control message includes a regeneration of the uplink control message included in the previous uplink TB, and wherein the regenerated uplink control message includes the new indication.
Aspect 37: The method of Aspect 34, further comprising: transmitting a UE capability indicator identifying a capability associated with storing the one or more unsuccessful downlink HARQ termination events associated with the one or more previous downlink TBs.
Aspect 38: The method of any of Aspects 29-37, further comprising: ignoring a timer associated with a threshold time period associated with a transmission of a radio link control (RLC) status report, based on a determination that the uplink control message included in the previous uplink TB is associated with the RLC status report.
Aspect 39: The method of Aspect 38, further comprising: transmitting, to the network node, one or more new RLC status reports according to the timer, wherein the one or more new RLC status reports are generated after a transmission of the previous uplink TB.
Aspect 40: The method of any of Aspects 29-39, further comprising: stopping and resetting a timer associated with a threshold time period associated with a transmission of a radio link control (RLC) status report, based on a determination that the uplink control message included in the previous uplink TB is associated with an RLC status report, wherein the regenerated uplink control message includes a positive acknowledgement or a negative acknowledgement indication for each sequence number (SN), of one or more SNs, associated with an RLC SDU or an RLC SDU segment received since a transmission of the previous uplink TB.
Aspect 41: The method of Aspect 1, further comprising: performing a beam failure recovery (BFR) operation based on receiving an indication of successful HARQ termination of the previous uplink TB, wherein the uplink control message included in the previous uplink TB is associated with a BFR medium access control control element (MAC-CE).
Aspect 42: The method of any of Aspects 29-41, wherein the one or more uplink communications includes one or more new indications associated with one or more respective beam failure events that occurred since a transmission of the previous uplink TB, based on a determination that the uplink control message included in the previous uplink TB is associated with a beam failure recovery medium access control control element (MAC-CE), and wherein each new indication of the one or more new indications is transmitted as a separate MAC-CE.
Aspect 43: The method of any of Aspects 29-42, wherein the uplink control message included in the previous uplink TB is associated with a beam failure recovery (BFR) medium access control control element (MAC-CE), wherein the retransmitted uplink control message includes a regeneration of the uplink control message included in the previous uplink TB, including one or more updated fields associated with the BFR MAC-CE based on one or more beam conditions received since a transmission of the previous uplink TB.
Aspect 44: The method of any of Aspects 29-43, further comprising: receiving, from the network node, a radio resource control message indicating one or more conditions for retransmitting the uplink control message.
Aspect 45: The method of Aspect 44, wherein each condition of the one or more conditions is applied based on an uplink control message type associated with the uplink control message.
Aspect 46: A method of wireless communication performed by a network node, comprising: transmitting, to a user equipment (UE), an indication of an unsuccessful hybrid automatic repeat request (HARQ) termination associated with a previous uplink transport block (TB), wherein the previous uplink TB includes an uplink control message; and receiving, from the UE, one or more uplink communications, wherein the one or more uplink communications include a retransmission of the uplink control message.
Aspect 47: The method of Aspect 46, wherein the one or more uplink communications are associated with a different component carrier (CC) or HARQ identifier (ID) than a CC or HARQ ID associated with the previous uplink TB.
Aspect 48: The method of any of Aspects 46-47, wherein the retransmission of the uplink control message includes a retransmission of a payload associated with the uplink control message.
Aspect 49: The method of any of Aspects 46-48, wherein the retransmitted uplink control message includes a regeneration of the uplink control message included in the previous uplink TB.
Aspect 50: The method of any of Aspects 46-49, wherein the uplink control message is associated with an indication that indicates one or more unsuccessful downlink HARQ termination events associated with one or more previous downlink TBs.
Aspect 51: The method of Aspect 50, wherein the one or more uplink communications include a new indication associated with at least one unsuccessful downlink HARQ termination event, of the one or more unsuccessful downlink HARQ termination events, that occurred since a transmission of the previous uplink TB.
Aspect 52: The method of Aspect 51, wherein the retransmitted uplink control message includes a regeneration of the uplink control message included in the previous uplink TB, and wherein the regenerated uplink control message includes the new indication.
Aspect 53: The method of Aspect 51, further comprising: receiving a UE capability indicator identifying a capability associated with storing the one or more unsuccessful downlink HARQ termination events associated with the one or more previous downlink TBs.
Aspect 54: The method of any of Aspects 46-53, wherein the one or more uplink communications includes one or more new indications associated with one or more respective beam failure events that occurred since a transmission of the previous uplink TB, and wherein each new indication of the one or more new indications is transmitted as a separate medium access control control element (MAC-CE).
Aspect 55: The method of any of Aspects 46-54, wherein the uplink control message included in the previous uplink TB is associated with a beam failure recovery (BFR) medium access control control element (MAC-CE), wherein the retransmitted uplink control message includes a regeneration of the uplink control message included in the previous uplink TB, including one or more updated fields associated with the BFR MAC-CE.
Aspect 56: The method of any of Aspects 46-55, further comprising: transmitting, to the UE, a radio resource control message indicating one or more conditions for retransmitting the uplink control message.
Aspect 57: The method of Aspect 56, wherein each condition of the one or more conditions is applied based on an uplink control message type associated with the uplink control message.
Aspect 58: A method of wireless communication performed by a user equipment (UE), comprising: receiving a downlink control information (DCI) message associated with scheduling a new transport block (TB) on a physical uplink shared channel, wherein the DCI message includes a feedback indication of a previous TB; and transmitting one or more uplink communications, wherein whether the one or more uplink communications includes a retransmission of information associated with the previous TB is based on the feedback indication.
Aspect 59: The method of Aspect 58, wherein the DCI message includes an indication of a particular hybrid automatic repeat request identifier (HARQ ID) for the new TB, and wherein the feedback indication of the previous TB is associated with the particular HARQ ID.
Aspect 60: The method of any of Aspects 58-59, further comprising: receiving another DCI message with an untoggled new data indicator value scheduling a retransmission of a new TB, where the other DCI message includes a same feedback indication for the previous TB as the feedback indication included in the DCI message.
Aspect 61: The method of any of Aspects 58-60, wherein the DCI message includes an untoggled new data indicator value for a feedback identifier and the DCI message indicates a negative acknowledgment for the previous TB associated with the feedback identifier, and wherein a previous DCI message with a same new data indicator value and feedback identifier indicates an acknowledgment for the previous TB.
Aspect 62: The method of any of Aspects 58-61, wherein the UE is configured to transmit a new TB based on the DCI message.
Aspect 63: The method of any of Aspects 58-62, wherein the UE is configured to perform automatic repeat request (ARQ) retransmission for one or more radio link control service data units associated with the previous TB based on the DCI message.
Aspect 64: The method of any of Aspects 58-63, wherein the UE is configured to flush one or more radio link control service data units associated with the previous TB based on the DCI message.
Aspect 65: The method of any of Aspects 58-64, wherein whether the UE is configured to retransmit or flush one or more radio link control service data units associated with the previous TB is based on an indicator value in the DCI message.
Aspect 66: The method of any of Aspects 58-65, wherein the DCI message includes a new data indicator value that is increased, relative to a previous new data indicator value, by more than one increment for an indicated feedback identifier and is associated with a plurality of previous TBs.
Aspect 67: The method of any of Aspects 58-66, wherein the DCI message includes a two-bit new data indicator associated with indicating the new TB.
Aspect 68: The method of any of Aspects 58-67, wherein the DCI message includes a set of bits associated with identifying a set of TBs, with a common identifier, that are triggered for re-transmission.
Aspect 69: The method of any of Aspects 58-68, wherein the feedback indication applies to one or more indicated code blocks or code block groups of the previous TB, wherein an interpretation of a code block indication field is associated with a value in another field.
Aspect 70: The method of any of Aspects 58-69, further comprising: receiving configuration information associated with identifying a feedback mode; and wherein receiving the DCI message comprises: receiving the DCI message based on the feedback mode.
Aspect 71: The method of any of Aspects 58-70, further comprising: transmitting a UE capability indicator identifying a capability for a feedback mode; and wherein receiving the DCI message comprises: receiving the DCI message based on transmitting the UE capability indicator.
Aspect 72: A method of wireless communication performed by a user equipment (UE), comprising: receiving a non-scheduling downlink control information (DCI) message, wherein the DCI message includes an automatic repeat request (ARQ) indication of a transport block (TB) scheduled in a physical uplink shared channel (PUSCH) and scheduled by a previous DCI message, wherein the non-scheduling DCI message includes a configuration associated with validation of the non-scheduling DCI message; and transmitting one or more uplink communications to re-transmit information associated with the previous TB based on the feedback indication.
Aspect 73: The method of Aspect 72, wherein the feedback indication is a negative acknowledgment message.
Aspect 74: The method of any of Aspects 72-73, wherein the DCI message includes the feedback indication for a plurality of TBs associated with a plurality of different process identifiers.
Aspect 75: The method of Aspect 74, wherein the feedback indication includes a bitmap with a set of bits that maps to the plurality of TBs.
Aspect 76: The method of any of Aspects 72-75, wherein the configuration includes at least one of: a configuration of a field of the DCI message, a configuration of a radio network temporary identifier associated with the DCI message, or a configuration of a format of the DCI message.
Aspect 77: A method of wireless communication performed by a network node, comprising: transmitting a downlink control information (DCI) message associated with scheduling a new transport block (TB) on a physical uplink shared channel, wherein the DCI message includes a feedback indication of a previous TB; and receiving one or more uplink communications, wherein whether the one or more uplink communications includes a retransmission of information associated with the previous TB is based on the feedback indication.
Aspect 78: The method of Aspect 77, wherein the DCI message includes an indication of a particular hybrid automatic repeat request identifier (HARQ ID) for the new TB, and wherein the feedback indication of the previous TB is associated with the particular HARQ ID.
Aspect 79: The method of any of Aspects 77-78, further comprising: transmitting another DCI message with an untoggled new data indicator value scheduling a retransmission of a new TB, where the other DCI message includes a same feedback indication for the previous TB as the feedback indication included in the DCI message.
Aspect 80: The method of any of Aspects 77-79, wherein the DCI message includes an untoggled new data indicator value for a feedback identifier and the DCI message indicates a negative acknowledgment for the previous TB associated with the feedback identifier, and wherein a previous DCI message with a same new data indicator value and feedback identifier indicates an acknowledgment for the previous TB.
Aspect 81: The method of any of Aspects 77-80, wherein the DCI message is associated with a configuration of a transmission of a new TB.
Aspect 82: The method of any of Aspects 77-81, wherein the DCI message is associated with a configuration of automatic repeat request (ARQ) retransmission for one or more radio link control service data units associated with the previous TB.
Aspect 83: The method of any of Aspects 77-82, wherein the DCI message is associated with a configuration of a flush one or more radio link control service data units associated with the previous TB.
Aspect 84: The method of any of Aspects 77-83, wherein whether the DCI message is associated with a configuration of a retransmission or a flush of one or more radio link control service data units associated with the previous TB is based on an indicator value in the DCI message.
Aspect 85: The method of any of Aspects 77-84, wherein the DCI message includes a new data indicator value that is increased, relative to a previous new data indicator value, by more than one increment for an indicated feedback identifier and is associated with a plurality of previous TBs.
Aspect 86: The method of any of Aspects 77-85, wherein the DCI message includes a two-bit new data indicator associated with indicating the new TB.
Aspect 87: The method of any of Aspects 77-86, wherein the DCI message includes a set of bits associated with identifying a set of TBs, with a common identifier, that are triggered for re-transmission.
Aspect 88: The method of any of Aspects 77-87, wherein the feedback indication applies to one or more indicated code blocks or code block groups of the previous TB, wherein an interpretation of a code block indication field is associated with a value in another field.
Aspect 89: The method of any of Aspects 77-88, further comprising: transmitting configuration information associated with identifying a feedback mode; and wherein transmitting the DCI message comprises: transmitting the DCI message in accordance with the feedback mode.
Aspect 90: The method of any of Aspects 77-89, further comprising: receiving a UE capability indicator identifying a capability for a feedback mode; and wherein transmitting the DCI message comprises: transmitting the DCI message based on receiving the UE capability indicator.
Aspect 91: A method of wireless communication performed by a network node, comprising: transmitting a non-scheduling downlink control information (DCI) message, wherein the DCI message includes an automatic repeat request (ARQ) indication of a transport block (TB) scheduled in a physical uplink shared channel (PUSCH) and scheduled by a previous DCI message, wherein the non-scheduling DCI message includes a configuration associated with validation of the non-scheduling DCI message; and receiving one or more uplink communications to re-transmit information associated with the previous TB based on the feedback indication.
Aspect 92: The method of Aspect 91, wherein the feedback indication is a negative acknowledgment message.
Aspect 93: The method of any of Aspects 91-92, wherein the DCI message includes the feedback indication for a plurality of TBs associated with a plurality of different process identifiers.
Aspect 94: The method of Aspect 93, wherein the feedback indication includes a bitmap with a set of bits that maps to the plurality of TBs.
Aspect 95: The method of any of Aspects 91-94, wherein the configuration includes at least one of: a configuration of a field of the DCI message, a configuration of a radio network temporary identifier associated with the DCI message, or a configuration of a format of the DCI message.
Aspect 96: A method of wireless communication performed by a user equipment (UE), comprising: receiving, from a network node, information that indicates one or more unsuccessful hybrid automatic repeat request (HARQ) termination events associated with one or more respective uplink transport blocks (TBs) associated with one or more HARQ identifiers (IDs); and transmitting, to the network node, one or more uplink transmissions, wherein the one or more uplink transmissions include a retransmission of at least one of one or more radio link control (RLC) service data units (SDUs) or one or more RLC SDU segments associated with a respective uplink TB, of the one or more respective uplink TBs, associated with a valid unsuccessful HARQ termination event of the one or more unsuccessful HARQ termination events.
Aspect 97: The method of Aspect 96, wherein the information is received via a medium access control control element (MAC-CE).
Aspect 98: The method of any of Aspects 96-97, wherein the information is received via an RLC status report that indicates a negative acknowledgment associated with one or more of the one or more respective uplink TBs.
Aspect 99: The method of any of Aspects 96-98, wherein the information indicates a component carrier index, a HARQ ID of the one or more HARQ IDs, a new data indicator, and a time stamp associated with each unsuccessful HARQ termination event of the one or more unsuccessful HARQ termination events.
Aspect 100: The method of any of Aspects 96-99, wherein the information is a bitmap that includes a bit to represent a HARQ ID associated with one or more uplink TBs, and wherein a value of the bit indicates that the HARQ ID is associated with an unsuccessful HARQ termination event of the one or more unsuccessful HARQ termination events.
Aspect 101: The method of Aspect 100, wherein the information indicates a component carrier index associated with the bitmap.
Aspect 102: The method of Aspect 100, wherein the bitmap is associated with one or more component carriers.
Aspect 103: The method of Aspect 100, wherein the information indicates a new data indicator and a time stamp associated with each unsuccessful HARQ termination event of the one or more unsuccessful HARQ termination events.
Aspect 104: The method of any of Aspects 96-103, wherein the information indicates a time stamp for each unsuccessful HARQ termination event of the one or more unsuccessful HARQ termination events, and wherein the time stamp indicates one or more time periods associated with one or more scheduled physical uplink shared channels (PUSCHs) associated with each respective uplink TB of the one or more respective uplink TBs.
Aspect 105: The method of Aspect 104, wherein the one or more scheduled PUSCHs includes a first scheduled PUSCH or a last scheduled PUSCH.
Aspect 106: The method of Aspect 104, wherein the one or more scheduled PUSCHs includes a first scheduled PUSCH and a last scheduled PUSCH.
Aspect 107: The method of Aspect 104, wherein the one or more time periods include a first scheduled PUSCH and a time period occurring between the first scheduled PUSCH and a last scheduled PUSCH.
Aspect 108: The method of any of Aspects 96-107, wherein the information includes a time stamp that indicates a time period associated with a physical uplink shared channel (PUSCH) message that was successfully decoded most recently before a transmission of a respective uplink TB, of the one or more respective uplink TBs, having a HARQ ID that matches a HARQ ID of the PUSCH message.
Aspect 109: The method of any of Aspects 96-108, further comprising: skipping transmission of the one or more uplink transmissions based on a determination that the UE did not receive an uplink grant scheduling a physical uplink shared channel transmission associated with an NDI and a HARQ ID that match an NDI and a HARQ ID associated with the respective uplink TB of the one or more respective uplink TBs.
Aspect 110: The method of any of Aspects 96-109, further comprising: skipping transmission of the one or more uplink transmissions based on a determination that the UE previously skipped one or more uplink transmissions associated with an NDI and a HARQ ID that correspond to an NDI and a HARQ ID associated with the respective uplink TB of the one or more respective uplink TBs.
Aspect 111: The method of any of Aspects 96-110, further comprising: skipping transmission of the one or more uplink transmissions based on a determination that the information indicates that the respective uplink TB of the one or more respective uplink TBs is not associated with an RLC SDU or an RLC SDU segment.
Aspect 112: The method of any of Aspects 96-111, further comprising: discarding all RLC SDUs and all RLC SDU segments associated with the respective uplink TB of the one or more respective uplink TBs, based on a determination that the UE has not received, during a time period, an indication of one or more unsuccessful HARQ termination events associated with the respective uplink TB of the one or more respective uplink TBs, wherein the time period is measured from an immediately preceding transmission of the respective uplink TB.
Aspect 113: The method of Aspect 112, wherein the time period is configured for one or more of a cell group, a CC, a set of HARQ IDs, or a HARQ ID.
Aspect 114: A method of wireless communication performed by a network node, comprising: transmitting, to a user equipment (UE), information that indicates one or more unsuccessful hybrid automatic repeat request (HARQ) termination events associated with one or more respective uplink transport blocks (TBs) associated with one or more HARQ identifiers (IDs); and receiving, from the UE, one or more uplink transmissions, wherein the one or more uplink transmissions include a retransmission of at least one of one or more radio link control (RLC) service data units (SDUs) or one or more RLC SDU segments associated with a respective uplink TB, of the one or more respective uplink TBs, associated with a valid unsuccessful HARQ termination event of the one or more unsuccessful HARQ termination events.
Aspect 115: The method of Aspect 114, wherein the information is transmitted via a medium access control control element (MAC-CE).
Aspect 116: The method of any of Aspects 114-115, wherein the information is transmitted via an RLC status report that indicates a negative acknowledgment associated with one or more of the one or more respective uplink TBs.
Aspect 117: The method of any of Aspects 114-116, wherein the information indicates a component carrier index, a HARQ ID of the one or more HARQ IDs, a new data indicator, and a time stamp associated with each unsuccessful HARQ termination event of the one or more unsuccessful HARQ termination events.
Aspect 118: The method of any of Aspects 114-117, wherein the information is a bitmap that includes a bit to represent a HARQ ID associated with one or more uplink TBs, and wherein a value of the bit indicates that the HARQ ID is associated with an unsuccessful HARQ termination event of the one or more unsuccessful HARQ termination events.
Aspect 119: The method of Aspect 118, wherein the information indicates a component carrier index associated with the bitmap.
Aspect 120: The method of Aspect 118, wherein the bitmap is associated with one or more component carriers.
Aspect 121: The method of Aspect 118, wherein the information indicates a new data indicator and a time stamp associated with each unsuccessful HARQ termination event of the one or more unsuccessful HARQ termination events.
Aspect 122: The method of any of Aspects 114-121, wherein the information indicates a time stamp for each unsuccessful HARQ termination event of the one or more unsuccessful HARQ termination events, and wherein the time stamp indicates one or more time periods associated with one or more scheduled physical uplink shared channels (PUSCHs) associated with each respective uplink TB of the one or more respective uplink TBs.
Aspect 123: The method of Aspect 122, wherein the one or more scheduled PUSCHs includes a first scheduled PUSCH or a last scheduled PUSCH.
Aspect 124: The method of Aspect 122, wherein the one or more scheduled PUSCHs includes a first scheduled PUSCH and a last scheduled PUSCH.
Aspect 125: The method of Aspect 122, wherein the one or more time periods include a first scheduled PUSCH and a time period occurring between the first scheduled PUSCH and a last scheduled PUSCH.
Aspect 126: The method of any of Aspects 114-125, wherein the information includes a time stamp that indicates a time period associated with a physical uplink shared channel (PUSCH) message that was successfully decoded most recently before a transmission of a respective uplink TB, of the one or more respective uplink TBs, having a HARQ ID that matches a HARQ ID of the PUSCH message.
Aspect 127: The method of any of Aspects 114-126, further comprising: transmitting, to the UE, a configuration defining a time period associated with the UE retaining one or more RLC SDUs or one or more RLC SDU segments associated with the respective uplink TB of the one or more respective uplink TBs.
Aspect 128: The method of Aspect 127, wherein the time period is configured for one or more of a cell group, a CC, a set of HARQ IDs, or a HARQ ID.
Aspect 129: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-128.
Aspect 130: An apparatus for wireless communication at a device, the apparatus comprising one or more memories and one or more processors coupled to the one or more memories, the one or more processors configured to cause the device to perform the method of one or more of Aspects 1-128.
Aspect 131: An apparatus for wireless communication, the apparatus comprising at least one means for performing the method of one or more of Aspects 1-128.
Aspect 132: A non-transitory computer-readable medium storing code for wireless communication, the code comprising instructions executable by one or more processors to perform the method of one or more of Aspects 1-128.
Aspect 133: A non-transitory computer-readable medium storing a set of instructions for wireless communication, the set of instructions comprising one or more instructions that, when executed by one or more processors of a device, cause the device to perform the method of one or more of Aspects 1-128.
Aspect 134: A device for wireless communication, the device comprising a processing system that includes one or more processors and one or more memories coupled with the one or more processors, the processing system configured to cause the device to perform the method of one or more of Aspects 1-128.
Aspect 135: An apparatus for wireless communication at a device, the apparatus comprising one or more memories and one or more processors coupled to the one or more memories, the one or more processors individually or collectively configured to cause the device to perform the method of one or more of Aspects 1-128.
Aspect 136: A device comprising a processing system that includes one or more processors and one or more code-storing memories coupled with the one or more processors, the processing system configured to cause the device to perform the method of one or more of Aspects 1-128.
Aspect 137: A device comprising a processing system that includes processor circuitry and code-storing memory circuitry, the processing system configured to cause the device to perform the method of one or more of Aspects 1-128.

The foregoing disclosure provides illustration and description but is not intended to be exhaustive or to limit the aspects to the precise forms disclosed. Modifications and variations may be made in light of the above disclosure or may be acquired from practice of the aspects. No element, act, or instruction described herein should be construed as critical or essential unless explicitly described as such.

It will be apparent that systems or methods described herein may be implemented in different forms of hardware or a combination of hardware and software. The actual specialized control hardware or software used to implement these systems or methods is not limiting of the aspects. Thus, the operation and behavior of the systems or methods are described herein without reference to specific software code, because those skilled in the art will understand that software and hardware can be designed to implement the systems or methods based, at least in part, on the description herein. A component being configured to perform a function means that the component has a capability to perform the function, and does not require the function to be actually performed by the component, unless noted otherwise.

As used herein, the articles “a” and “an” are intended to refer to one or more items and may be used interchangeably with “one or more” or “at least one.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or “a single one” or similar language is used. Also, as used herein, the terms “has,” “have,” “having,” “comprise,” “comprising,” “include” and “including,” and derivatives thereof or similar terms are intended to be open-ended terms that do not limit an element that they modify (for example, an element “having” A may also have B). Also, as used herein, the term “or” is intended to be inclusive when used in a series and may be used interchangeably with “and/or,” unless explicitly stated otherwise (for example, if used in combination with “either” or “only one of”). As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (for example, a+a, a+a+a, a+a+b, a+a+c, a+b+b, a+c+c, b+b, b+b+b, b+b+c, c+c, and c+c+c, or any other ordering of a, b, and c).

As used herein, the term “determine” or “determining” encompasses a wide variety of actions and, therefore, “determining” can include calculating, computing, processing, deriving, estimating, investigating, looking up (such as via looking up in a table, a database, or another data structure), searching, inferring, ascertaining, and/or measuring, among other possibilities. Also, “determining” can include receiving (such as receiving information), accessing (such as accessing data stored in memory) or transmitting (such as transmitting information), among other possibilities. Additionally, “determining” can include resolving, selecting, obtaining, choosing, establishing, and/or other such similar actions.

As used herein, the phrase “based on” is intended to mean “based at least in part on” or “based on or otherwise in association with” unless explicitly stated otherwise. As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the scope of all aspects described herein. Many of these features may be combined in ways not specifically recited in the claims or disclosed in the specification. The disclosure of various aspects includes each dependent claim in combination with every other claim in the claim set.

What is claimed is:

1. A user equipment (UE), comprising:
a transceiver; and
a processing system that includes one or more processors and one or more code-storing memories coupled with the one or more processors, the processing system configured to:
receive, via the transceiver from a network node, an indication of an unsuccessful hybrid automatic repeat request (HARQ) termination associated with a previous uplink transport block (TB), wherein the previous uplink TB includes an uplink control message; and
transmit, via the transceiver to the network node, one or more uplink communications, wherein the one or more uplink communications include a retransmission of the uplink control message.

2. The UE of claim 1, wherein the one or more uplink communications are associated with a different component carrier (CC) or HARQ identifier (ID) than a CC or HARQ ID associated with the previous uplink TB.

3. The UE of claim 1, wherein the retransmission of the uplink control message includes a retransmission of a payload associated with the uplink control message.

4. The UE of claim 1, wherein the retransmitted uplink control message includes a regeneration of the uplink control message included in the previous uplink TB.

5. The UE of claim 1, wherein the one or more uplink communications include a new indication associated with at least one unsuccessful downlink HARQ termination event, of the one or more unsuccessful downlink HARQ termination events, that occurred since a transmission of the previous uplink TB.

6. The UE of claim 5, wherein the new indication has a lower transmission priority than a transmission priority associated with the retransmission of the uplink control message.

7. The UE of claim 5, wherein the retransmitted uplink control message includes a regeneration of the uplink control message included in the previous uplink TB, and wherein the regenerated uplink control message includes the new indication.

8. The UE of claim 5, wherein the processing system is further configured to:
transmit, via the transceiver, a UE capability indicator identifying a capability associated with storing the one or more unsuccessful downlink HARQ termination events associated with the one or more previous downlink TBs.

9. The UE of claim 1, wherein the processing system is further configured to:
ignore a timer associated with a threshold time period associated with a transmission of a radio link control (RLC) status report, based on a determination that the uplink control message included in the previous uplink TB is associated with the RLC status report.

10. The UE of claim 9, wherein the processing system is further configured to:
transmit, via the transceiver to the network node, one or more new RLC status reports according to the timer, wherein the one or more new RLC status reports are generated after a transmission of the previous uplink TB.

11. A network node, comprising:
a transceiver; and
a processing system that includes one or more processors and one or more code-storing memories coupled with the one or more processors, the processing system configured to:
transmit, via the transceiver to a user equipment (UE), an indication of an unsuccessful hybrid automatic repeat request (HARQ) termination associated with a previous uplink transport block (TB), wherein the previous uplink TB includes an uplink control message; and
receive, via the transceiver from the UE, one or more uplink communications, wherein the one or more uplink communications include a retransmission of the uplink control message.

12. The network node of claim 11, wherein the one or more uplink communications are associated with a different component carrier (CC) or HARQ identifier (ID) than a CC or HARQ ID associated with the previous uplink TB.

13. The network node of claim 11, wherein the retransmission of the uplink control message includes a retransmission of a payload associated with the uplink control message.

14. The network node of claim 11, wherein the retransmitted uplink control message includes a regeneration of the uplink control message included in the previous uplink TB.

15. The network node of claim 11, wherein the uplink control message is associated with an indication that indicates one or more unsuccessful downlink HARQ termination events associated with one or more previous downlink TBs.

16. The network node of claim 15, wherein the one or more uplink communications include a new indication associated with at least one unsuccessful downlink HARQ termination event, of the one or more unsuccessful downlink HARQ termination events, that occurred since a transmission of the previous uplink TB.

17. The network node of claim 11, wherein the one or more uplink communications includes one or more new indications associated with one or more respective beam failure events that occurred since a transmission of the previous uplink TB, and wherein each new indication of the one or more new indications is transmitted as a separate medium access control control element (MAC-CE).

18. The network node of claim 11, wherein the uplink control message included in the previous uplink TB is associated with a beam failure recovery (BFR) medium access control control element (MAC-CE), wherein the retransmitted uplink control message includes a regeneration of the uplink control message included in the previous uplink TB, including one or more updated fields associated with the BFR MAC-CE.

19. The network node of claim 11, wherein the processing system is further configured to:
transmit, to the UE, a radio resource control message indicating one or more conditions for retransmitting the uplink control message.

20. The network node of claim 19, wherein each condition of the one or more conditions is applied based on an uplink control message type associated with the uplink control message.

21. A method of wireless communication performed by a user equipment (UE), comprising:
receiving, from a network node, an indication of an unsuccessful hybrid automatic repeat request (HARQ) termination associated with a previous uplink transport block (TB), wherein the previous uplink TB includes an uplink control message; and
transmitting, to the network node, one or more uplink communications, wherein the one or more uplink communications include a retransmission of the uplink control message.

22. The method of claim 21, further comprising:
stopping and resetting a timer associated with a threshold time period associated with a transmission of a radio link control (RLC) status report, based on a determination that the uplink control message included in the previous uplink TB is associated with an RLC status report, wherein the regenerated uplink control message includes a positive acknowledgement or a negative acknowledgement indication for each sequence number (SN), of one or more SNs, associated with an RLC service data unit (SDU) or an RLC SDU segment received since a transmission of the previous uplink TB.

23. The method of claim 21, wherein the one or more uplink communications includes one or more new indications associated with one or more respective beam failure events that occurred since a transmission of the previous uplink TB, based on a determination that the uplink control message included in the previous uplink TB is associated with a beam failure recovery medium access control control element (MAC-CE), and
wherein each new indication of the one or more new indications is transmitted as a separate MAC-CE.

24. The method of claim 21, wherein the uplink control message included in the previous uplink TB is associated with a beam failure recovery (BFR) medium access control control element (MAC-CE), wherein the retransmitted uplink control message includes a regeneration of the uplink control message included in the previous uplink TB, including one or more updated fields associated with the BFR MAC-CE based on one or more beam conditions received since a transmission of the previous uplink TB.

25. The method of claim 21, further comprising:
receiving, from the network node, a radio resource control message indicating one or more conditions for retransmitting the uplink control message.

26. A method of wireless communication performed by a network node, comprising:
transmitting, to a user equipment (UE), an indication of an unsuccessful hybrid automatic repeat request (HARQ) termination associated with a previous uplink transport block (TB), wherein the previous uplink TB includes an uplink control message; and
receiving, from the UE, one or more uplink communications, wherein the one or more uplink communications include a retransmission of the uplink control message.

27. The method of claim 26, further comprising:
receiving a UE capability indicator identifying a capability associated with storing the one or more unsuccessful downlink HARQ termination events associated with the one or more previous downlink TBs.

28. The method of claim 26, wherein the one or more uplink communications includes one or more new indications associated with one or more respective beam failure events that occurred since a transmission of the previous uplink TB, and wherein each new indication of the one or more new indications is transmitted as a separate medium access control control element (MAC-CE).

29. The method of claim 26, further comprising:
transmitting, to the UE, a radio resource control message indicating one or more conditions for retransmitting the uplink control message.

30. The method of claim 29, wherein each condition of the one or more conditions is applied based on an uplink control message type associated with the uplink control message.
